(19) United States
(12) Patent Application Publication
(10) Pub. No.: US 2022/0003684 A1
(43) Pub. Date: Jan. 6, 2022

(54) RESPONSIVE INTERFERENCE COLORATION

(71) Applicant: UWM Research Foundation, Inc., Milwaukee, WI (US)

(72) Inventors: Jian Chen, Milwaukee, WI (US); Seyedali Banisadr, Milwaukee, WI (US); Adebola Olatunji Oyefusi, Whitefish Bay, WI (US)

(21) Appl. No.: 17/291,690

(22) PCT Filed: Nov. 8, 2019
(86) PCT No.: PCT/US2019/060457

§ 371 Date: May 6, 2021

Related U.S. Application Data
(60) Provisional application No. 62/757,288, filed on Nov. 8, 2018.

(51) Int. Cl. G01N 21/78

(52) U.S. Cl. CPC G01N 21/78; G01N 2021/7779

(57) ABSTRACT

A three-layer system composed of a substrate, a metal or metal alloy thin film deposited on the substrate surface, and an overlaid stimulus-responsive polymer layer detects changes in environmental conditions brought about by physical, chemical, or biological stimuli. The thin metal or metal alloy film functions as an optical filter and the polymer layer changes properties (e.g., dimensions) in response to changing environmental conditions that manifests as a change in wavelength of reflected or filtered light. The system is useful in colorimetric sensors.

### CROSS-REFERENCE TO RELATED APPLICATIONS

This application claims priority to U.S. Provisional Application No. 62/757,288, filed Nov. 8, 2018, which is hereby incorporated by reference in its entirety.

### TECHNICAL FIELD

The present disclosure relates to a colorimetric three-layer system composed of a substrate, a metal or metal alloy thin film, and a stimulus-responsive polymer layer that detects changes in environmental conditions brought about by physical, chemical, or biological stimuli and is useful in colorimetric sensors.

### BACKGROUND

In contrast to chemical dyes (chemical colors), structural colorations are widely found in nature such as birds, butterflies, insects, and marine organisms, where colors originate from micro- or nanostructures instead of chemical structures. One main advantage of structural colors is that they are not easily degraded by environmental conditions such as ultraviolet light, heat, oxygen, and moisture. This is because the structural color arises from a physical structure of non-dyes, which is much more stable than a chemical dye structure. Structural coloration arises from the physical interaction of light with micro- or nanostructures via a variety of optical mechanisms, including thin-film interference, multilayer interference, diffraction gratings, photonic crystals, and scattering. Compared with pigmentary coloration, structural coloration is not only more resistant towards the color degradation caused by environmental conditions, but also easily tunable via changes in structural parameters or refractive index. The bioinspired stimuli-responsive structural coloration offers a wide range of promising applications in medical diagnostics, advanced packaging, environmental and building monitoring, adaptive camouflage, intelligent coatings and textiles, and anti-counterfeiting.

Although structural coloration based on thin film interference is well known, research on stimuli-responsive thin film interference has been mainly limited to materials such as inorganic materials, reflectin proteins, multilayers of polyelectrolytes, and hydrogels, which are typically deposited on nontransparent substrates such as silicon wafer. Compared with other substrates such as glass, single crystalline silicon wafer is relatively expensive to produce and has limited area size.

Compared with most inorganic materials, polymer-based materials have many advantages such as low cost, flexibility, good processability, excellent corrosion resistance, and lightweight. Moreover, the new class of smart polymers can sense their environment (e.g. humidity, temperature, chemicals, biomolecules, light, or mechanical forces), and change the shape, volume, or thickness accordingly. For many potential applications, low-cost substrates other than monocrystalline silicon wafer are highly desirable. For example, the glass substrate can be used for applications where large-area structural coloration is required. In addition, transparent glass substrate is required for smart window-related applications. However, thin films of polymers with appropriate thickness that are directly deposited on glass generally do not exhibit visible structural colors (FIG. 1 and FIG. 3B-3C).

While remarkable progress has been made in the field of responsive structural coloration based on photonic crystals and multilayer interference, how to make high-quality responsive structural coloration systems on large scale at low cost still remains a challenge. Thin-film interference is the simplest structural coloration mechanism, which is responsible for the colorful, iridescent reflections that can be seen in oil films on water, and soap bubbles. Owing to its design simplicity, which does not require multilayers of materials with alternative refractive indices or micro- and nanostructures, thin film interference represents a promising solution towards scalable and affordable manufacturing of high-quality responsive structural coloration systems.

The Internet of Things (IoT) is a network of broadly defined devices that are used to collect, exchange, and process information, which enables a wide range of transformative applications, such as environmental monitoring, smart home, wearable health-monitoring electronics, and smart farming. One of the critical challenges that significantly limits the implementation and growth of the IoT is exponentially growing power demand by the vast network of electronic devices. For instance, state-of-the-art sensors use electronics to actively monitor the environment for the infrequent target stimulus, consuming power continuously while waiting for the specific signal. Such active electronic sensors not only have high energy footprints, but also have limited sensor lifetime because sensors are always in the working state. Therefore, developing energy efficient sensors are essential to fully realize the potential of the IoT.

One approach is to use photovoltaics to harvest solar energy to power the sensors. Such self-powered sensors can be used as wearable sensors for the precise and continuous monitoring of biological signals. Another approach is to use triboelectric nanogenerators to harvest mechanical energy from the environment to power the sensors. Since both solar and environmental mechanical energy sources are intermittent by nature and they are not always available for conversion into electricity, energy storage devices such as batteries are generally required to ensure the sensor performance.

Colorimetric chemical sensors convert a chemical input signal into an optical output signal. One main advantage of colorimetric sensors is their self-reporting feature that autonomously exhibits a color change upon exposure to a target stimulus without using external power sources, which make them good candidates for IoT applications.

### SUMMARY

Disclosed herein is a new scalable and affordable platform technology for fabrication of polymer-based, stimuli-responsive interference colored films. The material system is composed of a polymer layer deposited on a metal-coated substrate. The thickness of the polymer layer determines the reflected color, whereas the thickness of the metal thin film controls the intensity of the reflected color. A full spectrum of bright interference colors can be generated on both rigid and soft substrates such as low-cost glass and soft silicone elastomer (e.g. poly dimethylsiloxane (PDMS)) through a facile fabrication method. Moreover, the interference colored films can exhibit fast and reversible color changes in response to various external stimuli. The sensing function can be achieved by choosing suitable polymer structures that can interact with specific external stimuli. Such affordable, scalable polymer-based, responsive interference coloration (RIC) could enable colorimetric sensing of various environmental stimuli (e.g. humidity, temperature, chemicals, biomolecules, light, or mechanical forces), which could enable a broad range of commercial applications.

In one aspect, the invention provides a responsive interference coloration system comprising: (a) a substrate having a first surface; (b) a continuous thin film of a metal or metal alloy on at least a portion of the first surface of the substrate, wherein the thin film has a thickness configured to filter electromagnetic radiation; and (c) a polymer layer coated on the thin film, wherein the polymer of the polymer layer is a stimulus-responsive polymer.

In another aspect, the invention provides an article of manufacture, such as a sensor, comprising the system of the invention.

Another aspect of the invention provides a method of manufacturing the article comprising (a) depositing a metal or metal alloy on at least a portion of a first surface of a substrate, the metal or metal alloy being deposited as a thin film with a thickness configured to filter electromagnetic radiation; and (b) coating a stimulus-responsive polymer on the thin film to form a polymer layer.

Another aspect of the invention provides a method of detecting a change in an environmental condition comprising (a) contacting the article of the invention with a physical, chemical, or biological stimulus; and (b) detecting a change in color and/or shape of the article.

### BRIEF DESCRIPTION OF THE DRAWINGS

FIG. 1 shows that thin films of polymers with appropriate thickness generally do not exhibit visible structural colors if they are directly deposited on low-cost substrates such as glass and polydimethylsiloxane (PDMS).

FIG. 2 is a schematic illustration of an example of preparation of the thin films of polymer on metal-coated substrates. The process is simple, scalable, and affordable.

FIG. 3 is the interference coloration principle. (A) A polymer-metal-substrate trilayer RIC design. (B, C) The PVP-glass film with the polymer layer thickness comparable to that in (F-H). (D, E) The Ir-glass film. (F-H) Photographs, reflection spectra (θ=0°), and transmission spectra of the PVP-Ir-glass film with different thicknesses of metal (d₃): (F) 1 nm, (G) 5 nm, and (H) 25 nm. Metal film thickness: (D,E) 5 nm. Scale bars: 1 cm.

FIG. 4 shows that using an ultrathin metal layer as an optical filter allows tuning of the degree of transparency, the constructive interference reflection light, and complementary destructive interference transmission light via changing the metal film thickness of blue-colored PVP-Ir-Glass film. (A) Reflection colors. (B) Transmission colors. d₃ indicates the thickness of the metal film in nm.

FIG. 5 demonstrates using an ultrathin metal layer as an optical filter allows tuning of the degree of transparency, the constructive interference reflection light, and complementary destructive interference transmission light via changing the metal layer thickness of red-colored PVP-Ir-Glass film. (A) Reflection colors. (B) Transmission colors. d₃ indicates the thickness of the metal layer in nm.

FIG. 6 shows tuning the reflection color via changing the polymer layer thickness. (A) Photographs (top view) of color palettes generated in PVP-Ir-glass. Thickness (d₂) of PVP layer in the purple, blue, green, yellow, and red-colored PVP-Ir-glass films are 268 nm, 303 nm, 342 nm, 386 nm, and 481 nm, respectively. (B) Reflection spectra (θ=0°) of different colors generated by PVP-Ir-glass films. Metal film thickness: 5 nm. Scale bars: 1 cm.

FIG. 7 shows the chemical structures of (A) PVP, (B) PDMS, and (C) PC.

FIG. 8 (A) Front-side photograph (top view) and (B) reflection spectrum (θ=0°) of the blue-colored PVP-Ir-glass film. The arrow in the spectrum shows the calculated peak wavelength of 464 nm for the second order (m=2) of reflection, which is in reasonably good agreement with the experimental peak position of 458 nm. (C) Back-side photograph (top view) and (D) transmission spectrum of the same PVP-Ir-glass film. The arrows in the transmission spectrum show the calculated peak wavelengths for m-½=1.5 (618 nm) and m-½=2.5 (371 nm), which are in reasonably good agreement with the experimental peak positions of 605 nm and 370 nm, respectively. (E) Front-side photograph (top view) and (F) reflection spectrum (θ=0°) of the green-colored PVP-Ir-glass film. The arrow in the spectrum shows the calculated peak wavelength of 523 nm for the second order (m=2) of reflection, which is in reasonably good agreement with the experimental peak position of 518 nm. (G) Back-side photograph (top view) and (H) transmission spectrum of the same PVP-Ir-glass film. The arrows in the transmission spectrum show the calculated peak wavelengths for m-½=1.5 (698 nm) and m-½=2.5 (419 nm), which are in reasonably good agreement with the experimental peak positions of 680 nm and 412 nm, respectively. Metal film thickness: 5 nm. Scale bars: 1 cm.

FIG. 9, the RIC film on glass shows strong coupling of constructive interference reflected colors (front-side view) and complementary destructive interference transmitted colors (back-side view) on opposite sides of the film. a) A traditional color wheel. Each color serves as the complement of the opposite color across the wheel. (B) Front-side and (C) back-side photographs (top view) of PVP-Ir-glass films with tunable colors. Metal film thickness: 5 nm. Scale bars: 1 cm.

FIG. 10 depicts photographs (top view) of color palettes generated in (A) PC-Ir-glass and (B) PDMS-Ir-glass films with tunable polymer layer thickness. Metal film thickness: 5 nm. Scale bars: 1 cm.

FIG. 11 (A) Viewing-angle dependent photography of the PC-Ir-glass film at different viewing angles relative to the normal. (B) Reflection spectroscopy of the PC-Ir-glass film at different angles of incidence (θ). The reflection spectra were obtained using a fiber-guided light source (HL-2000, Ocean Optics) and a detector (USB2000+, Ocean Optics). Both light source and detector were varied at the same angle relative to the normal. (C) Comparison of the observed reflection peak positions at various 0 values with corresponding predicted reflection peak positions based on Equation 4 d₂: 295 nm. Metal film thickness: 5 nm. Scale bar: 1 cm.

FIG. 12 (A) Top-view and (B) side-view (at 450 viewing angle) photographs of color palettes generated in PVP-Ir-glass films with tunable polymer layer thickness. Metal film thickness: 5 nm. Scale bars: 1 cm.

FIG. 13 (A) Top-view and (B) side-view (at 450 viewing angle) photographs of color palettes generated in PC-Ir-glass films with tunable polymer layer thickness. Metal film thickness: 5 nm. Scale bars: 1 cm.

FIG. 14 shows photographs (top view) of blue and red colors generated in (A) PVP-nichrome-glass and (B) PVP-Ag-glass films with two different polymer layer thickness. (C) Photographs (top view) of color patterns generated in PVP-Ir-glass films with a patterned metal layer and tunable polymer layer thickness. Metal film thickness: 5 nm. Scale bars: 1 cm.

FIG. 15 shows photographs (top view) of blue and green colors generated in PVP-Al-glass films with two different polymer layer thickness. Metal film thickness: 5 nm. Scale bars: 1 cm.

FIG. 16 is photographs (top view) of yellow and red colors generated in PVPP-Al-glass films with two different polymer layer thickness. Metal film thickness: 5 nm. Scale bars: 1 cm.

FIG. 17 (A) Cross-sectional SEM image of the purple-colored PVP-Ir-glass film. Scale bar: 500 nm. The thickness of PVP film measured from the SEM image is 268 nm with a variation of 5 nm. Inset image is the corresponding photograph (top view). Metal film thickness: 5 nm. Scale bar: 1 cm. (B) Reflection spectrum (θ=0°) of the same PVP-Ir-glass film. The arrows in the spectrum show the calculated peak wavelengths of 820 nm and 410 nm for the first order (m=1) and second order (m=2) of reflections, respectively, which are in fairly good agreement with the experimental peak positions of 801 and 414 nm.

FIG. 18 (A) Cross-sectional SEM image of the blue-colored PVP-Ir-glass film. Scale bar: 1 μm. The thickness (d₂) of PVP film measured from the SEM image is 303 nm with a variation of 4 nm. Inset image is the corresponding photograph (top view). (B) Reflection spectrum (θ=0°) of the same PVP-Ir-glass film. The arrow in the spectrum shows the calculated peak wavelength of 464 nm for the second order (m=2) of reflection, which is in fairly good agreement with the experimental peak position of 458 nm.

FIG. 19 (A) Cross-sectional SEM image of the green-colored PVP-Ir-glass film. Scale bar: 1 μm. The thickness of PVP film measured from the SEM image is 342 nm with a variation of 3 nm. Inset image is the corresponding photograph (top view). Metal film thickness: 5 nm. Scale bar: 1 cm. (B) Reflection spectrum (θ=0°) of the same PVP-Ir-glass film. The arrow in the spectrum shows the calculated peak wavelength of 523 nm for the second order (m=2) of reflection, which is in fairly good agreement with the experimental peak position of 518 nm.

FIG. 20 (A) Cross-sectional SEM image of the yellow-colored PVP-Ir-glass film. Scale bar: 1 μm. The thickness of PVP film measured from the SEM image is 386 nm with a variation of 6 nm. Inset image is the corresponding photograph (top view). Metal film thickness: 5 nm. Scale bar: 1 cm. (B) Reflection spectrum (θ=0°) of the same PVP-Ir-glass film. The arrows in the spectrum show the calculated peak wavelengths of 591 nm and 394 nm for the second order (m=2) and third order (m=3) of reflections, respectively, which are in fairly good agreement with the experimental peak positions of 585 and 393 nm.

FIG. 21 is the RIC trilayer system can be put on additional metal substrates without negatively affecting its reflected color intensity. (A) Schematic illustration of the RIC trilayer system. (B) Photograph (top view) of the red-colored PVP-Ir-glass film. (C) Schematic illustration of the RIC trilayer system on top of a metal substrate. (D) Photograph (top view) of the red-colored PVP-Ir-glass-Ir film after the second layer of iridium (25 nm thick) is sputter-coated on the backside of the glass substrate. (E) Photograph (top view) of the red-colored PVP-Ir-glass film on top of an aluminum foil. Metal film thickness: 5 nm. Scale bars: 1 cm.

FIG. 22 is the chemical structure of Nafion in its acidic state.

FIG. 23 shows photographs (top view) of color palettes generated in Nafion-Ir-glass with tunable polymer layer thickness. Metal film thickness: 5 nm. Scale bars: 1 cm.

FIG. 24 is photographs (top view) of color palettes generated in Nafion-Al-glass with tunable polymer layer thickness. Metal film thickness: 5 nm. Scale bars: 1 cm.

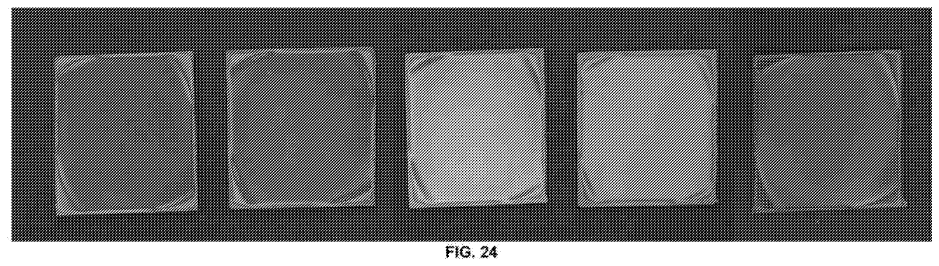

FIG. 25 is the chemical structure of soluble starch.

FIG. 26 shows photographs (top view) of color palettes generated in starch-Ir-glass with tunable polymer layer thickness. Metal film thickness: 3 nm.

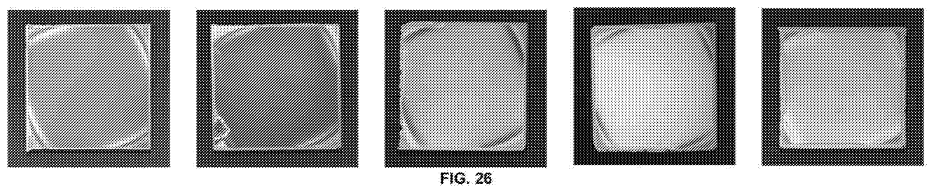

FIG. 27, preparation of UV-crosslinked starch-Ir-glass film. Rinsing with water causes a color change of the UV-crosslinked film from pink to yellow and DMSO causes the film to change from yellow to orange. Metal film thickness: 3 nm. UV-crosslinking makes starch insoluble and enhances its stability towards water vapor.

FIG. 28 shows the chemical structure of polystyrene (PS).

FIG. 29 is photographs (top view) of color palettes generated in UV-crosslinked PS-Ir-glass with tunable polymer layer thickness. Metal film thickness: 3 nm.

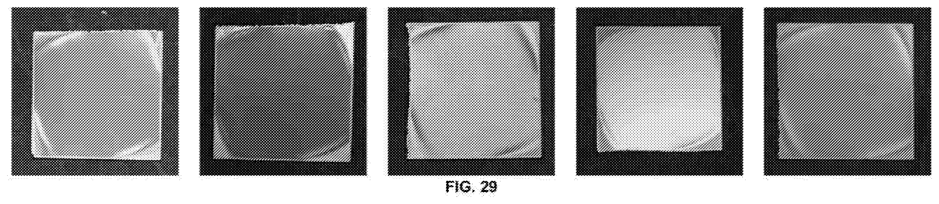

FIG. 30 demonstrates that different color patterns can be generated in UV crosslinked PS-Ir-glass by controlling UV irradiation time at different locations, followed by rinsing in toluene. Metal film thickness: 3 nm.

FIG. 31 is the chemical structure of glucomannan.

FIG. 32 shows photographs (top view) of color palettes generated in glucomannan-Ir-glass with tunable polymer layer thickness. Metal film thickness: 3 nm.

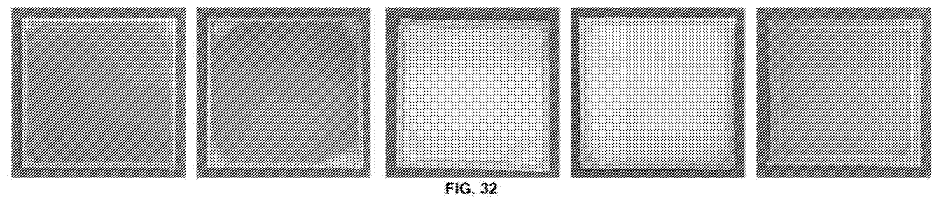

FIG. 33 (A) A polymer-metal-substrate trilayer thin-film transducer. B, C) The colorless PVP-PDMS film with the PVP layer thickness comparable to that in the blue-colored PVP-Ir-PDMS film. D, E) The Ir-PDMS film showing light grayish color. (F) Photographs (top view) of color palettes generated in PVP-Ir-PDMS films with tunable polymer layer thickness. (G) Reflection spectra (θ=0°) of different colors generated by PVP—Ir-PDMS films. (H) Front-side photograph (inset) and reflection spectrum (θ=0°) of the blue-colored PVP-Ir-PDMS film, and (I) back-side photograph (inset) and transmission spectrum of the same film. (J) Front-side photograph (inset) and reflection spectrum (θ=0°) of the green-colored PVP-Ir-PDMS film, and (K) back-side photograph (inset) and transmission spectrum of the same film. Metal film thickness: (D-G) 5 nm. Scale bars: 1 cm.

FIG. 34 demonstrates that the PVP-Ir-PDMS film shows strong coupling of constructive interference reflected colors (front-side view) and complementary destructive interference transmitted colors (back-side view) on opposite sides of the film. (A) A traditional color wheel. Each color serves as the complement of the opposite color across the wheel. (B) Front-side and (C) back-side photographs (top view) of PVP-Ir-PDMS films with tunable colors. Metal film thickness: 5 nm. Scale bars: 1 cm.

FIG. 35 (A) SEM image of blue-colored PVP-Ir-PDMS film. Scale bar: 1 μm. Average thickness measured from the SEM image is 300 nm. Inset is the corresponding image (top view). Scale bar: 1 cm. (B) Reflectance spectrum (θ=0°) of the same PVP-Ir-PDMS film. The arrow on the spectrum shows the calculated peak position of 459 nm for the second order (m=2) of reflection, which is in fairly good agreement with the experimental peak position of 469 nm.

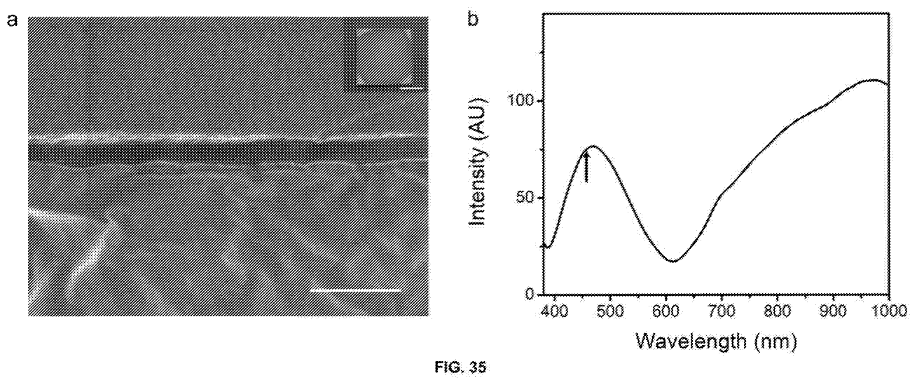

FIG. 36 (A) Top-view and (B) side-view photographs of color palettes generated in PVP-Ir-PDMS films with tunable polymer layer thickness. Metal film thickness: 5 nm. Scale bars: 1 cm.

FIG. 37 (A) Images of the PVP-Ir-PDMS film at different viewing angles relative to the normal. (B) Reflection spectroscopy of the PVP-Ir-PDMS film at different angles of incidence (θ). The reflection spectra were obtained using a fiber-guided light source (HL-2000, Ocean Optics) and a detector (USB2000+, Ocean Optics). Both light source and detector were varied at the same angle relative to the normal. (C) Comparison of the observed reflection peak positions at various 0 values with corresponding predicted reflection peak positions based on Equation 4. d₂: 300 nm. Metal film thickness: 5 nm. Scale bar: 1 cm.

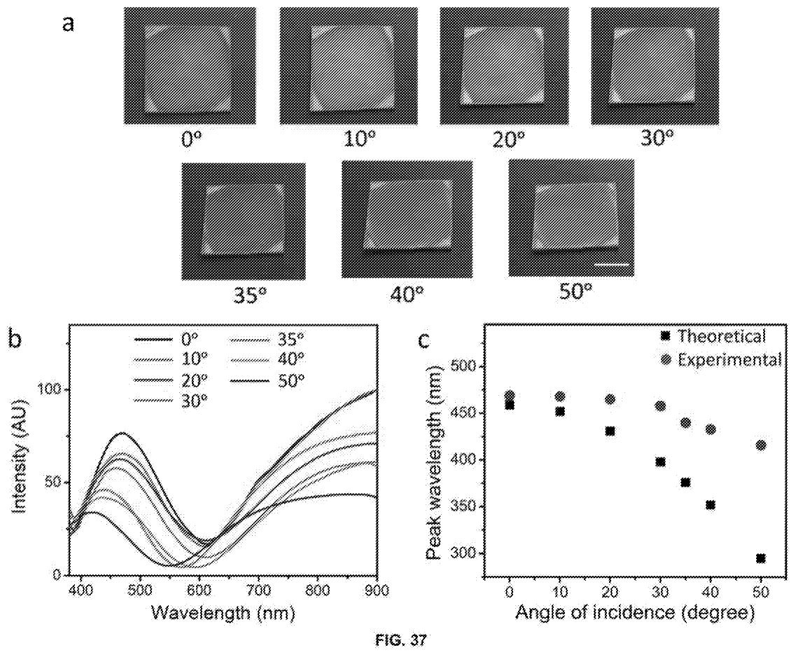

FIG. 38 is RIC for humidity sensing. (A) Sensing mechanism for water vapor. (B) Photographs (top view) of the PVP-Ir-glass film at different static humidity levels. Metal film thickness: 5 nm. Scale bars: 1 cm.

FIG. 39 shows the humidity sensing mechanism. Comparison of the experimental and theoretical reflection peak positions for the PVP-Ir-glass at different static RH levels between 20 and 70%.

FIG. 40 A, B) Dynamic reflectance spectra (θ=0°) of the PVP-Ir-glass film in (A) response to and (B) recovery from water vapor, respectively.

FIG. 41 is photographs (top view) of the PVP-Ir-glass film in (A) response to and (B) recovery from the localized exposure to water vapor, respectively. (C) No response and color change when the PVP-Ir-glass film is exposed to hexane vapor. Metal film thickness: 5 nm. Scale bars: 1 cm.

FIG. 42 shows the dynamic reflectance spectra (θ=0°) of the PVP-Ir-glass film in response to water vapor.

FIG. 43 shows the dynamic reflectance spectra (θ=0°) of the PVP-Ir-glass film in recovery from water vapor.

FIG. 44 is the reflection spectra (θ=0°) of the PVP-Ir-glass film before and after exposure to water vapor.

FIG. 45 (A) Photograph (top view) of the green-colored PVP-Ir-glass film before thermal crosslinking. (B) Photograph of the resulting blue-colored PVPP-Ir-glass film after heating at 200° C. for 1.5 h, which leads to thermal crosslinking of PVP to form PVPP and decrease in film thickness. (C) Photograph of the blue-colored PVPP-Ir-glass film after rinsing in DI water to remove any unreacted PVP residue. (D) Corresponding reflection spectra (θ=0°) of the films in (A-C), respectively. Metal film thickness: 5 nm. Scale bars: 1 cm.

FIG. 46 (A) Photographs (top view) of the PVPP-Ir-glass film before (left) and after dipping of lower part in water for 10 s followed by blow drying with nitrogen (right). Red broken rectangle indicates the dipped region. Since PVPP is insoluble in water, the RIC film remains intact after dipping into the water. (B) Photographs (top view) of the PVP-Ir-glass film before (left) and after dipping of lower part in water for 10 s followed by blow drying with nitrogen (right). Red broken rectangle indicates the dipped region. Since PVP is soluble in water, the PVP layer in the dipped region is removed after dipping into the water. (C) Reflectance spectra (θ=0°) of encircled region in (A) before and after dipping test. (D) Reflectance spectra (θ=0°) of encircled region in (B) before and after dipping test. Metal film thickness: 5 nm. Scale bars: 1 cm.

FIG. 47 is photographs (top view) of the PVPP-Ir-glass film in (A) response to and (B) recovery from the localized exposure to water vapor, respectively. Metal film thickness: 5 nm. Scale bars: 1 cm.

FIG. 48 (A) Little effects of number of humidity sensing cycles on wavelength shift from blue to red color and corresponding response time of the PVPP-Ir-glass film upon localized exposure to water vapor. (B) Reflection spectra (θ=0°) of the PVPP-Ir-glass film before cycle #1 and after cycle #50 of localized exposure to water vapor. C, D) Corresponding photographs (top view) of the PVPP-Ir-glass film (C) before and (D) after 50 cycles of the localized exposure to water vapor at encircled region, respectively. Metal film thickness: 5 nm. Scale bars: 1 cm.

FIG. 49 (A) Little effects of number of humidity sensing cycles on wavelength shift from blue to red color and corresponding response time of the PVPP-nichrome-glass film upon localized exposure to water vapor. (B) Reflection spectra (θ=0°) of the PVPP-nichrome-glass film before cycle #1 and after cycle #50 of localized exposure to water vapor. C, D) Corresponding photographs (top view) of the PVPP-nichrome-glass film (C) before and (D) after 50 cycles of the localized exposure to water vapor at encircled region, respectively. Metal film thickness: 5 nm. Scale bars: 1 cm.

FIG. 50 is photographs (top view) of the Nafion-Ir-glass film in response to and recovery from the localized exposure to water vapor, respectively. Metal film thickness: 5 nm. Scale bars: 1 cm.

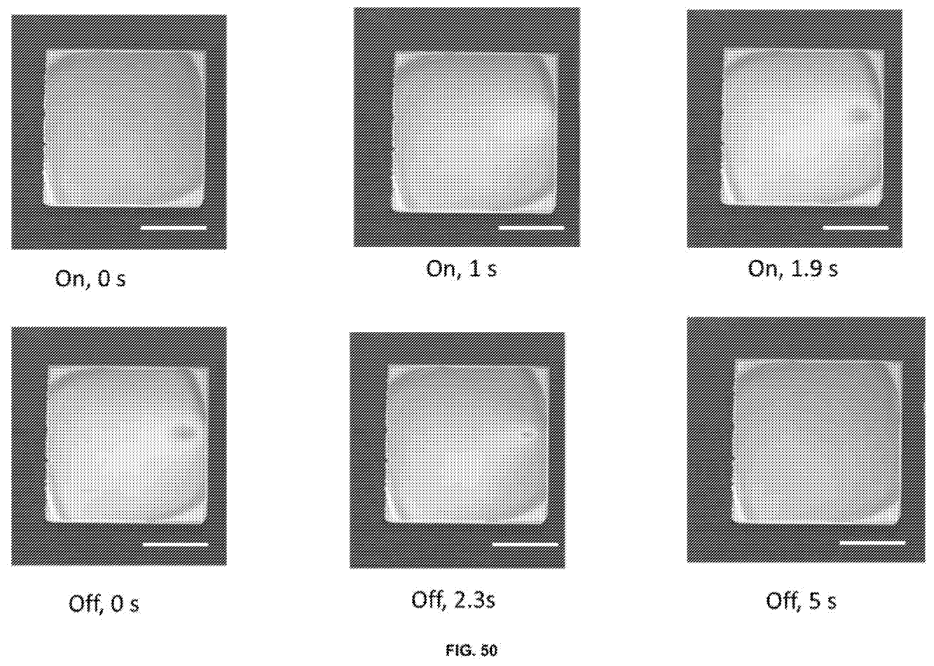

FIG. 51 shows a stimuli-sensing window with a metal layer of 3 nm thickness and transparent substrate that has both good transparency and bright interference coloration. The sensing layer faces inside.

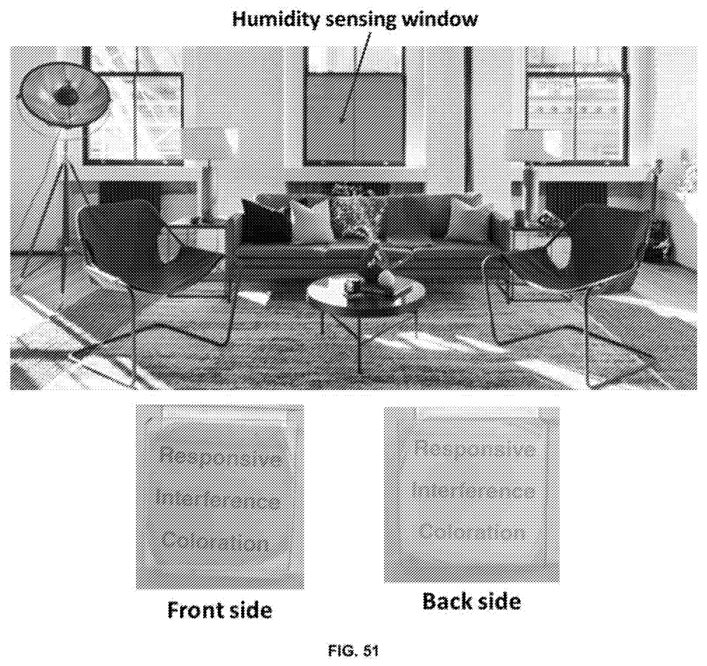

FIG. 52 is a demonstration of a humidity-sensing window made of PVP-Ir-glass. A, D, F) Top view from the PVP side in (D) response to and (F) recovery from the localized exposure to water vapor, respectively. (B) A traditional color wheel. Each color serves as the complement of the opposite color across the wheel. C, E, G) Top view from the glass side in (E) response to and (G) recovery from the localized exposure to water vapor, respectively. Metal film thickness: 3 nm. Scale bars: 1 cm.

FIG. 53 demonstrates that (A) PVPP-Ir-glass and (B) Nafion-Ir-glass films show significant color change when they are moved from the (C) dry soil surface to (D) wet soil surface.

FIG. 54 is a schematic illustration of the transparent and flexible RIC film as a wearable sweat sensor.

FIG. 55 (A) A traditional color wheel. (B) front-side and (C) back-side photographs (top-view) of PVPP-Ir-PDMS film. D, E) PVPP-Ir-PDMS film used as a non-wearable sensor: (D) Top view photograph of the film from the PDMS side placed on top of a dry skin; (E) Top view from the PDMS side in response to a moist sweaty skin (after 15 minutes of exercise). F, G) PVPP-Ir-PDMS film as a wearable sensor. Top view photograph of the film from the PDMS side (F) before and (G) after 15 minutes of exercise. (H) Reflection spectra (θ=0°) of the corresponding film before and after sweat sensing. Metal film thickness: 5 nm. Scale bars: lcm.

FIG. 56 is RIC for organic vapor sensing. Sensing mechanism for hexane vapor.

FIG. 57 A, B) Dynamic reflectance spectra (θ=0°) of the PDMS-Ir-glass film in (A) response to and (B) recovery from hexane vapor, respectively. Metal film thickness: 5 nm. Scale bars: 1 cm.

FIG. 58 (A) No response and color change when the PDMS-Ir-glass film is exposed to water vapor. B, C) Photographs (top view) of the PDMS-Ir-glass film in (B) response to and (C) recovery from the localized exposure to hexane vapor, respectively. Metal film thickness: 5 nm. Scale bars: 1 cm.

FIG. 59 is dynamic reflectance spectra (θ=0°) of the PDMS-Ir-glass film in response to hexane vapor.

FIG. 60 is dynamic reflectance spectra (θ=0°) of the PDMS-Ir-glass film in recovery from hexane vapor.

FIG. 61 is the reflection spectra (θ=0°) of the PDMS-Ir-glass film before and after exposure to hexane vapor.

FIG. 62 shows no response and color change when the PC-Ir-glass film is exposed to (A) water vapor and (B) hexane vapor. Metal film thickness: 5 nm. Scale bars: 1 cm.

FIG. 63 is photographs (top view) of the Nafion-Ir-glass film in response to and recovery from the localized exposure to ethanol vapor, respectively. Metal film thickness: 5 nm. Scale bars: 1 cm.

FIG. 64 is photographs (top view) of the Nafion-Ir-glass film in response to and recovery from the localized exposure to methanol vapor, respectively. Metal film thickness: 5 nm. Scale bars: 1 cm.

FIG. 65 is photographs (top view) of the Nafion-Ir-glass film in response to and recovery from the localized exposure to acetone vapor, respectively. Metal film thickness: 5 nm. Scale bars: 1 cm.

FIG. 66 demonstrates that the Nafion-Ir-glass film exhibits blue-shift from 469 nm to 452 nm in response to ammonia vapor, arising from the ammonia-induced decrease of the Nafion layer thickness. In contrast, the Nafion-Ir-glass film shows red-shift from 469 nm to 525 nm in response to triethylamine vapor, arising from the triethylamine-induced increase of the Nafion layer thickness. This result suggests that it is possible to use the Nafion-based RIC sensors to differentiate different amines with various sizes. Unlike other organic vapors, the ammonia/amine-induced color change in Nafion-Ir-glass films is irreversible without further chemical treatment. The Nafion-based RIC sensors can be fully recovered by HCl treatment. Metal film thickness: 5 nm. Scale bars: 1 cm.

FIG. 67 shows that unlike other organic vapors, the ammonia/amine-induced color change in Nafion-Ir-glass films is irreversible without further chemical treatment. The Nafion-based RIC sensors can be fully recovered by HCl treatment. Metal film thickness: 5 nm. Scale bars: 1 cm.

FIG. 68 is photographs (top view) of the Nafion-Ir-glass film in response to and recovery from the localized exposure to trifluoroacetic acid vapor, respectively. Metal film thickness: 5 nm. Scale bars: 1 cm.

FIG. 69 is a schematic illustration of self-reporting and self-acting chemical sensor.

FIG. 70 A, C, E) Sensing mechanisms of (C) the trilayer thin-film transducer for (A) water vapor and (E) pentane vapor, respectively. B, D) Photographs (top view) of the PVP-Ir-PDMS film in response to the localized exposure to water vapor. D, F, G) Photographs of (F) top view and (G) side view of pentane vapor-induced bending deformation of the PVP-Ir-PDMS film. (H) Reflection spectra (θ=0°) of the encircled area C of the PVP-Ir-PDMS film in (D) before and upon exposure to water vapor. I, J) Reflection spectra (θ=0°) of the encircled area (I) A and (J) B of the PVP-Ir-PDMS film in (D) before and upon exposure to pentane vapor, respectively. To acquire the reflection spectra (θ=0°) of the encircled area B, the fiber optic probe is oriented perpendicular to the plane of the area B of the film for both unbent and bent shapes. Metal film thickness: 5 nm. Scale bars: 5 mm.

FIG. 71 (A) Side-view photographs of PVP-Ir-PDMS film in response to different concentrations of pentane vapor. (B) Curvature of the PVP-Ir-PDMS film as a function of concentration and partial pressure of pentane. (C) Long-term stability of PVP-Ir-PDMS films. Curvature of the film as a function of number of cycles of localized exposure to pentane vapor. Metal film thickness: 5 nm. Scale bar: 1 cm.

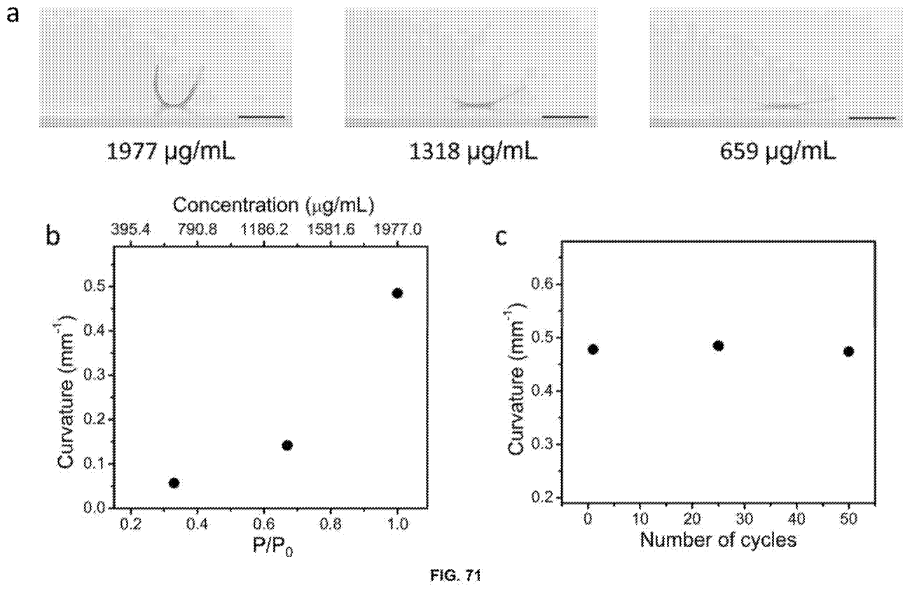

FIG. 72 is RIC for temperature sensing. (A) Sensing mechanism for temperature. (B) Photographs (top view) of the PDMS-Ir-glass film at different temperatures. (C) Reflectance spectra (θ=0°) of the PDMS-Ir-glass film in response to temperature change. Metal film thickness: 5 nm. Scale bars: 1 cm.

FIG. 73 (A) Sensing mechanism for compressive force. (B) Photographs (top view) of the reversible color change in the PVP-Ir-PDMS film in response to localized compressive force induced by a glass stamp with triangular, line, or circular shape, respectively. Metal film thickness: 5 nm. Scale bar: 1 cm.

FIG. 74 (A) The polymer-metal-substrate trilayer interference coloration design. B, C) Change in pixels of the initial blue color with mechanical strain in (B) kirigami I and (C) kirigami II films. D, H, L) Schematic illustration of uniaxial stretching of (D) film without cuts, (H) kirigami I film, and (L) kirigami II film. Gray lines and arrows represent cuts and load direction, respectively. E-G, I-K, M-O) Photographs (top view) of E-G) PVP—Ir-PDMS film without cuts, I-K) PVP-Ir-PDMS kirigami I film, and M-O) PVP-Ir-PDMS kirigami II film at different strains. Metal film thickness: 5 nm. Scale bar: 1 cm.

FIG. 75 A-C) Photographs (top view) of the PVP-Ir-PDMS film exhibiting strain-induced reflectance and transmittance change when subjected to (A) 0%, (B) 30%, and (C) 60% strain, respectively. (D) Reflection spectra (θ=0°) of the PVP-Ir-PDMS film at different strains. (E) Transmission spectra of PVP-Ir-PDMS film at different strains. Metal film thickness: 5 nm. Scale bar: 1 cm.

FIG. 76 A-C) Approximate areas of the PVP layer used in calculation at (A) 0%, (B) 30%, and (C) 60% strain, respectively. (D) Comparison of the experimental and calculated reflection peak wavelengths of the PVP-Ir-PDMS film at different strains. The calculation assumes that there is no PVP/metal cracking upon mechanical stretching. Metal film thickness: 5 nm. Scale bar: 1 cm.

FIG. 77 A, B) Schematic illustration of uniaxial stretching of the PVP-Ir-PDMS film. C, D) Optical microscopic images of the PVP-Ir-PDMS film at (C) 0% and (D) 60% strain, respectively. Black arrows indicate the stretching direction. White arrows show examples of PVP/metal cracks at 60% strain. Scale bar: 25 μm.

FIG. 78 shows mechanochromic properties of the PVP-Ir-PDMS film without cuts as the reference. (A) The polymer-metal-substrate trilayer interference coloration design. (B) Reflection spectra (θ=0°) corresponding to Spot A at 0% and 22% strain, respectively. (C) Schematic illustration of uniaxial stretching of the film without cuts. D-F) Photographs (top view) of the PVP-Ir-PDMS film without cuts at (D) 0%, (E) 13%, and (F) 22% strain, respectively. Metal film thickness: 5 nm. Scale bar: 1 cm.

FIG. 79 (A) Schematic illustration of uniaxial stretching of the kirigami I film, where the load direction is at 45° to the cuts. B, C) Photographs (top view) of the PVP-Ir-PDMS kirigami I film at (B) 0% and (C) 22% strain, respectively. D, E) Photographs (side view) of the PVP-Ir-PDMS kirigami I film at (D) 0% and (E) 22% strain, respectively. (F) Reflection spectra (θ=0°) corresponding to Spot B at 0% and 22% strain, respectively. (G) Reflection spectra (θ=0°) corresponding to Spot B at 0% strain after cycle #1, #25, and #50 to 22% strain, respectively. Metal film thickness: 5 nm. Scale bar: 1 cm.

FIG. 80 (A) Schematic illustration of uniaxial stretching of the kirigami II film, where the load direction is at 0°/90° to the cuts. B, C) Photographs (top view) of the PVP-Ir-PDMS kirigami II film at (B) 0% and (C) 20% strain, respectively. D, E) Photographs (side view) of the PVP-Ir-PDMS kirigami II film at (D) 0% and (E) 20% strain, respectively. (F) Reflection spectra (θ=0°) corresponding to Spot C at 0% and 20% strain, respectively. Metal film thickness: 5 nm. Scale bar: 1 cm.

FIG. 81 (A) Schematic illustration of uniaxial stretching of the kirigami I film, where the load direction is at 45° to the cuts. b-g) Photographs (top view) of the PVP-Ir-PDMS kirigami I film at (B) 0%, (C) 5%, (D) 9%, (E) 13%, (F) 17%, and (G) 22%, respectively. (H) Schematic illustration of uniaxial stretching of the kirigami II film, where the load direction is at 0°/90° to the cuts. I-N) Photographs (top view) of the PVP-Ir-PDMS kirigami II film at (I) 0%, (J) 5%, (K) 9%, (L) 13%, (M) 17%, and (N) 22%, respectively. Metal film thickness: 5 nm. Scale bar: 1 cm.

FIG. 82 (A) Principle of tunable reflectivity shield mechanochromic approach. B-D) Photographs (top view) of PVP-Ir-Dyed PDMS film at 0%, 30%, and 60% strain, respectively. Metal film thickness: 5 nm. Scale bar: 1 cm.

FIG. 83 shows the chemical structure of Sudan III dye (1-((4-(phenylazo)-phenyl)azo)-2-naphthalenol).

FIG. 84 is the characterization of the dyed PDMS film. (A) Photograph of the dyed PDMS film. Scale bar: 1 cm. (B) Absorption spectrum of the dyed PDMS film showing peaks at ˜ 361 and 501 nm, respectively. (C) Transmission spectrum of the dye PDMS film. (D) Reflection spectrum of the dyed PDMS film showing a broad peak in the red-orange region (˜642 nm), which corresponds to the complementary absorption wavelength of green color at ˜ 501 nm observed in (B).

FIG. 85 (A) Reflection spectra (θ=0°) of PVP-Ir-Dyed PDMS film at 0%, 30%, and 60% strain, respectively. (B) Change in blue and red values, respectively, with mechanical strain in PVP-Ir-Dyed PDMS film. (C) SEM of Ir-PDMS film in its pristine 0% strain state, 60% strain state, and released 0% strain state, respectively. Green arrows indicate stretching direction. Metal film thickness: 5 nm. Scale bar: 5 μm.

FIG. 86 A, B) Reflection and transmission spectra of the Ir-Dyed PDMS film at 0% and 60% strain, respectively. C, D) Reflection and transmission spectra of the Ir-PDMS film at 0% and 60% strain, respectively. Metal film thickness: 5 nm.

FIG. 87 is photographs (top view) of the PVP-Ir-Dyed PDMS film at 0%, 10%, 20%, 30%, 40%, 50%, and 60% strain, respectively. Metal film thickness: 5 nm. Scale bar: 1 cm.

FIG. 88 shows transmission spectra of the PVP-Ir-Dyed PDMS film at 0%, 30%, and 60% strain, respectively.

FIG. 89 shows reflection spectra (θ=0°) of the PVP-Ir-Dyed PDMS film at 0% strain after cycle #1, #25, and #50 to 60% strain, respectively.

FIG. 90 is photographs (top view) of different color patterns generated in A, B) PVP-Ir-Dyed PDMS, and (C) PVP-Ir-PDMS film, respectively. Metal film thickness: 5 nm. Scale bars: 1 cm.

FIG. 91 shows schematic illustration and photographs (top view) of mechanochromic response of patterned PVP-Ir-Dyed PDMS film with load direction at A, B) 45° and C, D) 0°/90° to blue-colored cross pattern. Metal film thickness: 5 nm. Scale bars: 1 cm.

### DETAILED DESCRIPTION

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. Responsive Interference Coloration System

The system of the invention generally relates to a metal or metal alloy thin film deposited or coated on a substrate surface and further overlaid with a polymer layer of a stimulus-responsive polymer. The thin film functions as an optical filter that reflects sufficient incident light (i.e., electromagnetic radiation) for constructive interference, while simultaneously filtering out unwanted wavelengths of light. The thin film has a thickness configured to filter electromagnetic radiation, such as visible light, ultraviolet (UV) light, and infrared (IR) light. The thin film thickness determines the intensity of reflected light color for visible light. The stimulus-responsive polymer changes properties (e.g., dimensions) in response to changes in environmental conditions, which manifests as a change in observable color from incident visible light.

The thin metal or metal alloy film may be deposited on the substrate by physical or chemical deposition techniques. Physical deposition or physical vapor deposition techniques include evaporation and sputtering techniques. For example, evaporation may be vacuum thermal evaporation, electron beam evaporation, laser beam evaporation, arc evaporation, molecular beam epitaxy, or ion plating evaporation. Sputtering may be direct current sputtering or radio frequency sputtering. Chemical deposition techniques include sol-gel, chemical bath, spray pyrolysis, plating, and chemical vapor deposition. The plating may be electroplating or electroless deposition.

The thin metal or metal alloy film is a continuous film over at least a portion of the first surface of the substrate. The continuous film is thus distinguished from metallic paint coatings that are characterized by metal flakes powder dispersed throughout the coating.

The thin metal or metal alloy film may be composed of various types of metals or metal alloys selected from aluminum, iridium, silver, nichrome, copper, titanium, chromium, nickel, palladium, zinc, iron, carbon, gallium, indium, silicon, germanium, tin, selenium, or tellurium, or a combination. Preferred metals include iridium, silver, aluminum, copper, iron, zinc, titanium. A suitable alloy is nichrome.

The metal or metal alloy film generally may have a thickness between about 0.5 to about 15 nm. The thickness may be 0.5 to 15 nm, 0.5 to 14 nm, 0.5 to 13 nm, 0.5 to 12 nm, 0.5 toll nm, 0.5 to 10 nm, 0.5 to 9 nm, 0.5 to 8 nm, 0.5 to 7 nm, 0.5 to 6 nm, 0.5 to 5 nm, 0.5 to 4 nm, 0.5 to 3 nm, 0.5 to 2 nm, 0.5 to 1 nm, 1 to 15 nm, 1 to 14 nm, 1 to 13 nm, 1 to 12 nm, 1 to 11 nm, 1 to 10 nm, 1 to 9 nm, 1 to 8 nm, 1 to 7 nm, 1 to 6 nm, 1 to 5 nm, 1 to 4 nm, 1 to 3 nm, 1 to 2 nm, about 1, about 2, about 3, about 4, about 5, about 6, about 7, about 8, about 9, or about 10 nm. Any of the metals or metal alloys described herein for the thin film may be used in any thickness.

The polymer layer may be coated on the metal or metal alloy thin film using any suitable polymer coating technique such as spin-coating, dip-coating, spraying, plasma coating, thermal coating, inkjet printing, or chemical vapor deposition. The polymer layer is deposited with a thickness of 5 to 800 nm under ambient and equilibrated conditions. The polymer layer may have a thickness of 700 to 800 nm, 600 to 800 nm, 500 to 800 nm, 400 to 800 nm, 300 to 800 nm, 200 to 800 nm, 100 to 800 nm, 50 to 800 nm, 5 to 10 nm, 5 to 20 nm, 5 to 30 nm, 5 to 40 nm, 5 to 50 nm, 50 to 100 nm, 100 to 200 nm, 200 to 300 nm, 300 to 400 nm, 400 to 500 nm, 500 to 600 nm, or 600 to 700 nm.

The stimulus-responsive polymer (also known as a smart polymer) is any polymer that is responsive to one or more of a physical, chemical, or biological stimulus. A stimulus-responsive polymer changes properties in response to a stimulus from the surrounding environment. Changes in properties include a thickness change, a change in refractive index, a change in shape, or a change of other physical or chemical properties of the polymer layer. Physical stimuli include, for example, heating, cooling, electromagnetic radiation (e.g. UV, visible, IR), an electrical signal, a magnetic signal, or mechanical force (e.g., pressure, vibration such as an acoustic signal). Mechanical forces include stretching, bending, pressing, vibrating, etc. Chemical stimuli include, for example, chemical substances or mixtures of chemical substances. Chemical substances include elements and chemical compounds (e.g., salts, molecules including biomolecules). Chemical substances may be in the form of gas, liquid, solid, or chemical substances dissolved in a solvent. Dissolved chemical substances may be cations, anions, molecules, or biomolecules. A particular cation is H⁺, the measurement of which in aqueous solution is pH (i.e., the chemical stimulus is pH). Gases include any vapors such as water vapor (i.e., humidity) or solvent vapors, such as vapors of the organic solvents described below. Liquids include water, non-aqueous solvents (e.g., organic solvents such as hydrocarbons (e.g., pentane, hexane), halogenated hydrocarbons (e.g., chloroform, carbon tetrachloride, dichloromethane), alcohols (e.g., methanol, ethanol), ethers (e.g., diethyl ether, tetrahydrofuran), esters (e.g., ethyl acetate), ketones (e.g., acetone, 2-butanone), dimethylsulfoxide, dimethylformamide, N-methylpyrrolidone), or mixtures thereof. A chemical stimulus may be a redox stimulus. Biological stimuli include, for example, glucose or an enzyme. Stimulus-responsive polymers include those described in Cohen Stuart et al., Nature Materials (2010) 9, 101-113; Wei et al., Polym. Chem. (2017) 8, 127; and Ganesh et al., RSC Adv. (2014) 4, 53352, which are incorporated herein by reference.

Suitable classes of polymers include polyvinylpyrrolidone, polyvinylpolypyrrolidone, fluoropolymers, polycarbonate, polystyrene, polyethylene, polypropylene, polyurethane, polyvinyl chloride, polyacrylonitrile, polytetrafluoroethylene, polychlorotrifluoroethylene, phenol-formaldehyde resin, para-aramid, poly(methyl methacrylate), parylene, polyethylene terephthalate, polychloroprene, polyamide, epoxy resins, polyimide, poly-p-phenylene-2,6-benzobisoxazole, polysiloxanes, polyphosphazene, polyarylsulfones, polybutylene, polybutylene terephthalate, polyetheretherketone, polyetherimide, polyetherketoneketone, perfluoroalkoxy resin, polymethyl pentene, poly(p-phenylene), polyethyleneoxide, polyphenylene ether, polyphenylene oxide, polyphenylene sulfide, polyphenylene sulfide sulfone, polyvinyl alcohol, polyvinylidene chloride, polyvinylidene fluoride, polyvinyl fluoride, poly(lactic acid), polyisoprene, styrene-butadiene rubber, poly(vinyl acetate), polyacetal, polycarbosilanes, polysilazanes, polyhydroxyalkanoates, polycyclodextrins, polybutylene succinate, polycaprolactone, polyanhydrides, cellulose acetates, nitrocellulose, vitrimers, ferrocene-based polymers, hydrogels, organogels, block copolymers, poly(ionic liquid)s, radical polymers, sol-gel precursors, supramolecular polymers, polydopamine, polyamines, covalent organic frameworks, metal-organic frameworks, fluorescent polymers, and their derivatives and composites, or a combination thereof.

Other polymer classes include conjugated polymers and their derivatives and composites: polythiophenes, polyanilines, polyacetylenes, polypyrroles, poly(phenylene vinylene)s, polyparaphenylenes, poly(phenyleneethynylene)s, polyfluorenes.

Other polymer classes include natural or bio-polymers, and their derivatives and composites: glucomannan. cellulose, nanocellulose, lignin, starch, polysaccharides, chitin, chitosan, gelatin, collagen, keratin, silk, enzymes, DNAs, RNAs, polypeptides, proteins, antibodies, lipids.

Other polymer classes include shape-memory polymers, shape-changing polymers, or stimuli-responsive polymers, and their derivatives and composites: Nafion (tetrafluoroethylene-perfluoro-3,6-dioxa-4-methyl-7-octenesulfonic acid copolymer), liquid crystalline polymers, liquid crystalline elastomers, azopolymers (polymers that contain azo group), thermo-responsive polymers, photo-responsive polymers, electroactive polymers, magneto-responsive polymers, bio-responsive polymers, chemical-responsive polymers, mechano-responsive polymers, redox-responsive polymers, water-responsive polymers, pH-responsive polymers.

Other polymer classes include ionomers and their derivatives and composites. Ionomers include copolymers of ethylene and acrylic and/or methacrylic acid (Surlyn, Nucrel, Primacor, Eltex, Optema) and perfluorinated sulfonic acid ionomers such as tetrafluoroethylene-perfluoro-3,6-dioxa-4-methyl-7-octenesulfonic acid copolymer (Nafion) Optema.

Other polymer classes include carbon materials and nanocarbon materials: carbon nanotubes, graphene, graphene oxide, fullerenes, diamond, nanodiamond, diamondoids, carbon black, asphalt, graphyne.

Other polymer classes include 2D nanomaterials: boron nitride, C₃N₄, transition metal dichalcogenides (e.g. MoS₂, WS₂, WTe₂, TiSe₂), transition metal carbides (e.g. Mo₂C, W₂C, WC, TaC, NbC), transition metal oxides, nitrides, phosphides, and arsenides of III A group metals, chalcogenides of IV A group metals, chalcogenides of V A group metals, MXenes.

Other polymer classes include perovskite-structured materials.

The stimuli-responsive polymer may be a derivative or composite of the polymers described above, or a combination of the polymers, and/or their derivatives, and/or composites.

The polymer used in the polymer layer may be a cross-linked polymer.

A preferred group of stimuli-responsive polymers includes polyvinylpyrrolidone, polyvinylpolypyrrolidone, poly dimethylsiloxane, polycarbonate, polystyrene, tetrafluoroethylene-perfluoro-3,6-dioxa-4-methyl-7-octenesulfonic acid copolymer, starch, and glucomannan, and their derivatives and composites, or a combination thereof.

The polymer layer may be transparent or substantially transparent.

The polymer layer may be comprised of polymers, polymer composites, or a combination of different polymers and/or polymer composites.

Any of the stimulus-responsive polymers described herein may be combined with any of the metal or metal alloy thin films and substrates described herein. Any combination of dimensions of the thin film and polymer layer may be used depending on the particular application.

Any substrate material may be generally used with the system disclosed herein. The substrate may be rigid (e.g., glass) or flexible (e.g., an elastomer such as PDMS or rubber). Classes of substrate materials include glass, metal, ceramic, wood, paper, stone, brick, concrete, cement, composite, polymers, or combinations thereof. When a polymer is used as a substrate, it may be a stimulus-responsive polymer, such as polydimethylsiloxane.

In an embodiment the substrate is comprised of a flexible substrate such as silicone elastomer or related materials, rubber or related materials, paper or related materials, or other polymers and polymer composites.

The ability to use substrates such as glass and PDMS allows for a humidity-sensing window, and a self-reporting, self-acting sensor that does not consume external power. Such transparent devices with coupled complementary colors on opposite sides are also desirable for applications such as wearable sensors, where the color change at the on-body side can be transduced into the color change on the opposite side of the film.

The system described herein also provides for patterns of interference coloration on nanoscale, microscale, macroscale, or multiscales by patterning of polymer and/or metal on a substrate using various techniques including but not limited to ink-jet printing, stencil lithography, photolithography, e-beam lithography, soft-lithography, mask-based spraying, mask-based dip-coating, mask-based plasma coating, mask-based thermal coating, mask-based chemical vapor deposition, mask-based sputter coating, patterned electroless plating.

In a representative combination, the substrate is glass, a polymer, or paper; the thin metal film is composed of aluminum; and the stimulus-responsive polymer is polyvinylpolypyrrolidone, starch, or glucomannan.

The system of the invention may be incorporated into various articles of manufacture such as a window or various devices, such as a colorimetric sensor.

In the sensor, the thickness of the polymer layer determines the reflected colors and the thickness of the metal layer controls the intensity of the reflected color. The sensor that responds to external stimuli using reflectance of light and/or transmission of light to produce a color change. The sensor may thus couple the reflected color on one side and transmitted color on another side.

The sensor may be used to detect an external stimulus, including but not limited to, water vapor, humidity, temperature, light, chemicals, biomolecules, mechanical force, and organic vapor. Chemicals such as organic vapors include, for example, ethanol, hexane, pentane, trimethylamine, ammonia, trifluoroacetic acid, etc. A colorimetric stimuli-sensing window may sense stimuli such as humidity, temperature, light, gas, volatile organic compounds, etc.

A colorimetric sensor may monitor soil moisture level.

A mechanochromic sensor has applications in strain sensing, finger printing, stretchable electronics, anti-counterfeiting, and soft robotics.

The sensor may be a self-reporting and/or self-acting sensor that functions without external power.

The sensor may be a wearable sensor for health monitoring, where the stimuli-induced color change at the on-body side can be transduced into the color change on the opposite side of the film.

Multiple sensors may be assembled in a sensor array for multi-stimuli sensing.

An aspect of the invention provides a method of manufacturing an article comprising the system described herein, the method comprising (a) depositing a metal or metal alloy on at least a portion of a first surface of a substrate, the metal or metal alloy being deposited as a thin film with a thickness configured to filter visible light; and (b) coating a stimulus-responsive polymer on the thin film to form a polymer layer.

An aspect of the invention provides a method of detecting a change in an environmental condition comprising (a) contacting an article with a physical, chemical, or biological stimulus, wherein the article comprises the system described herein; and (b) detecting a change in color of the article.

### 3. Examples

### Example 1

### Materials and Methods

Materials. Polyvinylpyrrolidone (PVP) powder was purchased from Alfa Aesar. PC pellets was purchased from Sigma-Aldrich. Polydimethylsiloxane (PDMS) precursors (Sylgard 184) were purchased from Dow Corning, and mixed based on the manufacturer's recommended base to crosslinker ratio of 10:1. PVP solutions in ethanol with PVP loadings from 6 to 9 wt % were prepared and stored at room temperature, PC solutions in chloroform with PC loading of 2 wt %, and PDMS solutions in hexane with PDMS precursors loading of 8 wt % were prepared and stored at room temperature. Ethanol (200 proof) was purchased from Koptec. Pentane was acquired from Sigma-Aldrich. Chloroform and hexane were acquired from Sigma-Aldrich. Nichrome wire was purchased from Ted Pella, Inc. High purity silver wire was purchased from Integrity Beads, Inc. Glass substrates (Micro Slides), were purchased from Corning. Glass microscopic slides were rinsed with acetone and isopropanol and then dried with nitrogen prior to use. 8-10% w/w Nafion alcohol solution was prepared by concentrating 5% w/w stock Nafion Alcohol solution purchased from Alfa Aesar. High purity aluminum wire (diameter: 0.015 inches) was purchased from Ted Pella. Sudan III (1-((4-(phenylazo)-phenyl)azo)-2-naphthalenol) dye was purchased from Allied Chemicals.

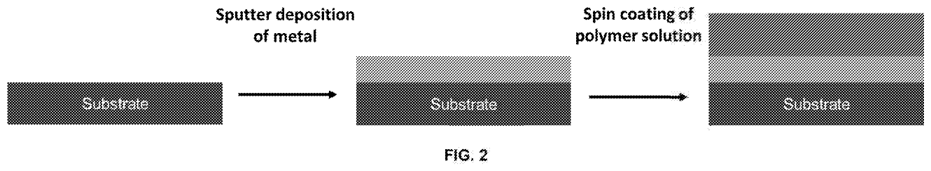

Preparation of Metal Layer. Ultrathin film of iridium is deposited on a desired substrate (e.g. glass, PDMS) in a sputter coating system (model K150X, Quorum Emitech) using a high purity iridium target (Ted Pella, Inc.) under a vacuum pressure of 2×10⁻³ mbar (FIG. 2). Ultrathin films of nichrome, silver, and aluminum were deposited on a desired substrate (e.g. glass, PDMS) in a thermal vacuum evaporation system (Edwards Coating System Inc., model E-306A) using corresponding metal targets under a vacuum pressure of 2×10-4 mbar (FIG. 2).

Preparation of Responsive Interference Coloration (RIC) Films on Glass Substrates. After ultrathin film of metal was deposited on a glass substrate (2.5 cm×2.5 cm), 0.5 mL of the solution of desired polymer (PVP, PC, PDMS, or Nafion-alcohol) was placed or spin-coated on top of the metal-coated glass substrate. The spin coating was carried out at specific spinning rates (1500-7000 rpm) for 30 seconds using a spin coater (model P6700, Specialty Coating Systems, Inc.). Since the reflected color is controlled by the polymer layer thickness, appropriate spinning rate and concentration of the polymer solution were used to obtain the desired color. The obtained color depends on both concentration and spin-coating speed. The entire process was performed at ambient humidity (45±5 RH %) and room temperature (22±2° C.). RIC color patterns were achieved by patterning of the metal layer with a pre-cut plastic stencil mask during the metal coating, followed by spin coating of the polymer layer.

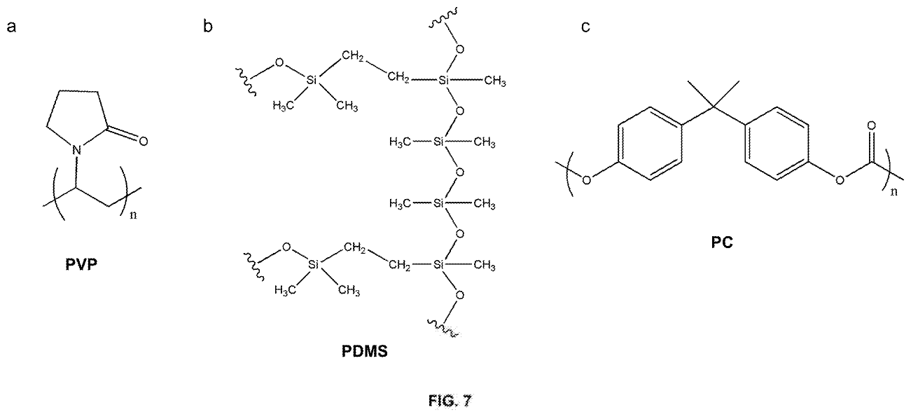

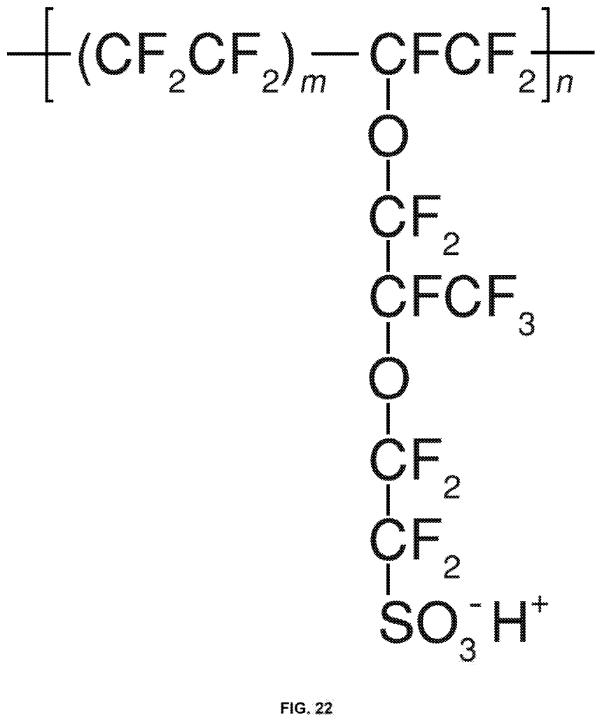

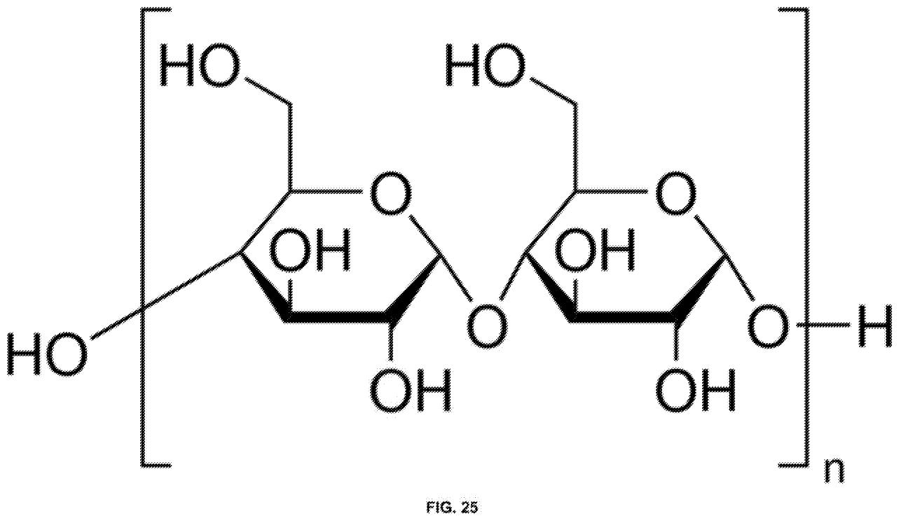

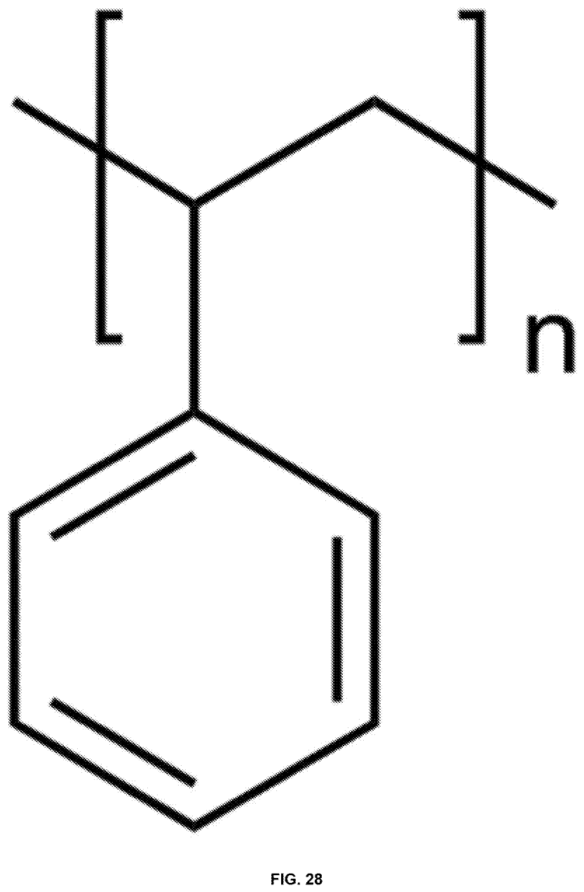

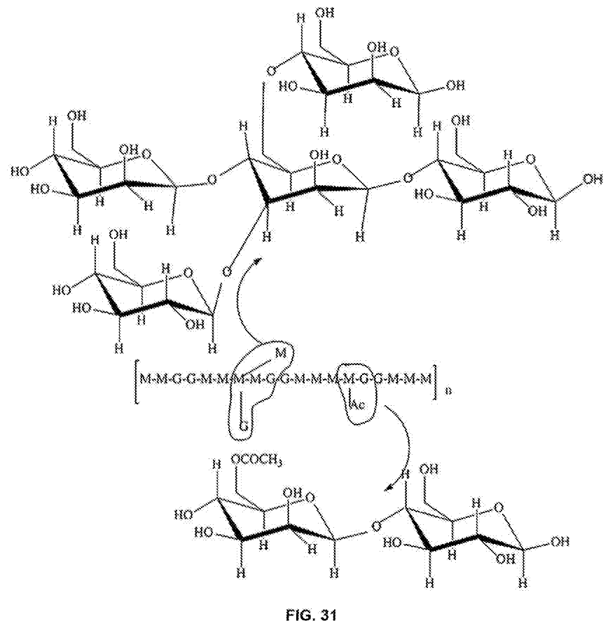

Preparation of Various Polymer-Metal-Glass Films. After ultrathin film of metal was deposited on a glass substrate (2.5 cm×2.5 cm), ˜ 0.5 mL of the solution of desired polymer (PVP (FIG. 7A), PC (FIG. 7C), PDMS (FIG. 7B), Nafion (FIG. 22), starch (FIG. 25), PS (FIG. 28), glucomannan (FIG. 31), etc.) was placed on top of the metal-coated glass substrate. The spin coating was carried out at appropriate spinning rates for 30 seconds using a spin coater (model P6700, Specialty Coating Systems, Inc.). Since the reflected color is controlled by the polymer layer thickness, appropriate spinning rate and concentration of the polymer solution were used to obtain the desired color. The entire process was performed at ambient humidity (45±5 RH %) and room temperature (22±2° C.). RIC color patterns were achieved by patterning of the metal layer with a pre-cut plastic stencil mask during the metal coating, followed by spin coating of the polymer layer.

Preparation of PVP-Ir-PDMS Films. The PDMS substrates were made by mixing and curing the PDMS precursors at 70° C. overnight or 100° C. for about 3 hours. The fully-cured PDMS film was then cut into small pieces (˜2 cm×2 cm), followed by ultrathin metal layer coating. Subsequently, ˜ 0.4 mL of the PVP solution was placed on the metal-coated PDMS substrate, and then spin-coated at a specific spinning rate for 30 seconds. Since the reflected color is controlled by the polymer layer thickness, appropriate spinning rate and concentration of the PVP solution were used to obtain the desired color.

Preparation of PVP-Ir-PDMS Film. PDMS base and curing agent were mixed at a 10:1 (w/w) ratio. The mixture was cast on silicon wafer and left overnight at room temperature, followed by curing at 80° C. for 4 h. The thickness of the PDMS was maintained at ˜ 750 μm. The fully-cured PDMS film was then cut into small pieces (˜2.5 cm×2.5 cm), followed by deposition of 5 nm ultrathin iridium layer coating in a sputter coating system (model K150X, Quorum Emitech) (FIG. 2). Subsequently, ˜ 0.4 mL of the PVP solution was placed on the metal-coated PDMS substrate, and then spin-coated at a specific spinning rate for 30 seconds (FIG. 2). Since the reflected color is controlled by the polymer layer thickness, appropriate spinning rate and concentration of the PVP solution were used to obtain the desired color.

Preparation of PVP-Ir-Dyed PDMS Film. PDMS base and curing agent were mixed at a 10:1 (w/w) ratio. The Sudan III dye solution in toluene was then added to the PDMS precursors at a loading of 1 mg dye per mL of PDMS base, followed by thorough mixing. The mixture was cast on silicon wafer and left overnight at room temperature, followed by curing at 80° C. for 4 h. The thickness of the PDMS was maintained at ˜ 650 μm. The rest of the sample preparation is similar to that of PVP-Ir-PDMS film.

Preparation of PVPP-Metal-Glass and PVPP-Metal-PDMS Films. Heating of a PVP thin film on various substrates (Ir, nichrome, Al, PDMS, etc.) at 200° C., followed by rinsing in deionized (DI) water to remove any unreacted PVP residue, leads to thermal crosslinking of PVP to form more stable PVPP, which is insoluble in common solvents.

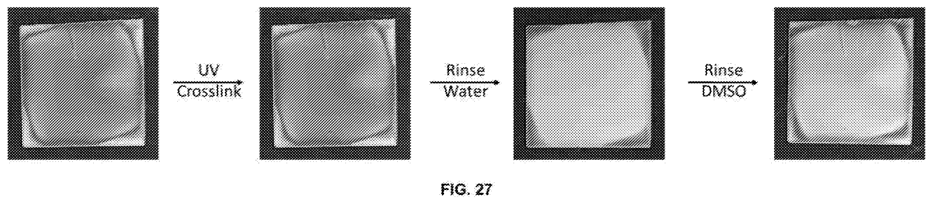

Preparation of UV-Crosslinked Starch-Ir-Glass Films. First, a DMSO solution of starch with 1% of sodium benzoate as a UV sensitizer was used to make a starch-Ir-glass film. Then, UV irradiation of the resulting film in the air, followed by rinsing in water and DMSO, respectively, produces the UV-crosslinked starch-Ir-glass film (FIG. 27).

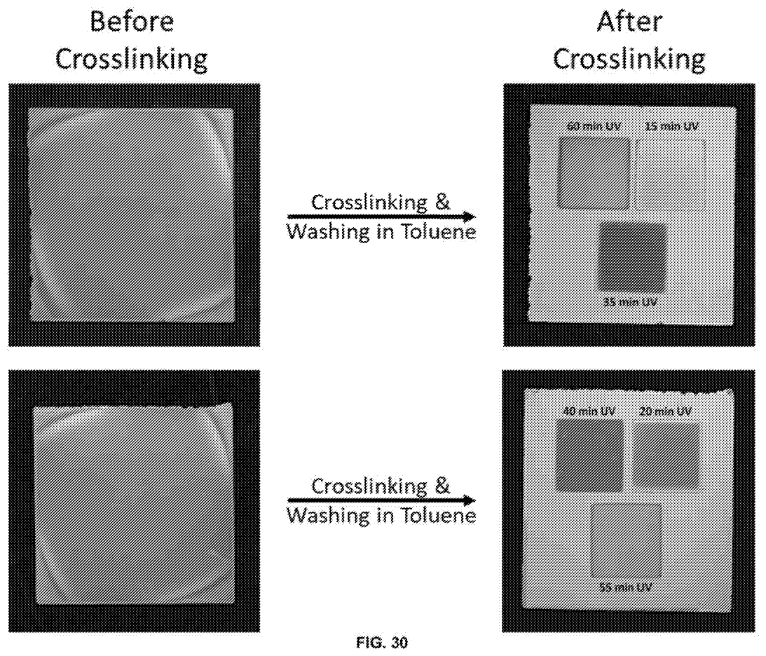

Preparation of UV-Crosslinked PS-Ir-Glass Films. First, a toluene solution of PS was used to make a PS-Ir-glass film. Then, UV irradiation of the resulting film under N2, followed by rinsing in toluene, produces the UV-crosslinked PS-Ir-glass film. To make a color pattern, a mask was used to allow localized UV irradiation of the PS-Ir-glass film, followed by rinsing in toluene. Controlling UV irradiation time at different locations leads to formation of a color pattern (FIG. 30).

Sample Characterizations. The reflection spectra were acquired using a fiber optic spectrometer (USB2000+, Ocean Optics). The incident light was perpendicular to the plane of the film. The transmission and absorption spectra of the samples were recorded with a Cary 5000 UV-Vis-NIR spectrophotometer. Scanning electron microscopy (SEM) was performed using a Hitachi S-4800 field emission scanning electron microscope. The average polymer layer thickness was determined from SEM measurements of 50 location points of the cross section of the polymer layer. Thickness of the substrates were measured with a Mitutoyo Digital Micrometer. Unless otherwise stated, all sample characterization was carried out at ambient humidity (45±5 RH %) and room temperature (22±2° C.).

Stimuli Response Measurements. The static response measurement of the RIC films to different humidity levels was carried out in a home-built humidity-control chamber based on literature (Steele et al., IEEE Sens. J 2008, 8, 1422-1428; Hawkeye and Brett, Adv. Funct. Mater. 2011, 21, 3652-3658). The RH level of the chamber was varied between 20% and 80% by controlling the relative flow rates of dry and wet N₂ gas. Under each humidity condition, the film was kept for 2 hours to ensure fully equilibrated state. The chamber's RH level was monitored with a commercial humidity meter (AcuRite 01083), calibrated with standard salt solutions (Table 1) (Greenspan, J. Res. Natl. Bur. Stand. Sec. A 1977, 81A, 89-96). The chemical vapors (i.e. water and pentane vapors) for sensing experiments were generated by a commercial ultrasonic humidifier (Essential Oil Diffusor, Radha Beauty Co.), and then applied to the samples through a rubber tubing with a small plastic tip (e.g. pipette tip) at the end. The dynamic reflection spectra were acquired continuously using a fiber optic spectrometer (USB2000+, Ocean Optics) with the interval time of 10 ms. Thermal response experiment was performed on a hot plate, and temperature of the RIC film during the experiment was measured with a non-contact infrared thermometer (MICRO-EPSILON thermoMETER LS), which was found to be in good agreement (within +2° C.) with a traditional thermometer.

TABLE 1
To ensure the accuracy of the static humidity-response measurements,
various standard saturated salt solutions were used to calibrate
the humidity-meter at room temperature. The RH % values recorded
with our calibrated humidity meter shown in the table are in close
agreement (within ±1 RH %) with the literature values (Greenspan,
J. Res. Natl. Bur. Stand. Sec. A 1977, 81A, 89-96).

| Saturated salt solutions | Relative humidity (%) |
|---|---|
| CaBr₂ | 17.4 |
| MgCl₂ | 33.2 |
| K₂CO₃ | 44.1 |
| Mg(NO₃)₂ | 53.5 |
| KI | 68.0 |
| NaCl | 74.5 |
| NH₄Cl | 78.0 |
| KCl | 84.1 |

Estimating the Thickness of the PVP Layer Using the Coefficient of Hygroscopic Expansion of PVP. To verify whether the humidity sensing mechanism of the PVP-Ir-glass film is due to the change in thickness of the PVP layer, we calculated the reflection peak position at each increased static RH level using the expected thickness of the PVP layer at corresponding static RH level. The expected thickness of the PVP layer was estimated using the coefficient of hygroscopic expansion of PVP, with respect to the original thickness of the PVP layer measured by SEM. The volumetric change induced by water absorption in PVP can be estimated by Equation 1 (Zhang and Webb, Opt. Lett. 2014, 39, 3026):

$$β = \frac{{ρ}_{w} f W}{300} \qquad ( 1 )$$

Where β is the coefficient of hygroscopic expansion, f is the fraction of the water that contributes to an increase in the PVP volume (Vogt et al., Polymer 2005, 46, 1635), ρ_{W} is the density of water, and W is the water uptake of PVP at 25° C. at specific RH level. As shown in the literature, the water absorption of PVP increases with relative humidity in a non-linear trend (Prudic et al., Eur. J Pharm. Biopharm. 2015, 94, 352). Hence, hygroscopic strain (εₕ) of PVP should be obtained at various RH levels according to Equation 2 (Stellrecht et al., Exp. Techniques 2003, 27, 40).

εₕ=β·W (2)

The hygroscopic strain of PVP determines expected thickness (D) of PVP at each static humidity level with respect to an initial thickness (do) according to Equation 3.

$${ɛ}_{h} = \frac{d - {d}_{0}}{{d}_{0}} \qquad ( 3 )$$

The resulting thickness (d) can be used to predict the expected reflection peak position of PVP using the equation for the condition for constructive thin-film interference as described in the main text.

Verification of Humidity Sensing Mechanism. To determine the reflection peak wavelength of the RIC film at different static RH levels, the sample was placed inside a homemade, transparent humidity chamber. The RH level of the chamber was varied between 20% and 70% by controlling the relative flow rates of dry and wet N₂ gas, and it was monitored with the calibrated commercial humidity meter. Under each humidity condition, the static reflection spectrum was recorded using a fiber optic spectrometer (USB2000+, Ocean Optics) after the film reached equilibrium state. To verify whether the humidity sensing mechanism of the PVP-Ir-glass film is due to the change in thickness of the PVP layer, the reflection peak position was calculated at each increased static RH level using the expected thickness of the PVP layer at corresponding static RH level. The expected thickness of the PVP layer was estimated using the coefficient of hygroscopic expansion of PVP, with respect to the original thickness of the PVP layer measured by SEM. The details can be found in supporting information. Comparison of the observed and calculated reflection peak positions at each static RH level was then used to determine whether the observed reflection wavelength change is caused by change in thickness of the PVP layer.

Humidity Cycle Test. To investigate the long-term stability of the RIC films, both PVPP-Ir-glass and PVPP-nichrome-glass films were subjected to 50 cycles of localized exposure to water vapor in the same region. The dynamic reflection spectra (θ=0°) were acquired continuously using a fiber optic spectrometer (USB2000+, Ocean Optics) with the interval time of 10 ms during the cycle #1, cycle #25, and cycle #50 of the humidity sensing experiments.

Color Analysis. The image color analysis was carried out using the Image Color Summarizer software (http://mkweb.bcgsc.ca/color-summarizer/). The pixel color partitioning was used to quantify the relative change in pixels of the initial blue color with mechanical strain in the kirigami systems. The average RGB color cluster values for the whole sample film at different mechanical strains were obtained to quantify the mechanochromic response in the PVP-Ir-Dyed PDMS film.

### Example 2

### A Versatile Strategy for Transparent Stimuli-Responsive Interference Coloration

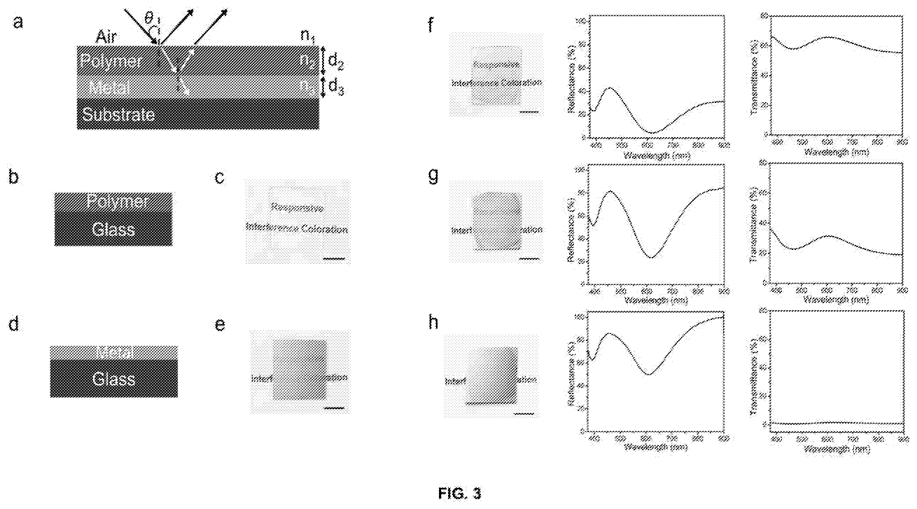

In this work, the thin polymer layer serves as an interference coloration layer, where the reflected color represents the constructive interference, whereas the transmitted color represents the destructive interference. Without the thin polymer layer, the metal-glass film exhibits only light grayish color (FIG. 3D and FIG. 3E). The condition for constructive thin-film interference is determined by Equation 4:

mλ=2n₂d₂ cos θ (4)

where λ is the wavelength giving the maximum reflectivity, m is the order of diffraction (a positive integer), d₂ and n₂ are the thickness and refractive index of the polymer layer, respectively, and θ is the angle of incidence (FIG. 3A) (Kinoshita et al., Rep. Prog. Phys. 2008, 71, 076401; Sun et al., RSC Adv. 2013, 3, 14862-14889). The condition for the destructive thin-film interference follows Equation 5:

(m−½)λ=2n₂d₂ cos θ (5)

where λ represents the wavelength giving the minimum reflectivity (maximum transmissivity) (Kinoshita et al., Rep. Prog. Phys. 2008, 71, 076401; Sun et al., RSC Adv. 2013, 3, 14862-14889).

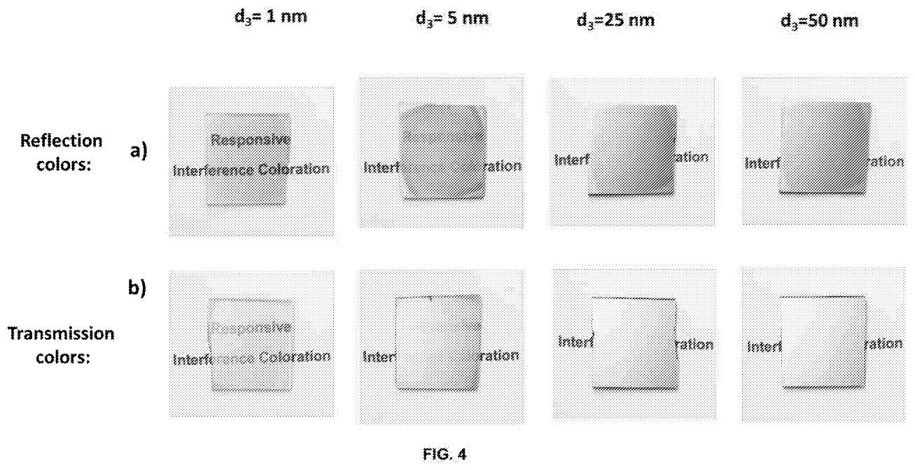

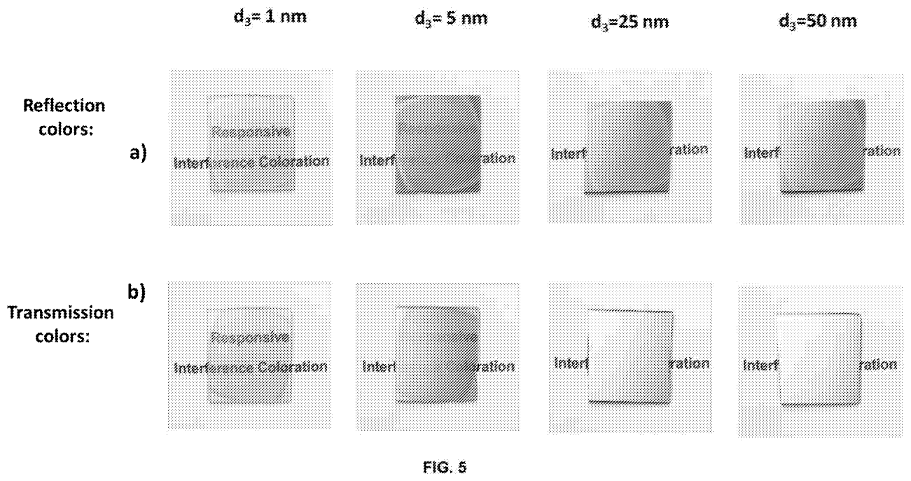

The RIC system is composed of three layers: 1) The thin polymer layer that exhibits stimuli-responsive thin film interference coloration; 2) The ultrathin metal layer that acts an optical filter; 3) The substrate layer. The key concept is to use an ultrathin metal layer as an optical filter instead of high refractive index substrate or highly reflective substrate. Such an optical filter layer allows tuning of the degree of transparency, the constructive interference reflection light, and complementary destructive interference transmission light via changing the metal layer thickness (FIG. 4 and FIG. 5).

The simple RIC system has the following distinctive advantages: 1) Versatile polymer layer choice: A wide range of thermoplastics, thermosets, and polymer composites can be used for rational engineering of stimuli-responsivity, stability, etc. 2) Versatile metal layer choice: A variety of metals and metal alloys such as iridium, silver, nichrome, aluminum, etc. can be selected for target applications and manufacturing processes. 3) Versatile substrate choice: The RIC design is applicable to many substrates, including glass and PDMS.

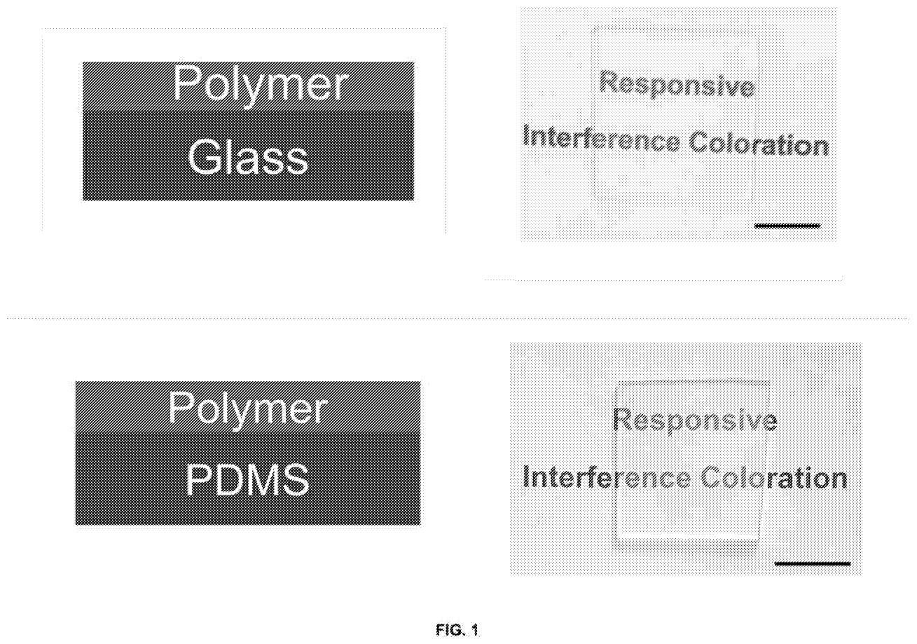

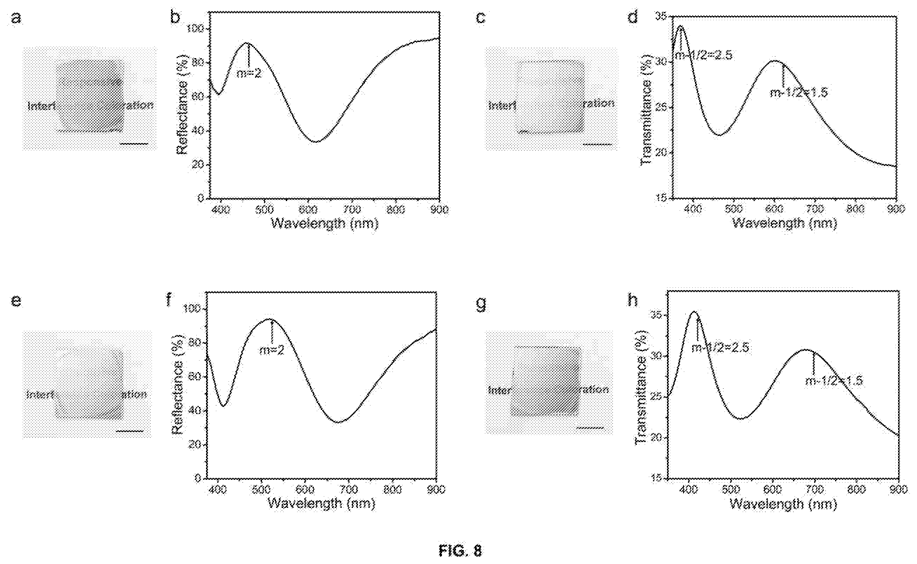

We have found that the thickness of the ultrathin metal layer is crucial to tune the intensity of the reflected light color (FIG. 3F-1H). Without the metal layer, there is no detectable interference color for the polymer layer on glass (FIG. 3B and FIG. 3C). If the metal layer is too thick, then all wavelengths of light could be reflected, which significantly diminishes the intensity of the reflected interference color (FIG. 3H). In our work, the ultrathin metal layer serves as an optical filter instead of highly reflective substrate, which can filter out unwanted wavelengths of light by transmission. The metal layer with appropriate thickness can simultaneously tune both the constructive interference reflection light and complementary destructive interference transmission light for various applications (FIG. 3F and FIG. 3G). To verify this concept, we have calculated the peak wavelengths for the constructive interference reflection spectra and destructive interference transmission spectra in a PVP-Ir-glass system based on Equation 4 and 5, respectively, using n₂=1.53 for the refractive index of PVP, θ=0° for the angle of incidence, and the experimentally-measured thickness (d₂) of the PVP film. We have found that the calculated peak wavelengths are in reasonably good agreement with corresponding experimental reflection and transmission spectra, respectively (FIG. 8).

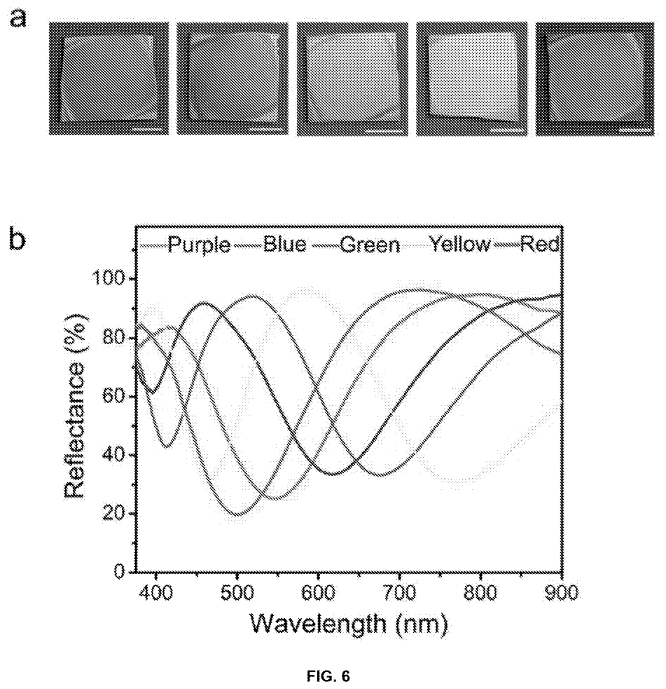

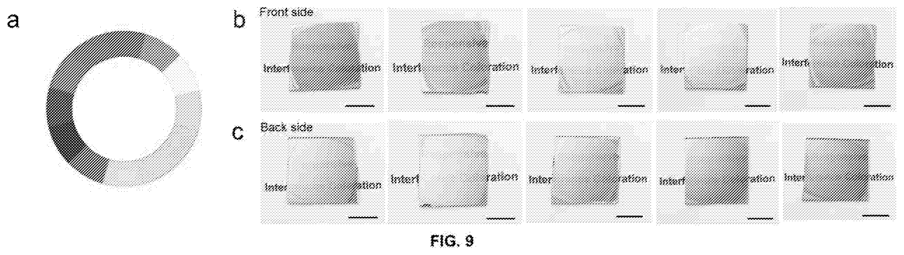

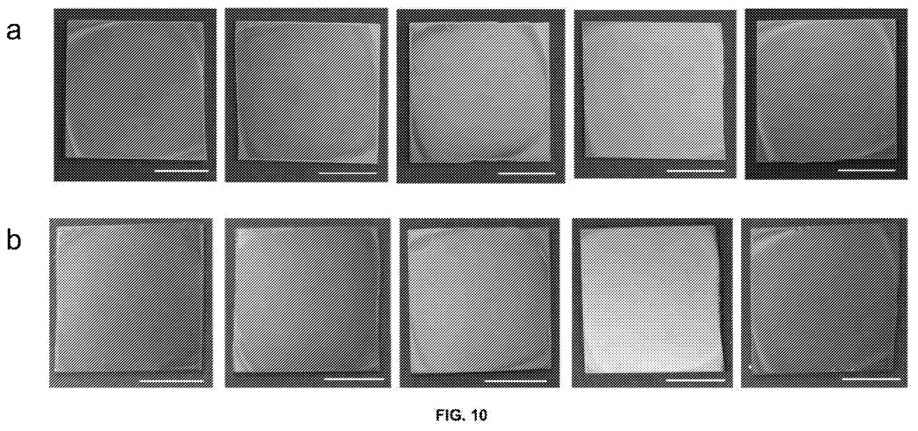

According to Equation 4, the thickness of the polymer layer determines the reflected color wavelength when the viewing angle is fixed (e.g. θ=0°). By tuning the polymer layer thickness via spin coating using appropriate spin speeds and concentrations of polymer solutions, various interference colors including purple, blue, green, yellow, and red can be generated by thin films of various polymers such as PVP, PDMS, and PC on metal-coated glass substrates (FIG. 6A and FIG. 6B, FIG. 9 and FIG. 10). Owing to the transparency of glass, both constructive interference reflected colors and complementary destructive interference transmitted colors across the spectrum can be created simultaneously on opposite sides of the substrate, respectively (FIG. 9). The degree of transparency in the interference system can be tuned via changing the thickness of the ultrathin metal film (FIG. 3F and FIG. 3G). Such transparent films with coupled complementary colors on opposite sides are desirable for applications such as wearable sensors, where the color change at the on-body side can be transduced into the color change on the opposite side of the film.

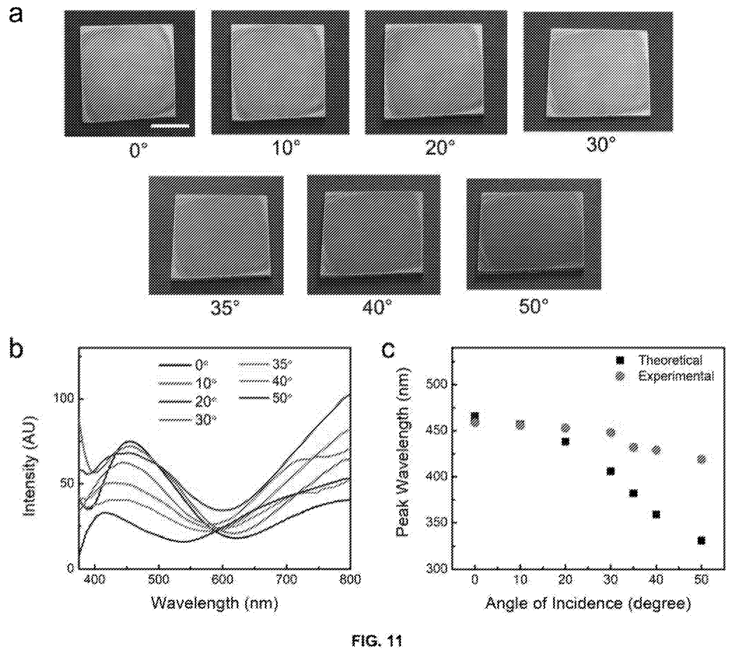

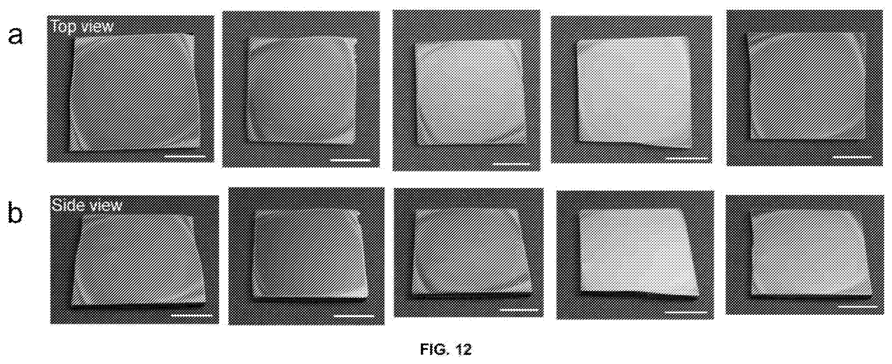

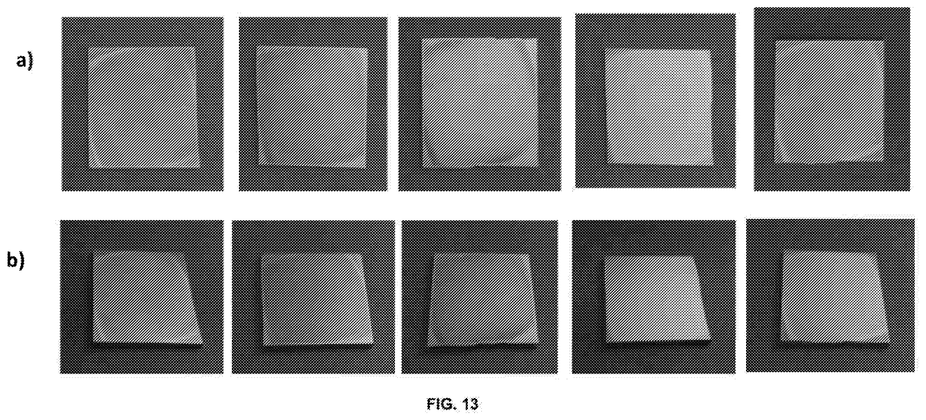

Like other conventional interference films and photonic crystals, our current RIC systems exhibit iridescent reflection colors that depend on the viewing angle (FIG. 11, FIG. 12, and FIG. 13). Both viewing angle-dependent photography and reflection spectroscopy reveal that the interference coloration has less viewing-angle dependence than expected from theoretical prediction (Equation 4). For example, the reflection color remains nearly same when the viewing angle is within 30 degree relative to the normal (FIG. 11). Although the origin of difference between experimental and theoretical results is unclear and requires further investigation in the future, the less-than-expected viewing-angle dependence of reflected colors can help to improve the reliability of the RIC sensors and will be beneficial for practical application.

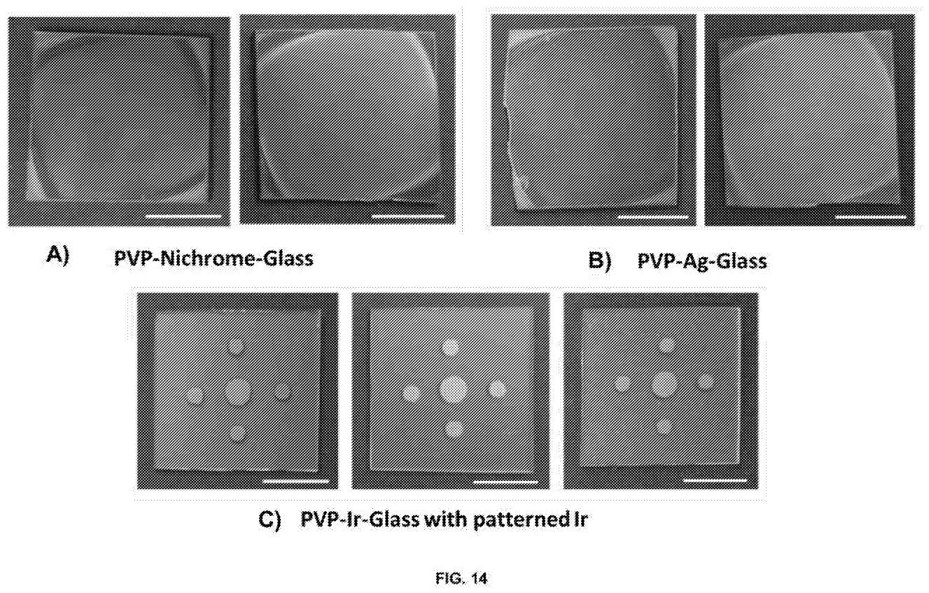

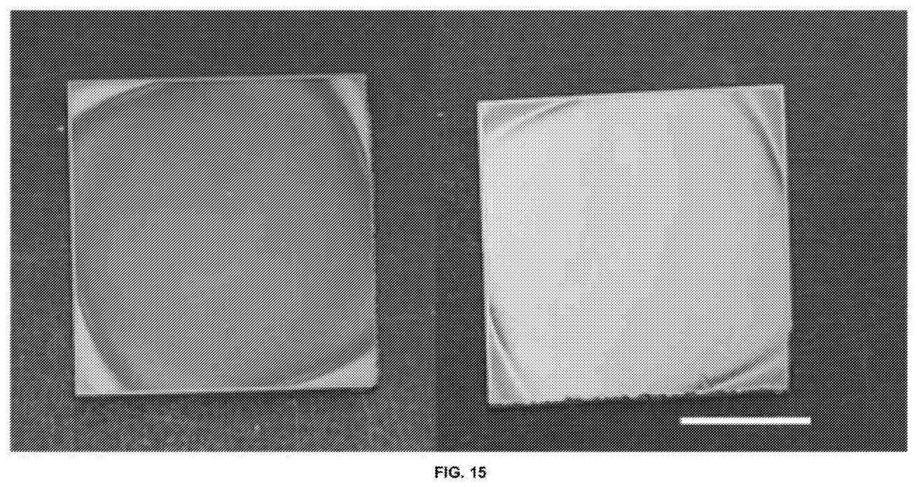

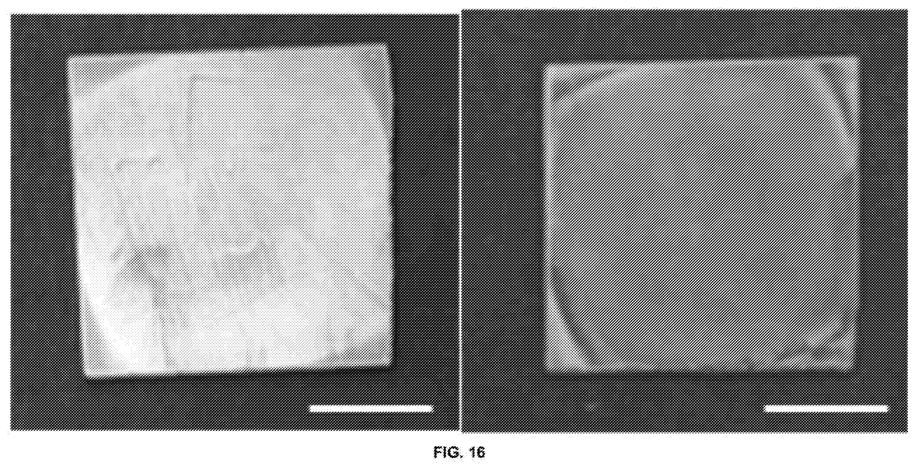

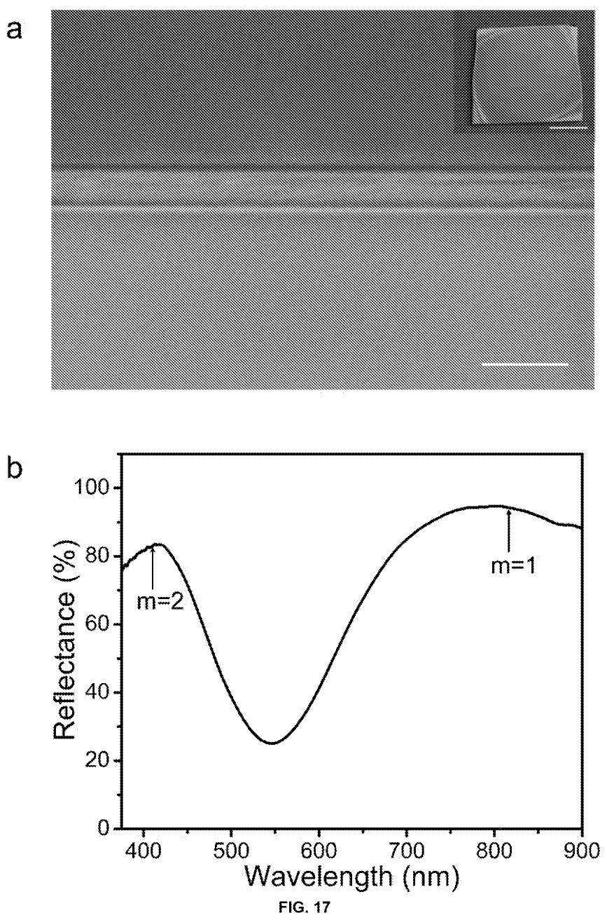

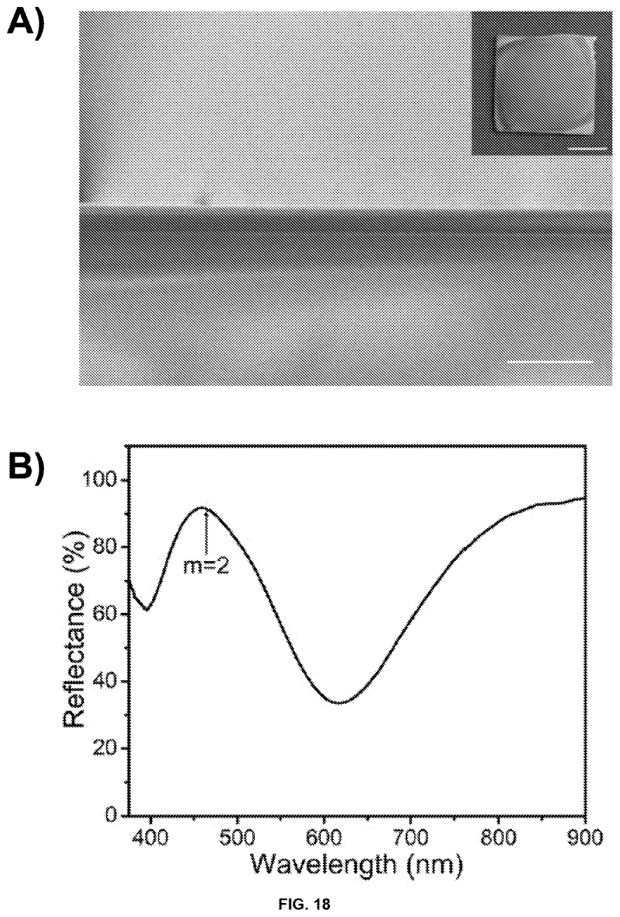

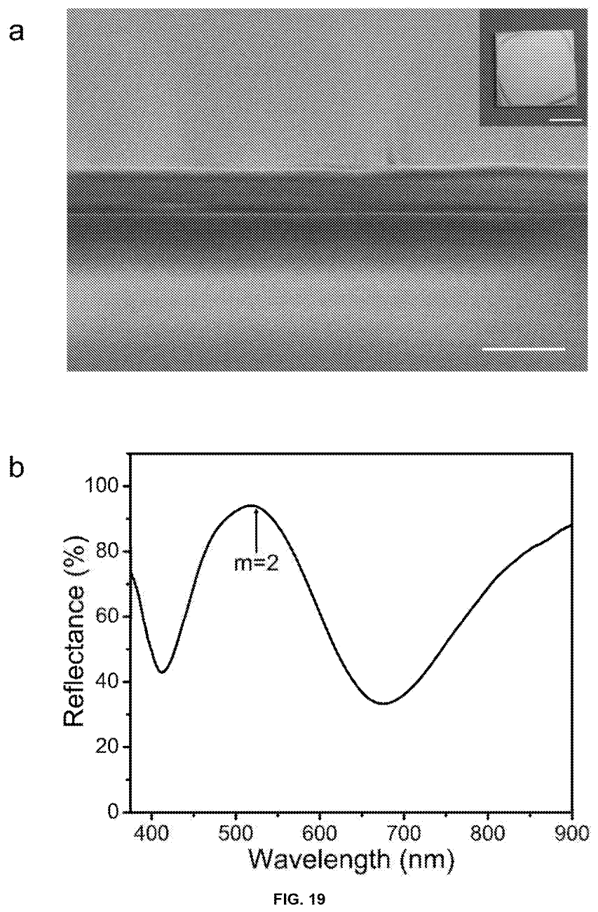

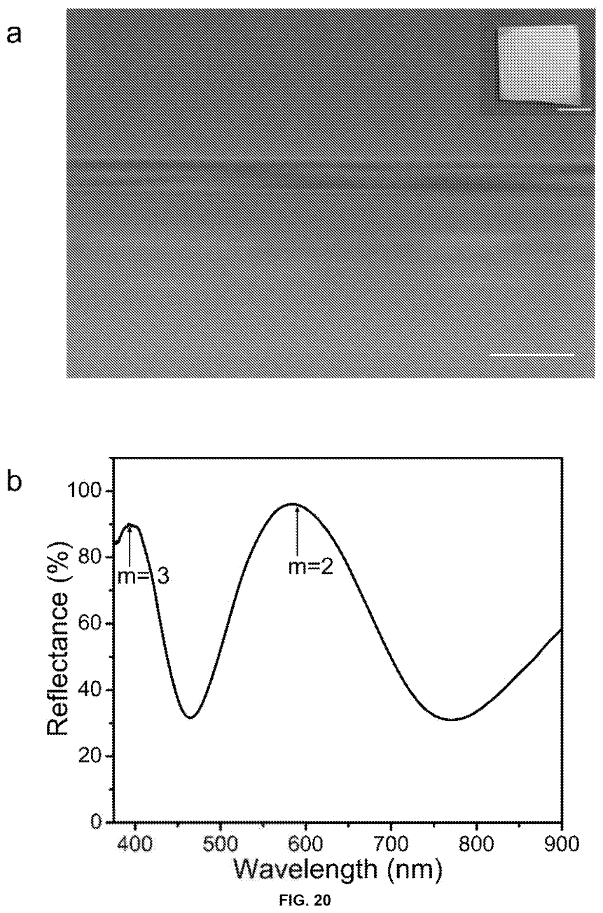

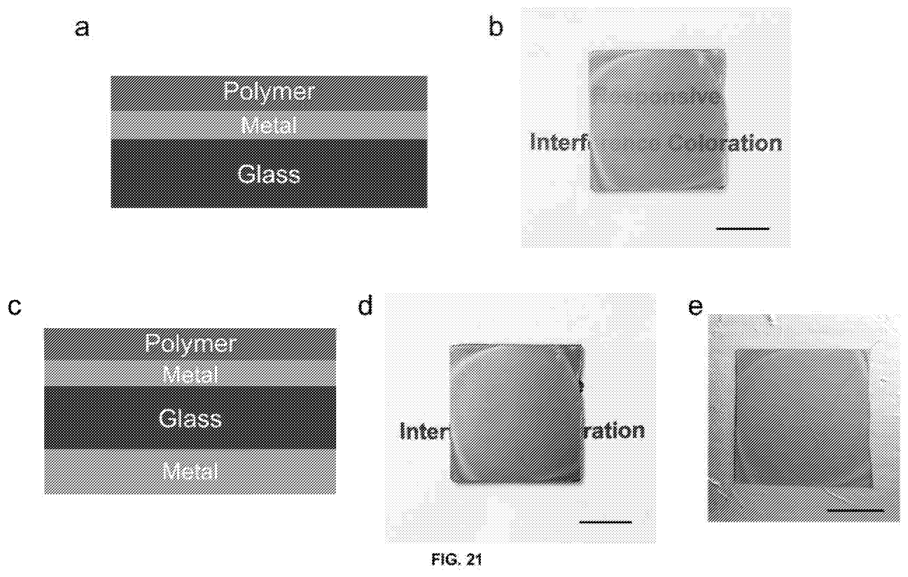

The calculated reflection peak wavelengths are in fairly good agreement with corresponding experimental reflection spectra (FIG. 18C and FIG. 18D, FIG. 17, FIG. 19, and FIG. 20). Our RIC design is applicable to a variety of metals and metal alloys, including indium, nichrome (FIG. 14E), silver (FIG. 14F), and aluminum (FIG. 15 and FIG. 16). Since the silver has very low refractive index (n=0.05 at 589 nm), this supports that the ultrathin metal layer serves as an optical filter instead of high refractive index substrate. In addition, interference color patterns can be produced by patterning of the ultrathin metal film with a plastic stencil mask on top of a glass substrate during the metal deposition (FIG. 14G). Although the thicker metal layer leads to diminished interference color intensity (FIG. 3H), the RIC trilayer system can be put on additional metal substrates without negatively affecting its reflected color intensity (FIG. 21).

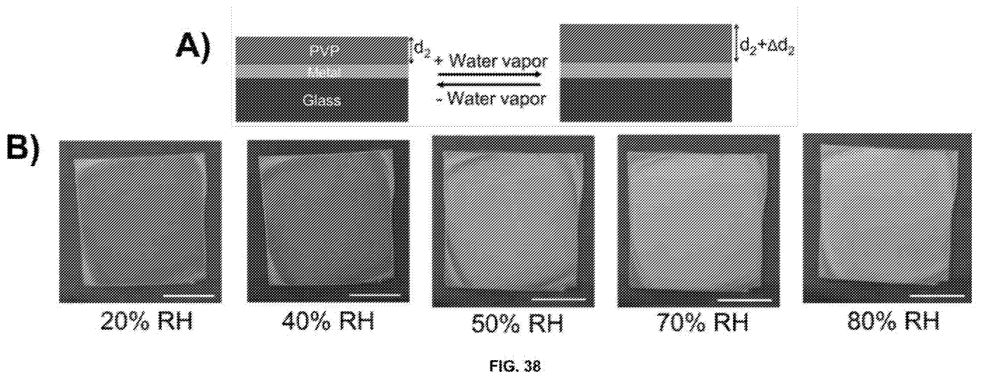

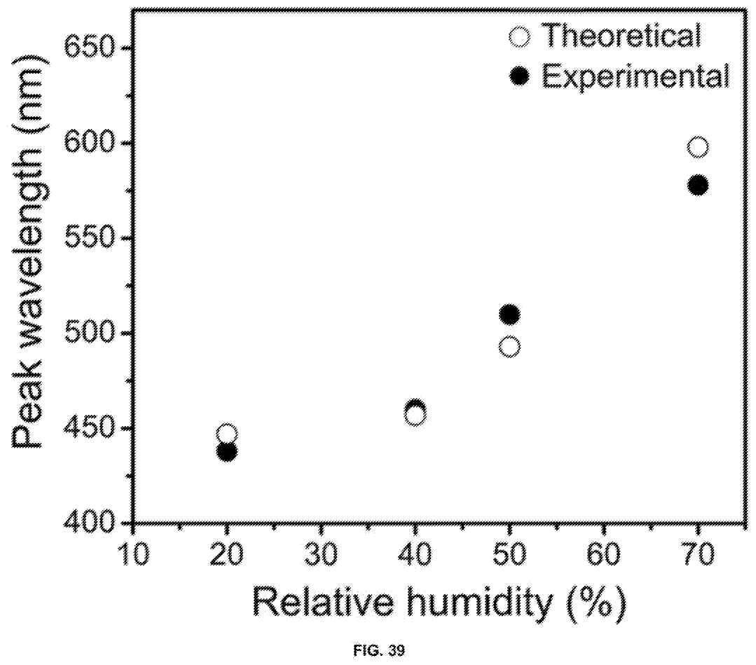

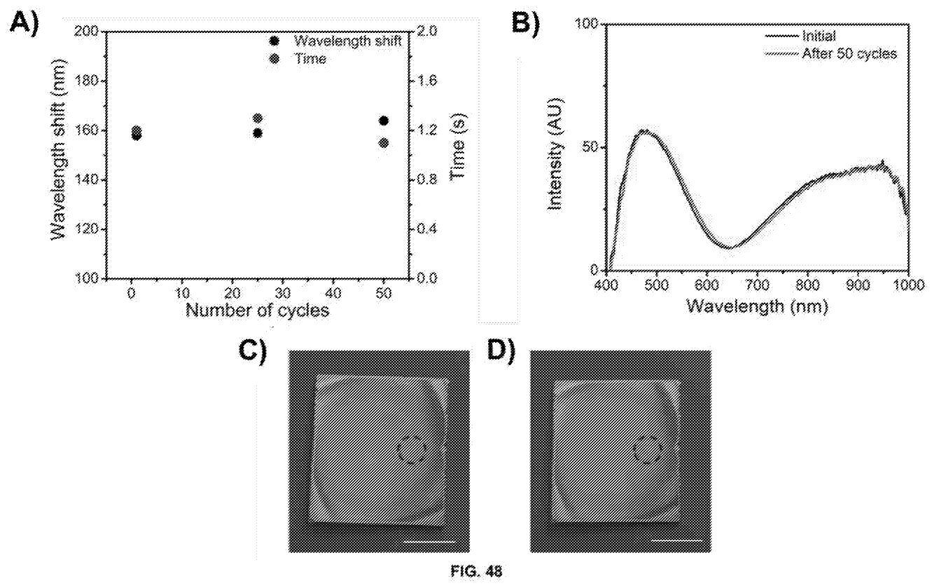

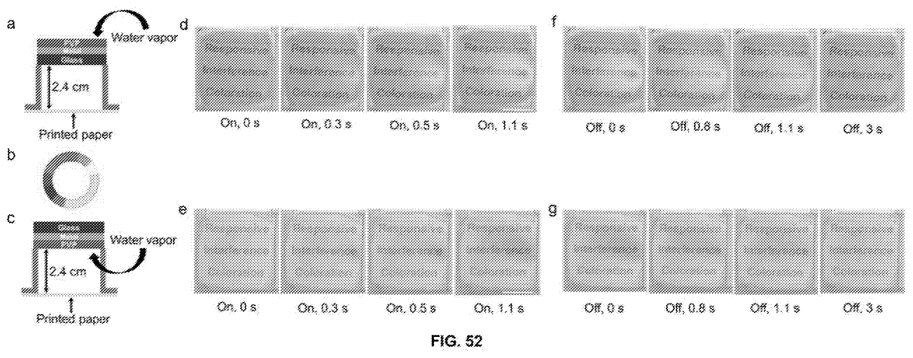

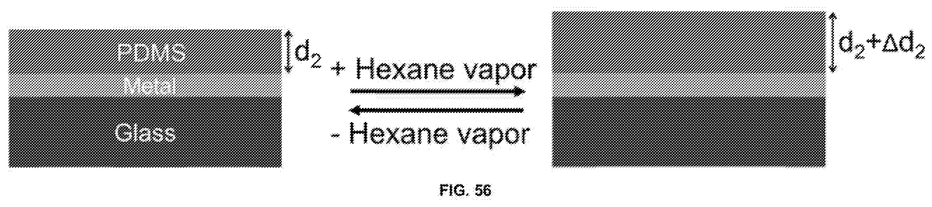

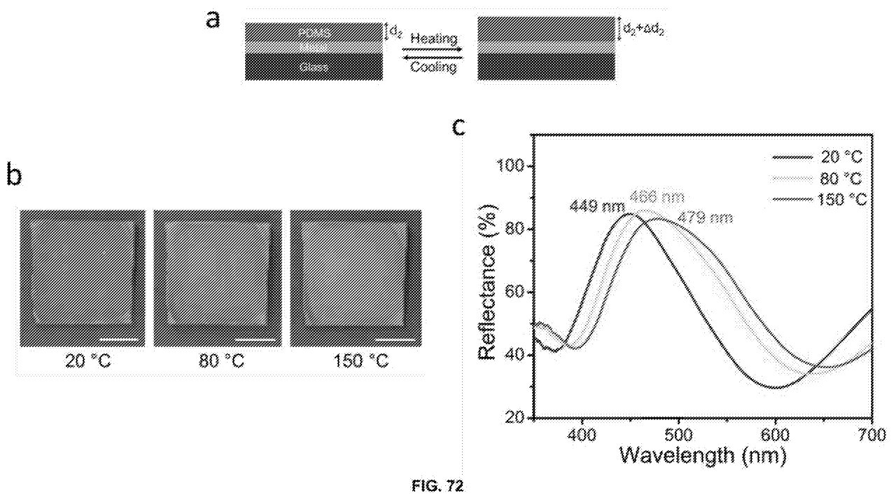

Compared with most inorganic materials, polymer-based materials have many advantages such as low cost, flexibility, good processability, excellent corrosion resistance, and light-weight. Moreover, stimuli-responsive polymers can sense their environment and change the shape and/or material properties accordingly (Stuart et al., Nat. Mater. 2010, 9, 101-113). In our current colorimetric RIC sensor design, the primary sensing mechanism is based on the stimulus-induced thickness change in the polymer layer, which leads to corresponding color change. In this study, we focus on the proof-of-concept demonstration of real-time, continuous, colorimetric RIC sensors for humidity (FIG. 38, FIG. 39, FIG. 48, and FIG. 52), organic vapor (FIG. 56), and temperature (FIG. 72A). The main advantages of such RIC sensors include low cost, zero power consumption, spatial and temporal resolution, fast, dynamic, and reversible response.

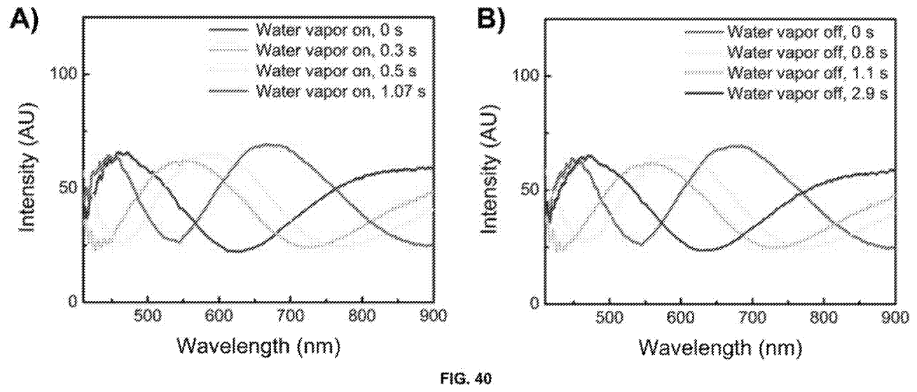

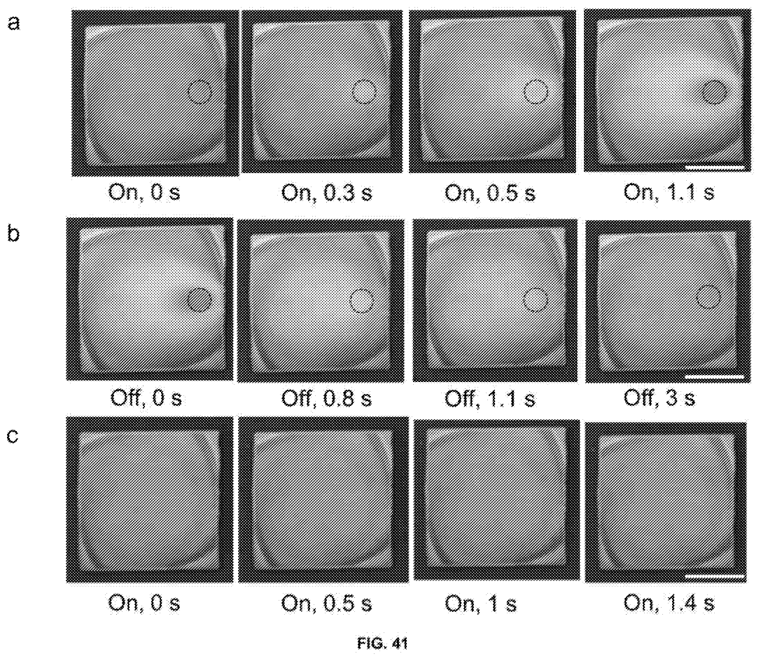

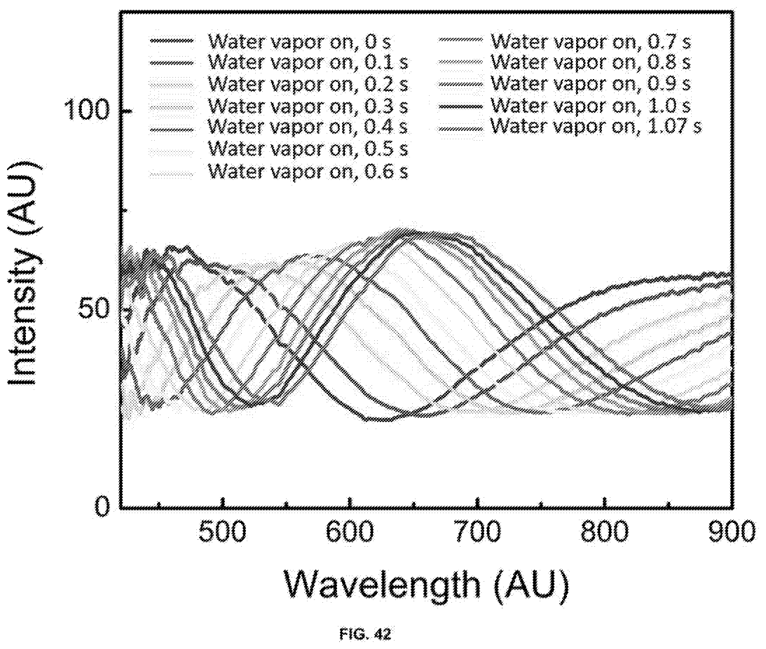

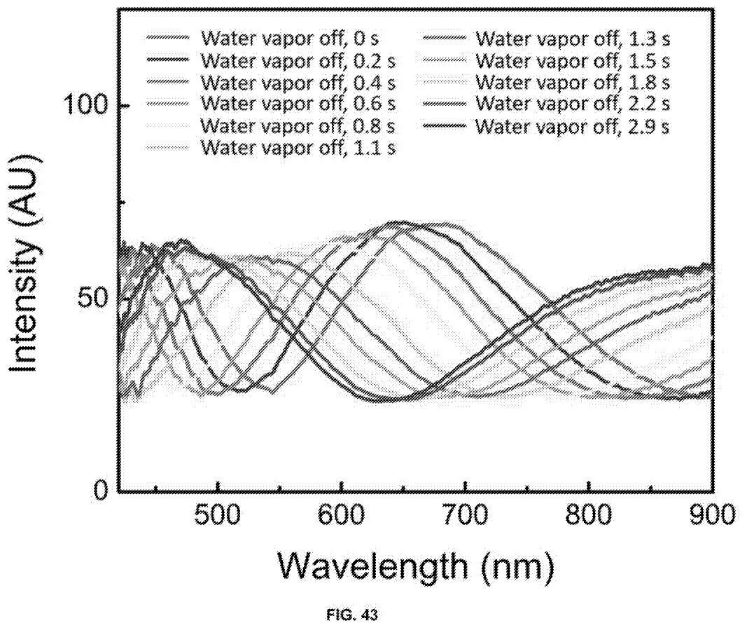

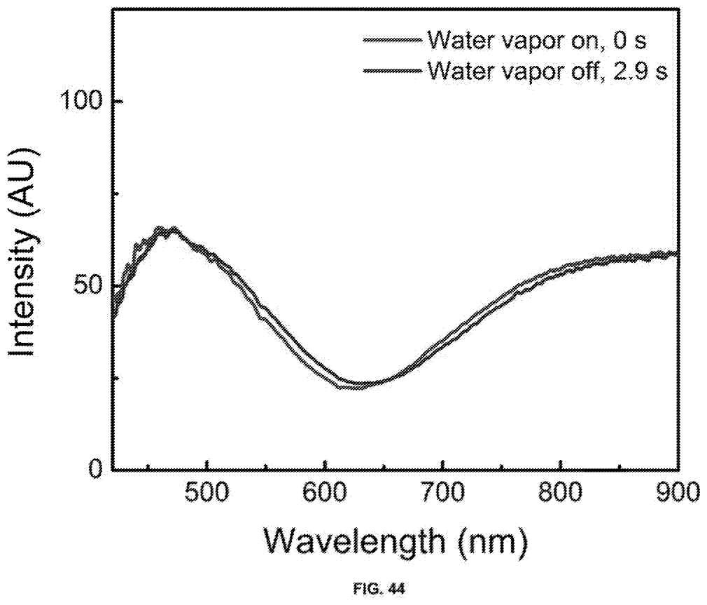

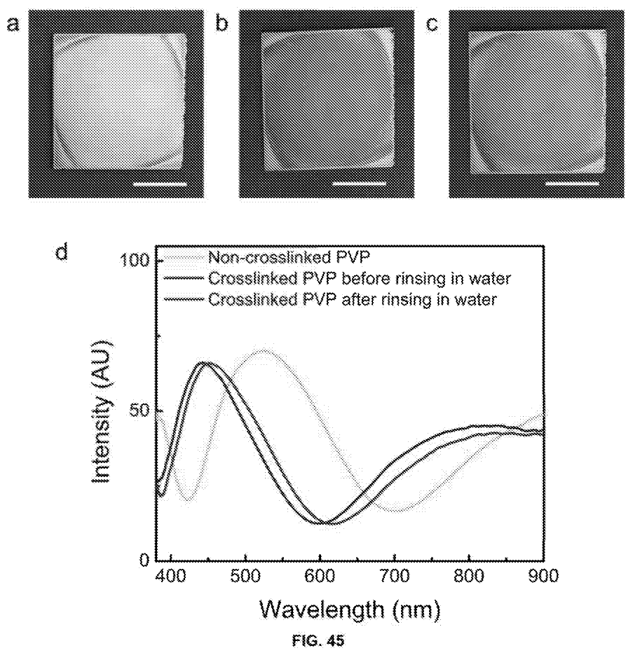

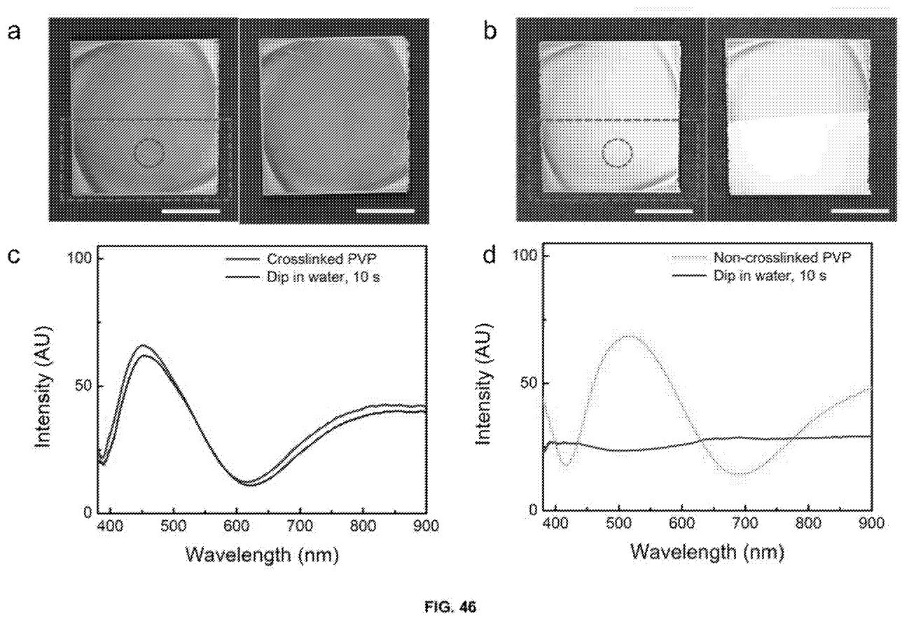

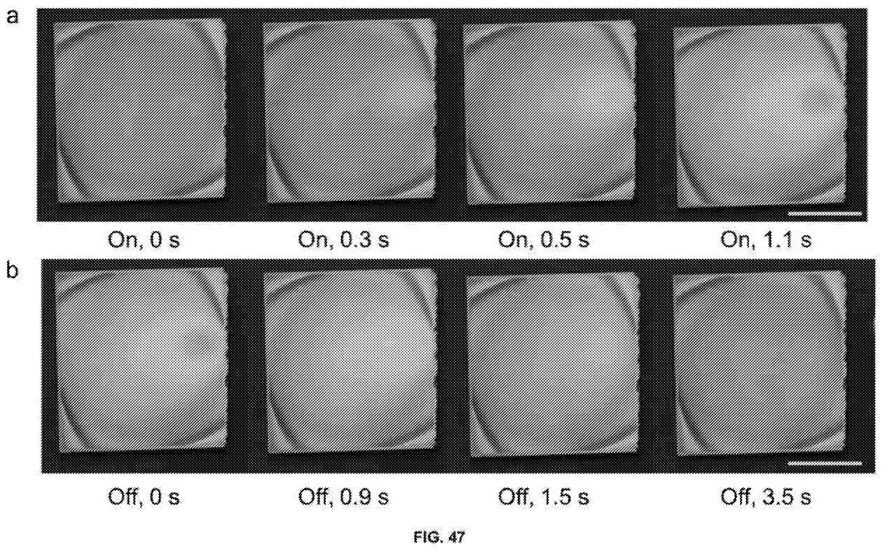

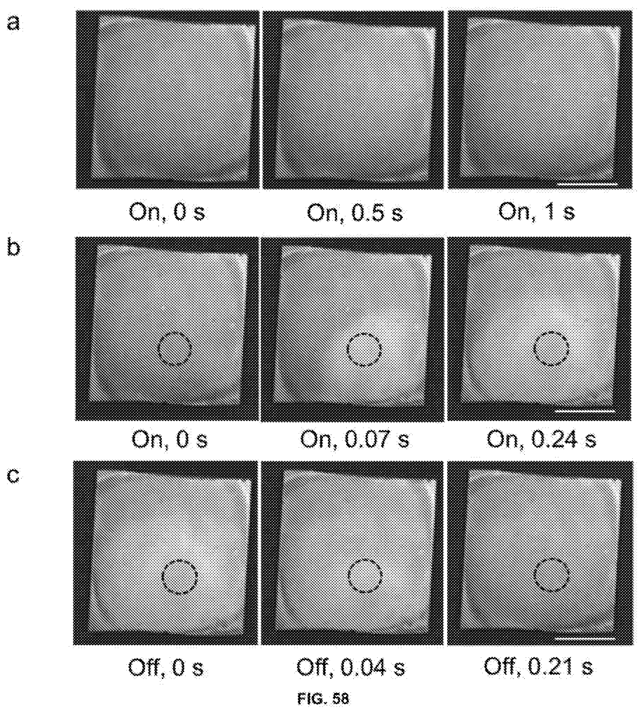

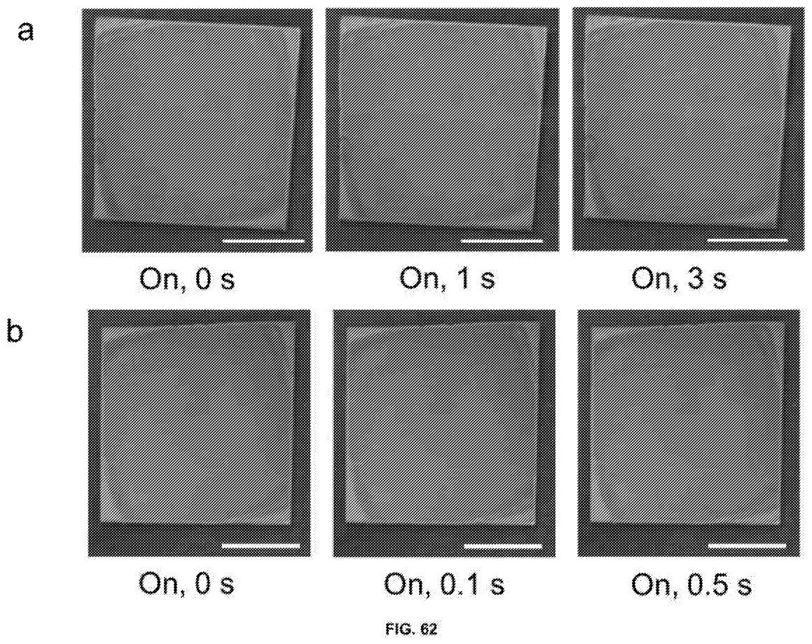

There has been a growing interest in low-cost, real-time humidity sensors for applications in agriculture, manufacturing, food industry, healthcare, and environmental monitoring (Chen and Lu, Sensor Lett. 2005, 3, 274-295). The PVP-Ir-glass colorimetric sensor exhibits excellent sensitivity to relative humidity (RH) change, ranging from purple at 20% RH to blue at 40% RH, green at 50% RH, yellow at 70% RH, and red at 80% RH (FIG. 38). This is because the hygroscopic PVP layer swells in a high humidity environment and shrinks in a low humidity environment. Furthermore, the PVP-Ir-glass sensor shows fast, dynamic, and reversible response both spatially and temporally towards the water vapor. To further investigate the humidity sensing properties, we have conducted the dynamic reflectance spectroscopy study, which is more reliable and accurate than the video imaging in measuring the stimulus response and recovery time. It takes only ˜ 1.1 s for the peak wavelength for the second-order of reflection to undergo ˜ 200 nm of shift from the blue-colored to red-colored PVP film in response to the water vapor (FIG. 40D, FIG. 41A, and FIG. 42). After the removal of the water vapor, it takes ˜ 2.9 s for the red-colored PVP film to be fully recovered to the original blue-colored film (FIG. 40E, FIG. 41B, FIG. 43, and FIG. 44). For comparison, both PDMS-Ir-glass and PC-Ir-glass systems do not respond to the water vapor (FIG. 58A and FIG. 62A). Heating of a PVP thin film at 200° C. leads to thermal crosslinking of PVP to form more stable PVPP, which is insoluble in common solvents (Telford et al., ACS Appl. Mater. Interfaces 2010, 8, 2399-2408). We have found that thermal crosslinking of PVP can significantly enhance the stability of PVP-based humidity sensors towards liquid water. Compared with the PVP-based humidity sensor, the PVPP-Ir-glass sensor exhibits similar sensitivity towards the humidity change while remains intact after dipped into liquid water (FIG. 45-FIG. 47).

To verify whether the humidity sensing mechanism of the PVP-Ir-glass film is due to the proposed change in thickness of the PVP layer (FIG. 38), we have performed the comparison study on observed and calculated reflection peak wavelength change with static relative humidity. Our comparison study shows that there is a good agreement between experimental and theoretical results, and the reflection peak wavelength increases with increase in relative humidity (FIG. 39). This study confirms the proposed humidity sensing mechanism that is based on the thin film interference principle (Equation 4) and water vapor-induced swelling of the PVP layer (FIG. 38).

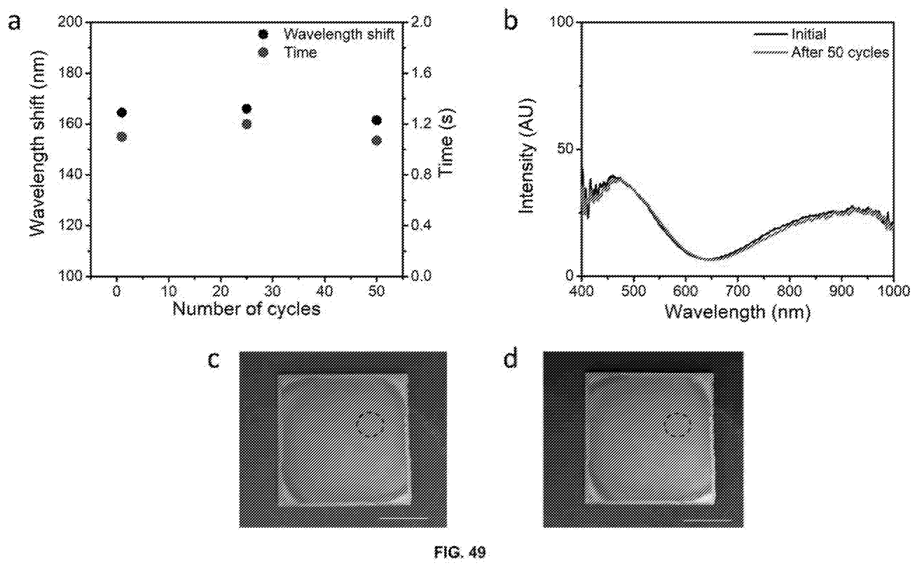

To investigate the long-term stability of the RIC films, we have carried out the humidity cycle test for PVPP-Ir-glass and PVPP-nichrome-glass RIC films (FIG. 48, and FIG. 49). Our humidity cycle test shows that there is no detectable change in both reflection spectra and color in the test region of the RIC films after 50 cycles of humidity sensing experiments (FIGS. 48A-48B and FIG. 49B-49D). In addition, the humidity sensing performance such as wavelength shift and corresponding response time of the RIC films remain little changed during the humidity cycle test (FIG. 48B and FIG. 49A). Compared with the PVP-based RIC films (FIG. 40A), the PVPP-based RIC films exhibit smaller wavelength shift at the similar response time (FIG. 48B and FIG. 49A), most likely due to the crosslink structure of PVPP.

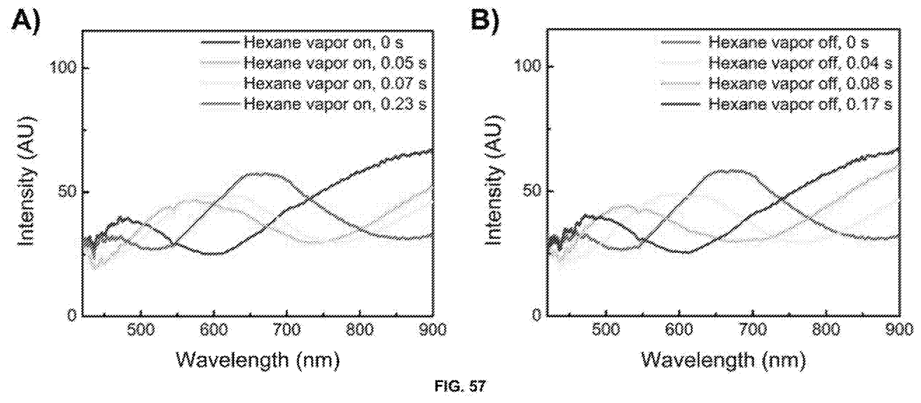

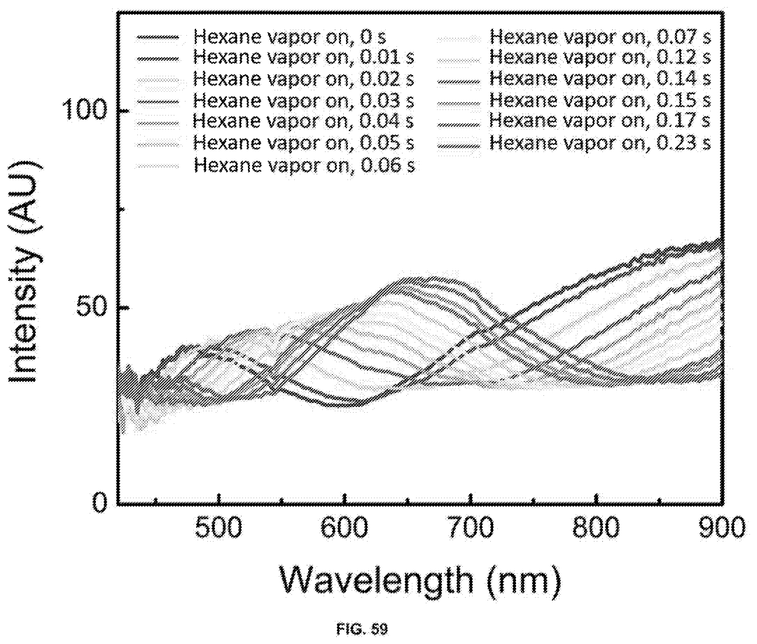

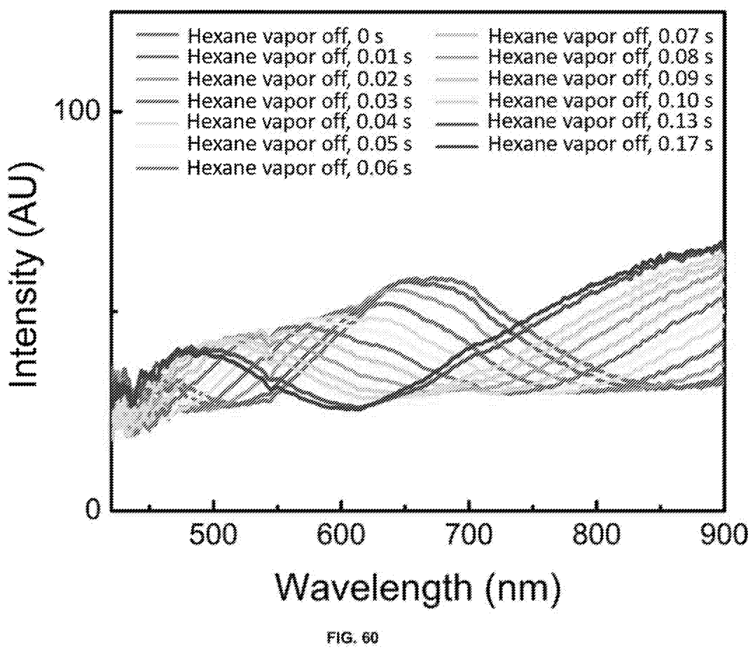

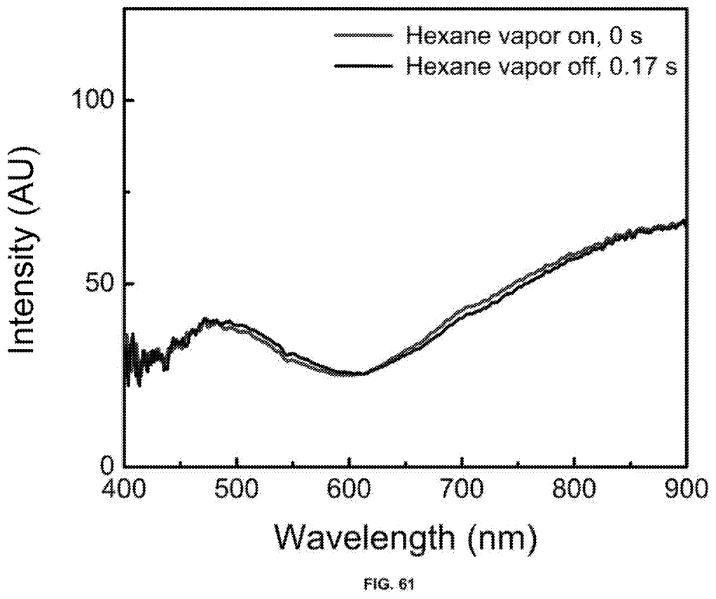

Although the PDMS-Ir-glass system has no response to the humidity change, it exhibits exceptional sensitivity towards organic vapors such as hexane that can swell PDMS. It takes just ˜ 0.23 s for the peak wavelength for the second-order of reflection to undergo 200 nm of shift from the blue-colored to red-colored PDMS film upon exposure to the hexane vapor (FIG. 57A, FIG. 58B, and FIG. 59). After the removal of the hexane vapor, it takes merely ˜ 0.17 s for the red-colored PDMS film to be fully recovered to the original blue-colored film (FIG. 57B, FIG. 58C, FIG. 60, and FIG. 61). For comparison, both PVP-Ir-glass and PC-Ir-glass systems do not show color change upon exposure to the hexane vapor (FIG. 41C and FIG. 62B). Therefore, the selectivity of a RIC sensor towards specific stimulus can be modulated by choosing a polymer material with desirable structure and properties.

Suitable indoor air humidity levels are important for human health and comfort. The EPA recommends the indoor relative humidity stays between 30% and 50%. If the indoor relative humidity is above 60%, it not only makes occupants feel less comfortable, but also allows mold and mildew to grow, which can cause health problems. On the other hand, if the indoor air is too dry with less than 30% relative humidity, it can cause static electricity problems, sensory irritation of the skin, dry eyes, and dry, sore throat. Low-cost, energy-free, real-time, continuous sensors are highly desirable for monitoring and control of temperature, humidity, occupancy, and indoor air quality in smart residential and commercial buildings (Wolkoff, Int. J. Hyg. Environ. Health 2018, 221, 376-390; Neal Stewart Jr. et al., Science 2018, 361, 229-230).

By using a metal layer of 3 nm thickness and transparent substrate, both good transparency and bright interference coloration can be achieved in RIC sensors (FIG. 52), which open door to new applications such as stimuli-sensing windows. One main advantage of such stimuli-sensing windows is their self-reporting feature that autonomously exhibits a color change upon exposure to a target stimulus without using external power sources. For instance, the PVP-Ir-glass sensor displays spatial and temporal color change in response to the localized humidity change while being transparent all the time (FIG. 52). Since the constructive interference reflected colors and complementary destructive interference transmitted colors on opposite sides of the transparent humidity-sensing window are strongly coupled (FIG. 52), this allows monitoring of the indoor humidity level from both inside and outside the building. The outdoor monitoring of the indoor relative humidity enables facile control of the indoor humidity by a third party without compromise of security. Alternatively, the transparent humidity-sensing window with the sensing layer facing outside lets people to determine the outdoor relative humidity level from both indoor and outdoor. The indoor monitoring of the outdoor air humidity helps residents to easily determine when to open windows for fresh air with suitable relative humidity.

Air leaks through windows and doors represent significant amount of commercial and residential building energy consumption. Detecting the leaking locations of a leaky window is crucial for sealing the leaks and saving the energy. The transparent humidity-sensing window with the sensing layer facing inside enables energy-free, real-time monitoring of potential window leaks with spatial resolution, because the localized air leak can cause the color change at the leaking spot of the window, due to the difference of outdoor and indoor moisture levels. Furthermore, the transparent humidity-sensing window with the sensing layer facing inside or outside can be used for monitoring of the air humidity inside or outside the car, which can help drivers to prevent the car window from fogging up by timely adjustment of humidity and temperature inside the car.

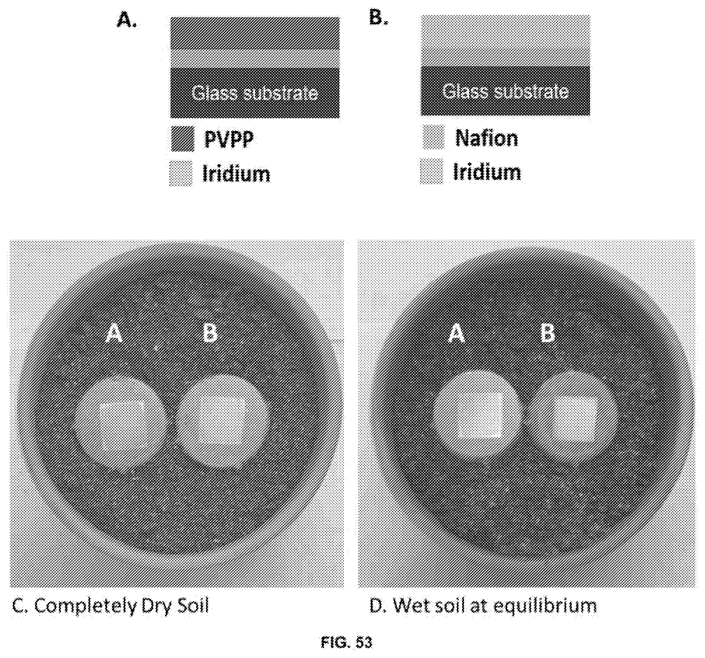

Low-cost, self-reporting, real-time soil moisture sensors with zero power consumption are crucial for precise water management in agriculture, which will help farmers save water and increase yields and the quality of the crop by improved management of soil moisture during critical plant growth stages. The combination of low-cost RIC soil moisture sensors (FIG. 53) and drones with cameras will allow automatic collection of soil moisture data.

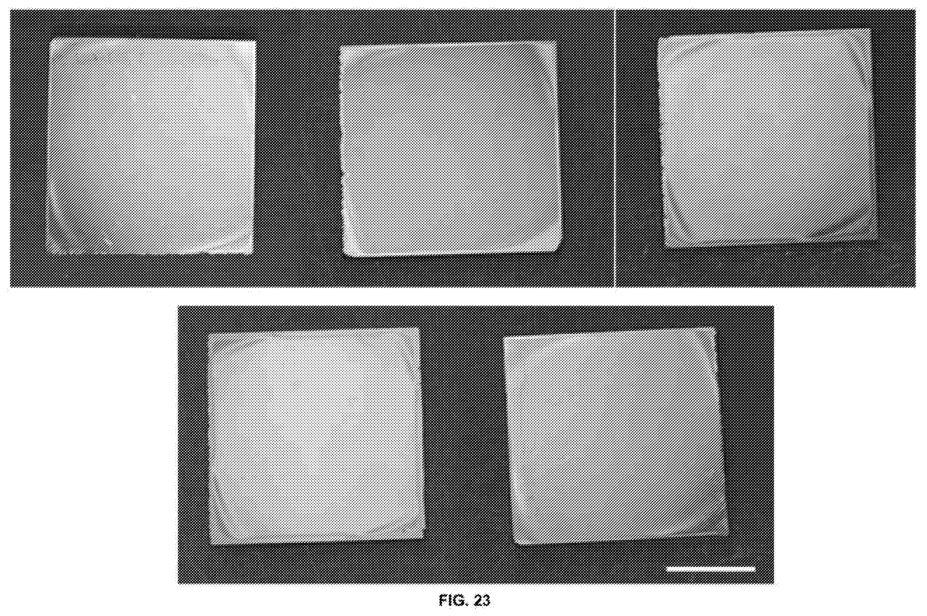

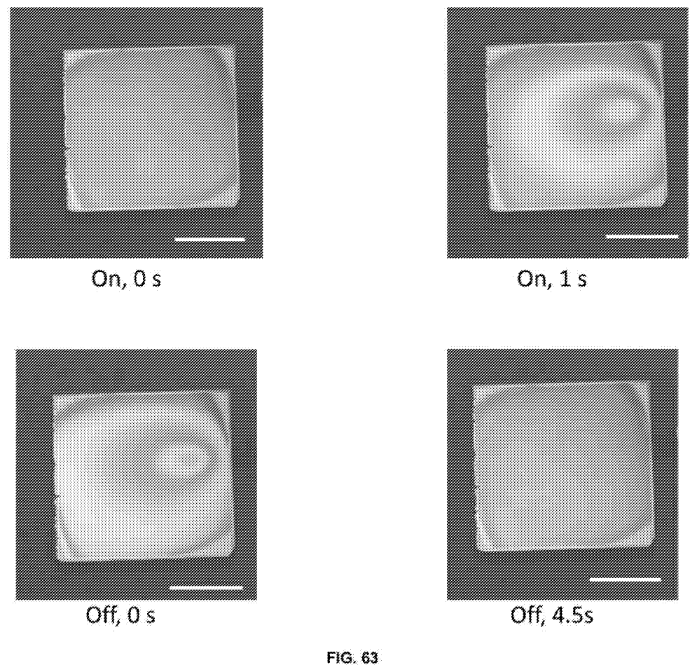

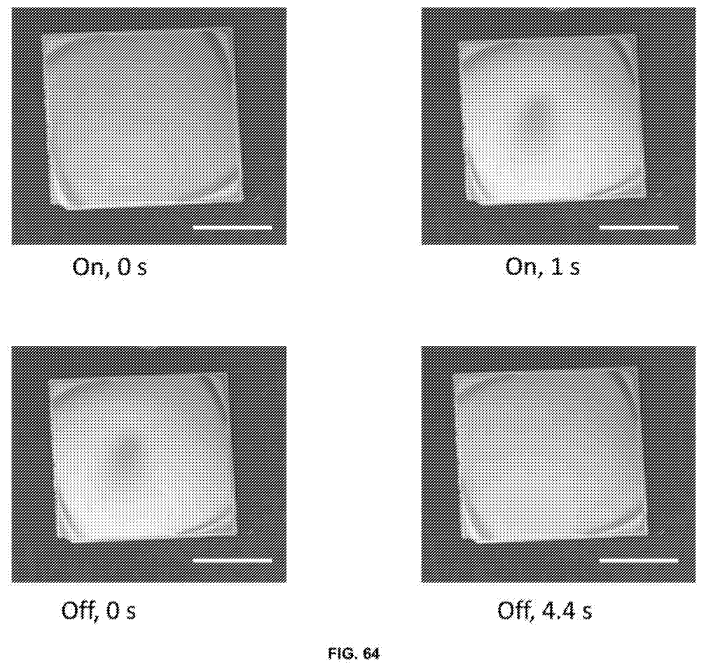

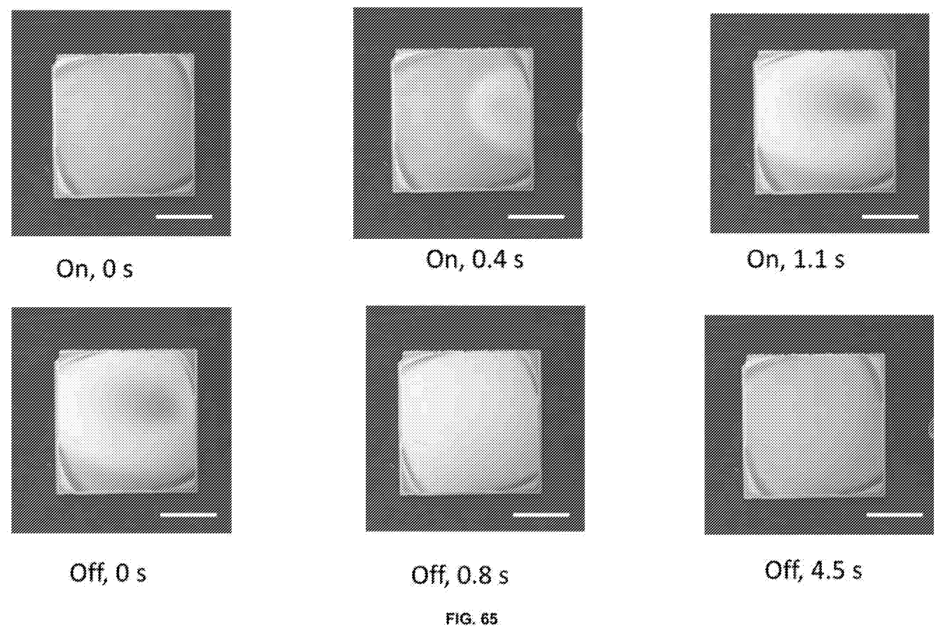

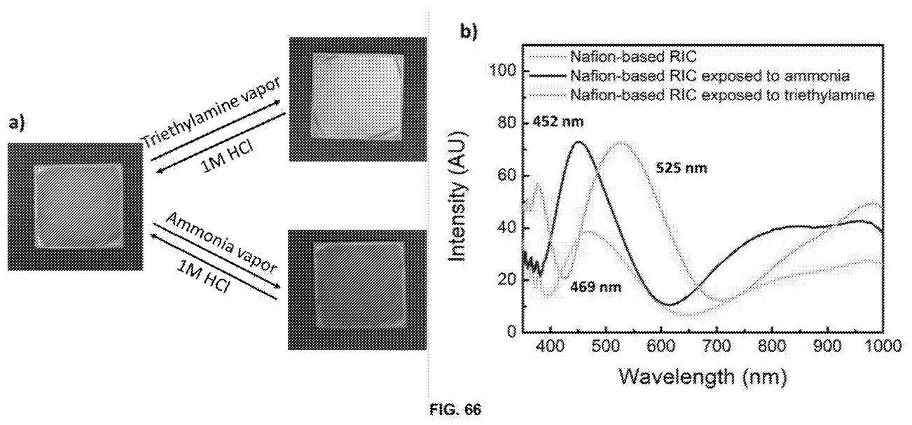

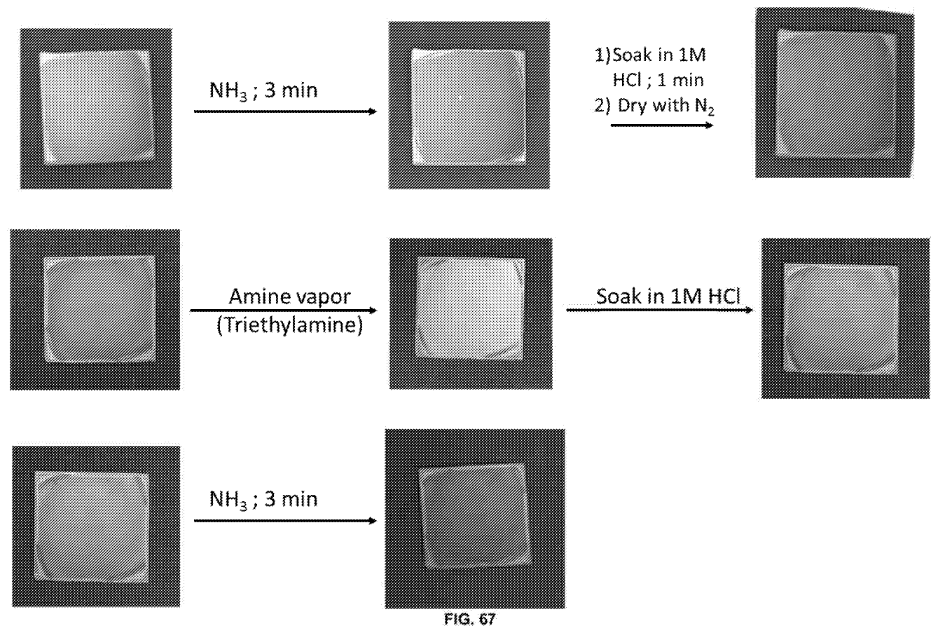

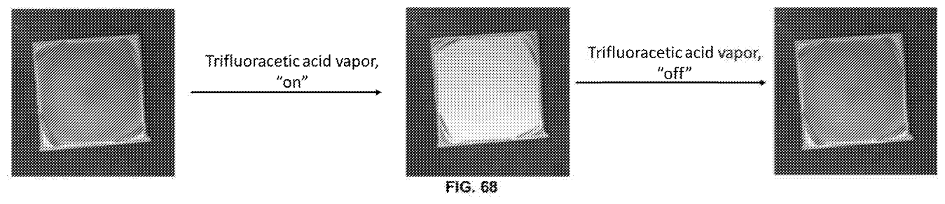

The transparent RIC films also make it possible to develop other stimuli-responsive windows by choosing appropriate sensing polymers. For instance, the volatile organic compounds (VOCs) are common indoor pollutants, which may have short- and long-term adverse health effects. We can use RGB-based response patterns of the Nafion-Ir-glass sensor (FIG. 23) array to differentiate different organic vapors. Examples include ethanol (FIG. 63), methanol (FIG. 64), acetone (FIG. 65), ammonia/amines (FIG. 66 and FIG. 67), and trifluoroacetic acid (FIG. 68). The VOCs-sensing windows can be used for monitoring the indoor air quality from both inside and outside the building. In addition, the alcohol-sensing car window may help prevent drunk driving.

In addition to chemical stimuli such as humidity and organic vapor, the RIC system with suitable polymer layer can also respond to physical stimuli such as temperature. Since PDMS has a relatively large linear thermal expansion coefficient (3.0×10⁻⁴/° C.) than typical polymers such as PC (6.7×10⁻⁵/° C.), the PDMS-Ir-glass sensor shows a detectable color change upon heating from 20° C. to 150° C. (FIG. 72B), which corresponds to ˜ 30 nm of shift for the peak wavelength for the second-order of reflection (FIG. 72C). The color change is fully reversible upon cooling. The sensitivity of the RIC thermal sensor could be significantly enhanced by using suitable thermoresponsive polymers (Roy et al., Chem. Soc. Rev. 2013, 42, 7214-7243; Kim and Matsunaga, J. Mater. Chem. B 2017, 5, 4307-4321).

### Example 3

### Self-Reporting and Self-Acting Chemical Sensing without Power

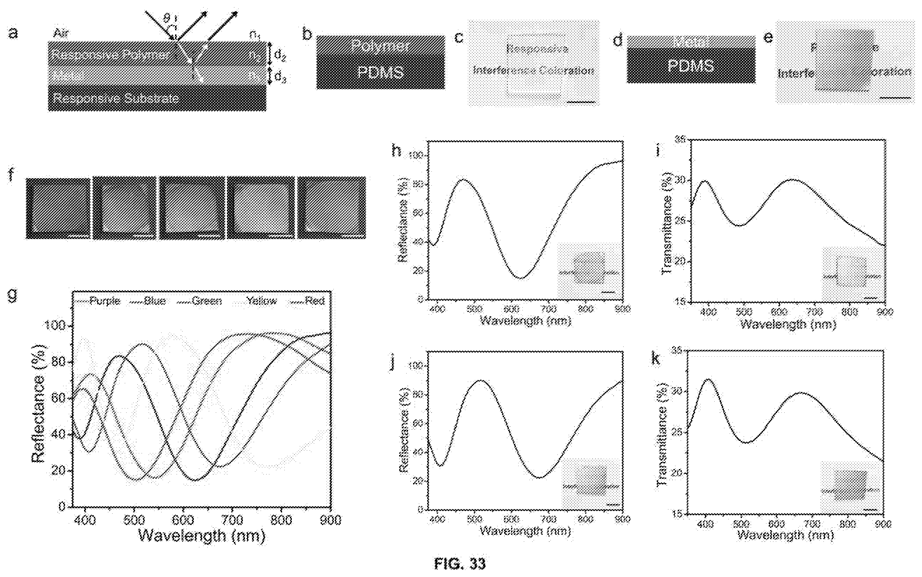

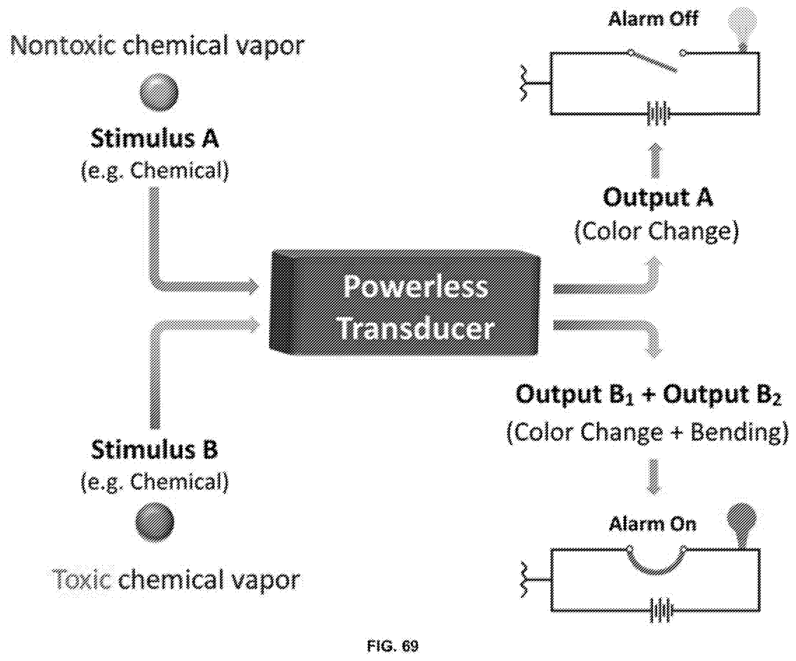

We have developed a general strategy for powerless self-reporting and self-acting chemical sensors, which can differentiate two different chemical stimuli by transforming one chemical stimulus such as nontoxic water vapor into one type of self-reporting output signal (i.e. color change), whereas transducing another chemical stimulus into two different types of self-reporting output signals (i.e. color change+bending). The bending actuation could be used as the self-acting function such as waking an electric circuit of an alarm system upon the detection of a specific stimulus such as toxic organic vapor (FIG. 69). The thin-film powerless transducer is composed of three layers (FIG. 33A): 1) The thin polymer layer acts as the first sensing layer, which exhibits stimuli-responsive thin film interference coloration; 2) The ultrathin metal layer serves as an optical filter; 3) The flexible substrate layer acts as the second sensing layer, which is responsive to different chemical stimuli. Our simple yet versatile trilayer thin-film transducer system allows the powerless integration of sensing with actuation, and it is applicable to a wide range of stimuli-responsive thermoplastics, thermosets, and polymer composites (Cohen Stuart et al., Nat. Mater. 2010, 9, 101-113).

The bioinspired stimuli-responsive structural coloration has received great interest in the past two decades due to its wide range of promising applications (Kinoshita et al., Rep. Prog. Phys. 2008, 71, 076401; Sun et al., RSC Adv. 2013, 3, 14862-14889; Fenzl et al., Chem. Int. Ed. 2014, 53, 3318-3335 and Angew. Chem. 2014, 126, 3384-3402; Ge and Yin, Angew. Chem. Int. Ed. 2011, 50, 1492-1522 and Angew. Chem. 2011, 123, 1530-1561; Zhao et al., Chem. Soc. Rev. 2012, 41, 3297-3317; Chan et al., Adv. Mater. 2013, 25, 3934-3947; Cai et al., Anal. Chem. 2015, 87, 5013-5025; Phillips et al., Chem. Soc. Rev. 2016, 45, 281-322; Dumanli and Savin, Chem. Soc. Rev. 2016, 45, 6698-6724; Isapour and Lattuada, Adv. Mater. 2018, 30, 1707069). Thin-film interference is the simplest structural coloration mechanism, which is responsible for the colorful, iridescent reflections that can be seen in oil films on water, and soap bubbles (Kinoshita et al., Rep. Prog. Phys. 2008, 71, 076401; Sun et al., RSC Adv. 2013, 3, 14862-14889; Kats and Capasso, Laser Photonics Rev. 2016, 10, 735-749; Kramer et al., Nat. Mater. 2007, 6, 533-538; Phan et al., Adv. Mater. 2013, 25, 5621-5625; Qin et al., Adv. Mater. 2018, 30, 1800468). Thanks to its design simplicity, which does not require multilayers of materials with alternative refractive indices or micro- and nanostructures, thin film interference represents a promising solution towards scalable and affordable manufacturing of high-quality responsive structural coloration systems. However, thin films of polymers with appropriate thickness generally do not exhibit visible structural colors if they are directly deposited on low-cost substrates such as glass (Banisadr et al., ACS Appl. Mater. Interfaces 2019, 11, 7415-7422) and polydimethylsiloxane (PDMS) (FIGS. 7A-7B and FIG. 33B-33E). We have found recently that, in order to see bright thin-film interference color on glass, it is crucial to use an ultrathin metal layer as an optical filter instead of high refractive index substrate or highly reflective substrate (Banisadr et al., ACS Appl. Mater. Interfaces 2019, 11, 7415-7422). Such an optical filter layer can significantly enhance the observed interference color intensity by simultaneously optimizing both the constructive interference reflection light and complementary destructive interference transmission light. In this work, the ultrathin metal layer is also found to be key to observe bright thin film interference colors on flexible PDMS substrate (FIG. 33B-33E).

Our previous study was focused on the sensing properties of the glass-based thin film interference films (Banisadr et al., ACS Appl. Mater. Interfaces 2019, 11, 7415-7422). Since the glass substrate is rigid and not responsive to external stimuli by itself, the actuation is impossible in these glass-based films. In current study, we have been successful for the first time in powerless integration of sensing with actuation functions in thin film interference films by using the flexible PDMS substrate, which also acts as the second sensing layer (FIG. 33A).

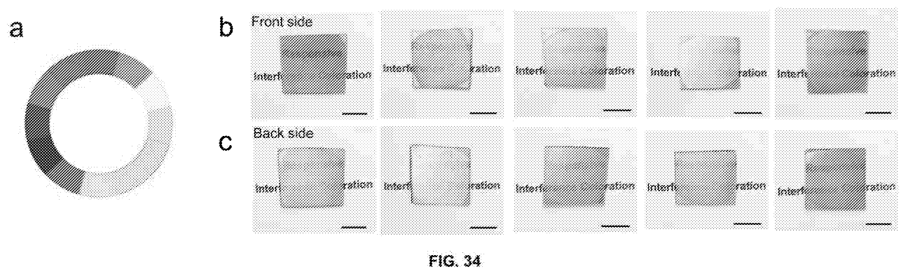

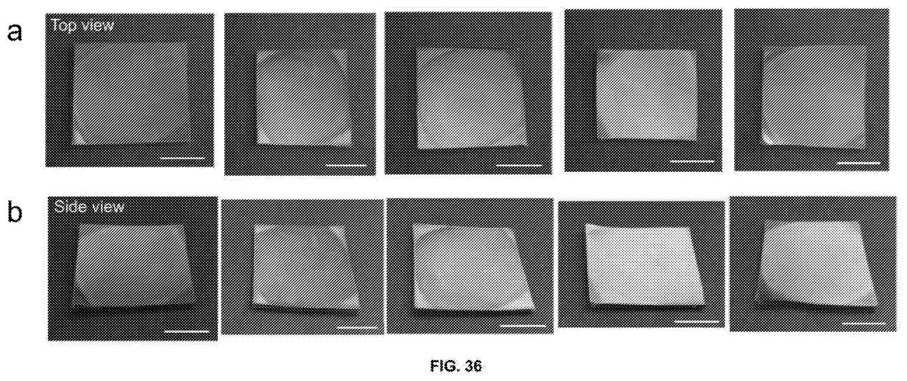

The condition for constructive thin-film interference is determined by Equation 4 where is the wavelength giving the maximum reflectivity, m is the order of diffraction (a positive integer), d₂ and n₂ are the thickness and refractive index of the polymer layer, respectively, and θ is the angle of incidence (FIG. 33A) (Kinoshita et al., Rep. Prog. Phys. 2008, 71, 076401; Sun et al., RSC Adv. 2013, 3, 14862-14889). The condition for the destructive thin-film interference follows Equation 5 where represents the wavelength giving the minimum reflectivity (maximum transmissivity) (Kinoshita et al., Rep. Prog. Phys. 2008, 71, 076401; Sun et al., RSC Adv. 2013, 3, 14862-14889). In this work, the polyvinylpyrrolidone (PVP) is chosen as the first sensing layer, whereas the PDMS is selected as the flexible substrate as well as the second sensing layer (FIG. 7A-7B). By tuning the PVP polymer layer thickness via spin coating using appropriate spin speeds and concentrations of polymer solutions, various interference colors including purple, blue, green, yellow, and red can be generated on metal-coated PDMS substrates (FIG. 33F-33G). Owing to the transparency of PDMS, both constructive interference reflected colors and complementary destructive interference transmitted colors across the spectrum can be created simultaneously on opposite sides of the substrate, respectively (FIGS. 33H-33K and FIG. 34). Like other conventional interference films and photonic crystals, our stimuli-responsive interference coloration films exhibit iridescent reflection colors that depend on the viewing angle (FIG. 36).

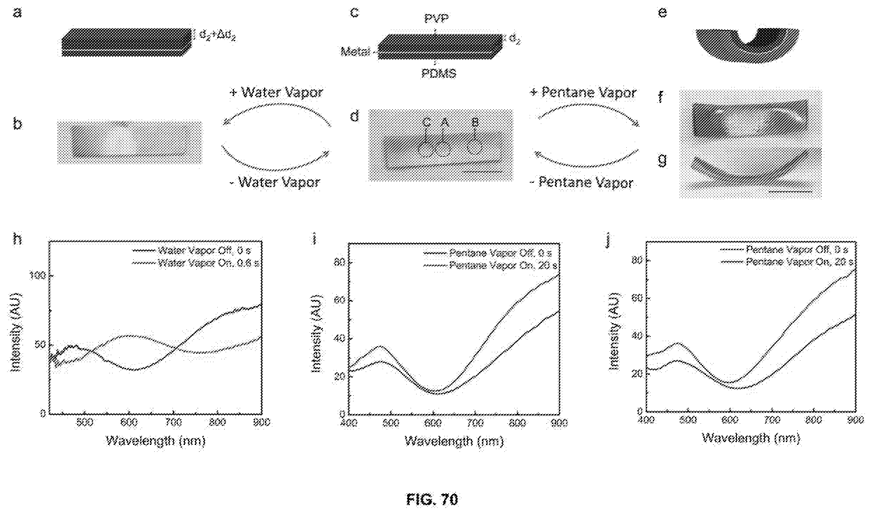

PVP and PDMS show opposite stimuli-responsive properties because of their different chemical structures (FIG. 7A-7B). The PVP layer is responsive to water vapor, but not volatile organic compounds (VOCs) such as pentane vapor. In contrast, the PDMS substrate is responsive to VOCs such as pentane vapor, but not water vapor. Upon exposure to the water vapor in area C, the PVP-Ir-PDMS film only exhibits a localized color change from blue to yellow and red without bending (FIG. 70A-70D). The reflectance peak position (θ=0°) of area C undergoes significant red-shift of ˜ 130 nm (FIG. 70H), which suggests the color change in area C is due to the PVP layer thickness increase upon exposure to the water vapor. Since the PVP layer is much thinner than the PDMS substrate (Thickness: ˜ 300 μm), the swelling of the PVP layer does not cause the bending of the PVP-Ir-PDMS film. After the removal of the water vapor, the area C of the PVP-Ir-PDMS film is fully recovered to the original blue color.

In contrast, when exposed to a pentane vapor, the PDMS layer swells and leads to the bending of the PVP-Ir-PDMS film towards the PVP side (FIG. 70C-70G). The pentane vapor-induced bending actuation also causes a simultaneous color change from blue to dark purple at both ends of the film. The bending is fully reversible after the removal of the pentane vapor. Since the reflectance peak position (θ=0°) of both area A and area B remain essentially unchanged around 473 nm upon bending (FIG. 70I-70J), the color change observed in area B can be attributed mainly to the change of viewing angle. The bending actuation of the film could be employed as an electrically conductive mechanical switch to turn on the electric circuit for further actions (e.g. alarm).

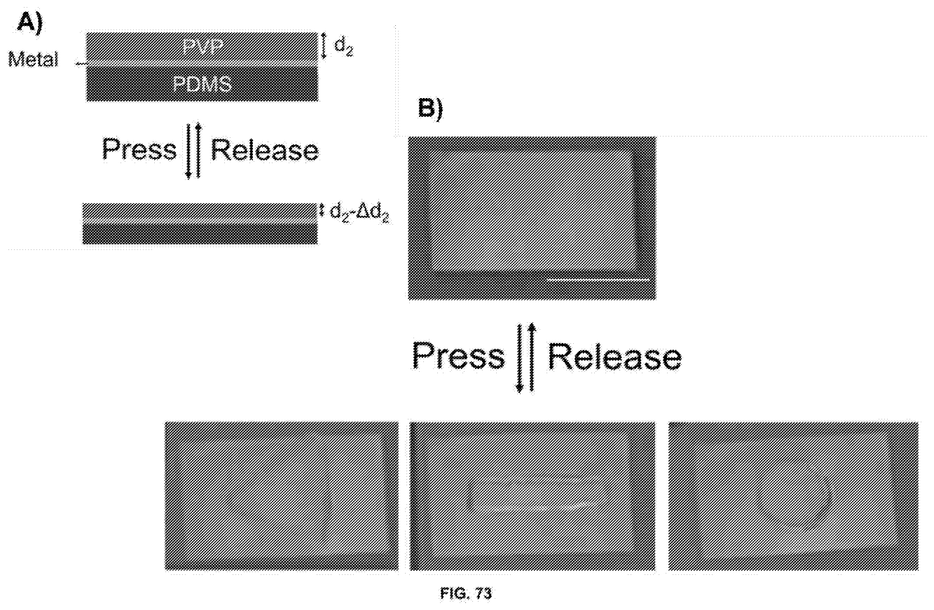

In addition to chemical stimuli, flexible trilayer thin-film sensors are also responsive to the compressive force and changes the color accordingly (FIG. 73). For example, when the PVP-Ir-PDMS sensor is pressed by a glass stamp on the PVP side, the color of the pressed region goes from red to yellow, which originates from the decrease in thickness of the PVP layer upon pressing (FIG. 73B). Three glass stamps with different shapes have been used to make three different color patterns. The color change is completely reversible after release of the glass stamp.

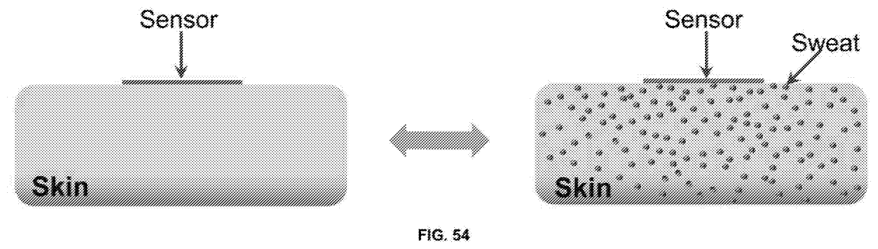

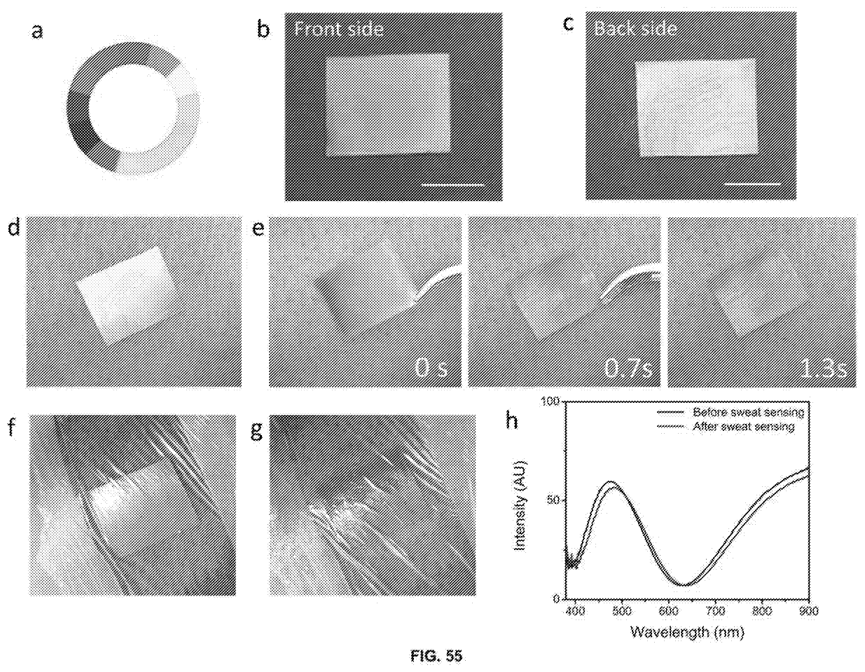

Owing to the transparency of PDMS, both constructive interference reflected colors and complementary destructive interference transmitted colors across the spectrum can be created simultaneously on opposite sides of the substrate, respectively. The degree of transparency in the interference system can be tuned via changing the thickness of the ultrathin metal film. Such transparent and flexible films with coupled complementary colors on opposite sides are desirable for applications such as wearable sweat sensors, where the color change at the on-body side can be transduced into the color change on the opposite side of the film (FIG. 54 and FIG. 55).

In summary, we have developed a general strategy for powerless self-reporting and self-acting chemical sensors, which is applicable to a broad range of stimuli-responsive polymer materials (Cohen Stuart et al., Nat. Mater. 2010, 9, 101-113). Our simple yet versatile trilayer thin-film transducer system enables integration of sensing with actuation, and allows on-site management of intelligent response and action towards different chemical stimuli. Such new type of chemical sensors not only can remain dormant but always alert while monitoring of the environment without consuming power, but also can initiate autonomous reporting and acting functions when a chemical signal of interest is detected.

### Example 4

### Dynamic, Reversible Mechanochromism Based on Thin Film Interference

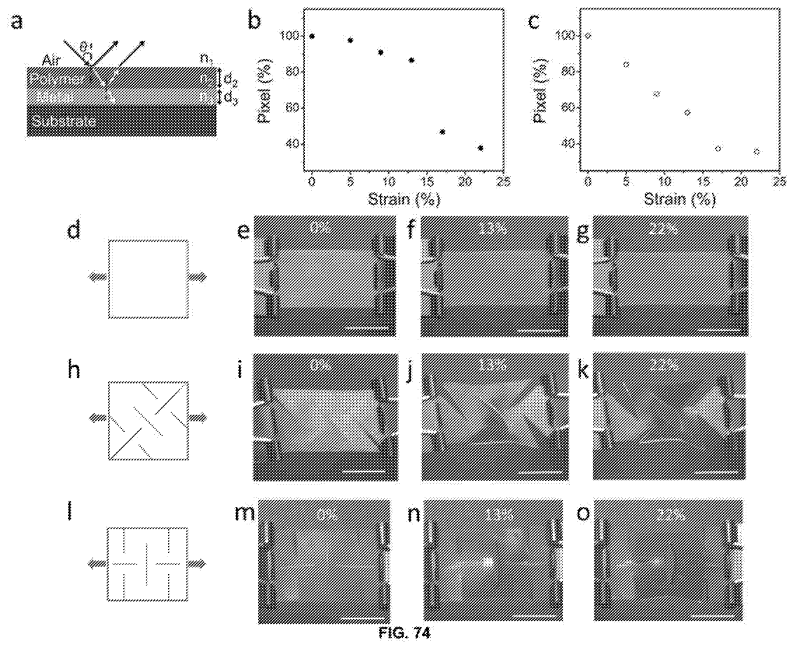

Thin films of polymers with appropriate thickness generally do not exhibit visible structural colors if they are directly deposited on low-cost substrates such as glass (Banisadr et al., ACS Appl. Mater. Interfaces 2019, 11, 7415-7422) and polydimethylsiloxane (PDMS). We have discovered recently that, in order to see bright thin-film interference color on glass or PDMS, it is crucial to use an ultrathin metal layer as an optical filter (Banisadr et al., ACS Appl. Mater. Interfaces 2019, 11, 7415-7422). Such an optical filter layer can dramatically enhance the interference color intensity by simultaneously optimizing both the constructive interference reflection light and complementary destructive interference transmission light. In this study, we choose a polyvinylpyrrolidone (PVP)—Ir-PDMS trilayer film as a model material system for mechanochromism, where the PVP layer exhibits the interference color, and the PDMS layer serves as a stretchable substrate (FIG. 74A). The interference color can be easily tuned by changing the PVP layer thickness (Banisadr et al., ACS Appl. Mater. Interfaces 2019, 11, 7415-7422).

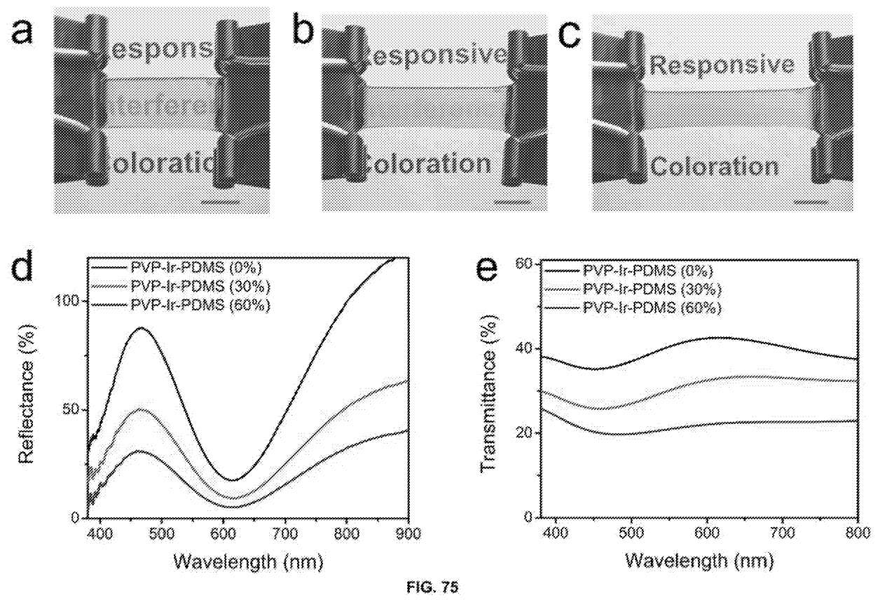

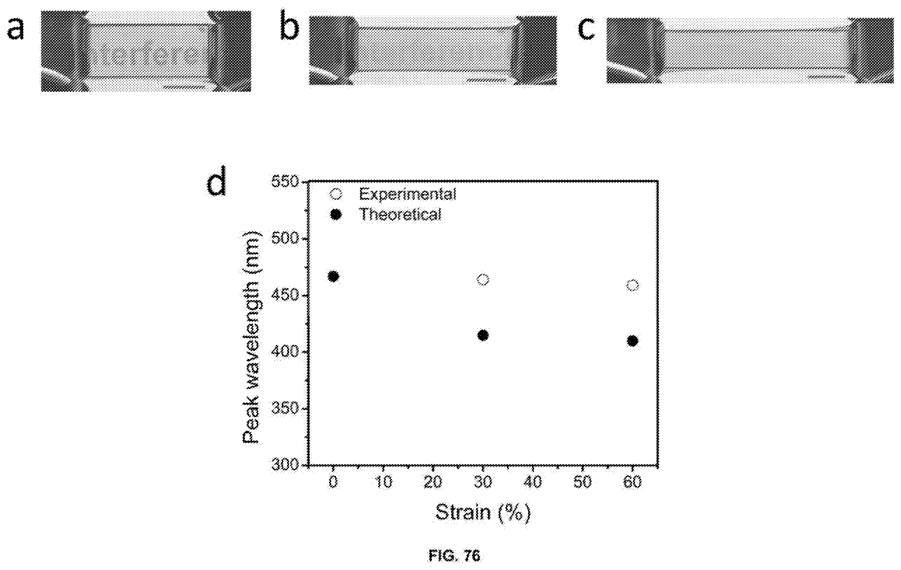

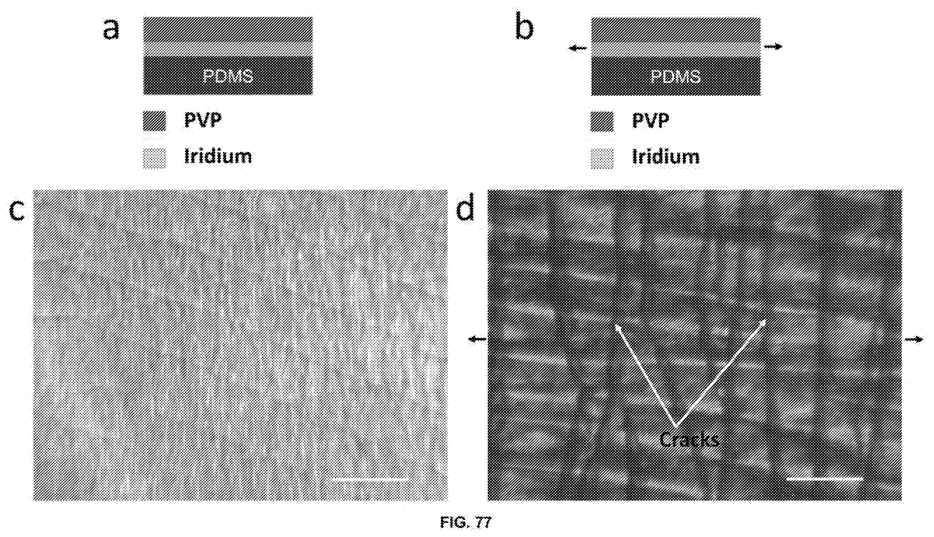

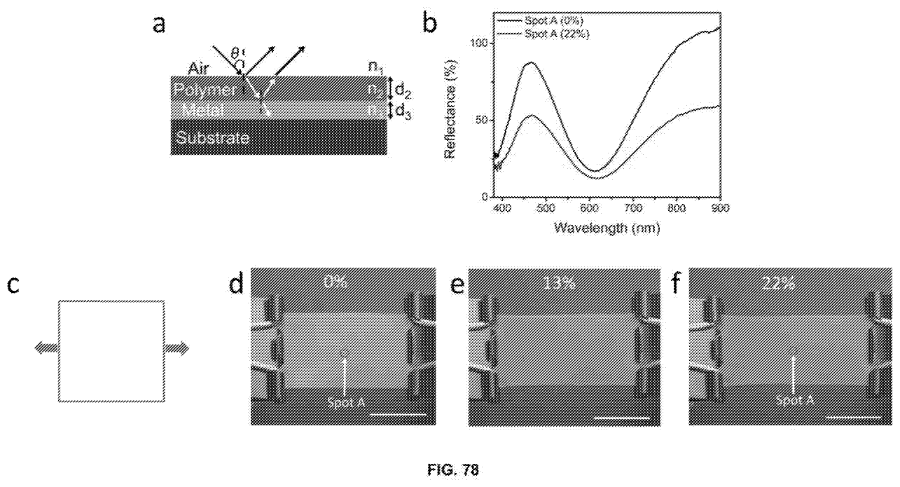

We first investigate the mechanochromic properties of the PVP-Ir-PDMS film. The condition for constructive thin-film interference is determined by Equation 4 where is the wavelength giving the maximum reflectivity, m is the order of diffraction (a positive integer), d₂ and n₂ are the thickness and refractive index of the polymer layer, respectively, and θ is the angle of incidence (FIG. 74A) (Kinoshita et al., Rep. Prog. Phys. 2008, 71, 076401; Sun et al., RSC Adv. 2013, 3, 14862-14889). According to Equation 4, mechanical stretching of the PVP-Ir-PDMS film could lead to significant thickness decrease of the PVP layer, which, in turn, causes the substantial blue-shift of the reflection peak. However, we have found that the PVP-Ir-PDMS film has poor mechanochromic properties in terms of color change (FIGS. 74D-74G and FIG. 75). It exhibits only a very small blue-shift of the reflection peak upon stretching, from 467 nm at 0% strain, to 460 nm at 60% strain (FIG. 75D), which is much less than the calculated 57 nm of blue-shift if the PVP layer is continuously stretched without cracking to 60% strain (FIG. 76). Further investigation suggests that the attenuated mechanochromic response of the PVP-Ir-PDMS film originates from significant cracking of the PVP and underlying metal layers during the mechanical stretching, which yields diminished thickness decrease of the PVP layer and hence small blue-shift of the reflection peak. The optical microscopy of the PVP-Ir-PDMS film in its stretched state shows the PVP/metal cracking perpendicular to the stretching direction (FIG. 77). As discussed later, scanning electron microscopy (SEM) of the Ir-PDMS film reveals the metal cracking upon stretching. Since the PVP and ultrathin metal layers are crucial for observed interference reflection color intensity, the PVP/metal cracking upon stretching also causes substantial intensity reduction of the reflection peak (FIG. 75D and FIG. 78B).

Our initial study suggests that solutions are needed to significantly enhance the mechanochromism based on thin film interference. Herein, we report two different implementation approaches of our new strategy for dynamic, reversible mechanochromism: 1) Kirigami approach; 2) Tunable reflectivity shield approach.

Kirigami allows transformation of a flat sheet into a complex 3D shape. Kirigami-based design principles have been exploited very recently to create or enhance material functions without altering material compositions, which enable potential applications such as dynamic solar tracking (Lamoureux et al., Nat. Commun. 2015, 6, 8092), tunable optical transmission windows (Zhang et al., Proc. Natl. Acad. Sci. USA 2015, 112, 11757-11764), stretchable electronics and optoelectronic devices (Shyu et al., Nat. Mater. 2015, 14, 785-789), stretchable triboelectric nanogenerators (Wu et al., ACS Nano 2016, 10, 4652-4659), optical chirality components (Liu et al., Sci. Adv. 2018, 4, eaat4436), and soft actuators (Rafsanjani et al., Sci. Robot. 2018, 3, eaar7555; Oyefusi and Chen, Angew. Chem. 2017, 129, 8362-8365 and Angew. Chem. Int. Ed. 2017, 56, 8250-8253). Although traditional kirigami involves both cutting and folding, recent studies have shown that the cuts alone in a flat sheet are sufficient to form a 3D object via out-of-plane buckling under strain (Lamoureux et al., Nat. Commun. 2015, 6, 8092; Zhang et al., Proc. Natl. Acad. Sci. USA 2015, 112, 11757-11764; Shyu et al., Nat. Mater. 2015, 14, 785-789; Wu et al., ACS Nano 2016, 10, 4652-4659; Liu et al., Sci. Adv. 2018, 4, eaat4436; Rafsanjani et al., Sci. Robot. 2018, 3, eaar7555; Rafsanjani and Bertoldi, Phys. Rev. Lett. 2017, 118, 084301). In our kirigami approach, the synergistic coupling of buckling-induced kirigami (Rafsanjani and Bertoldi, Phys. Rev. Lett. 2017, 118, 084301) and viewing angle-dependent interference color (Banisadr et al., ACS Appl. Mater. Interfaces 2019, 11, 7415-7422) leads to dramatic enhancement in mechanochromism based on thin film interference.

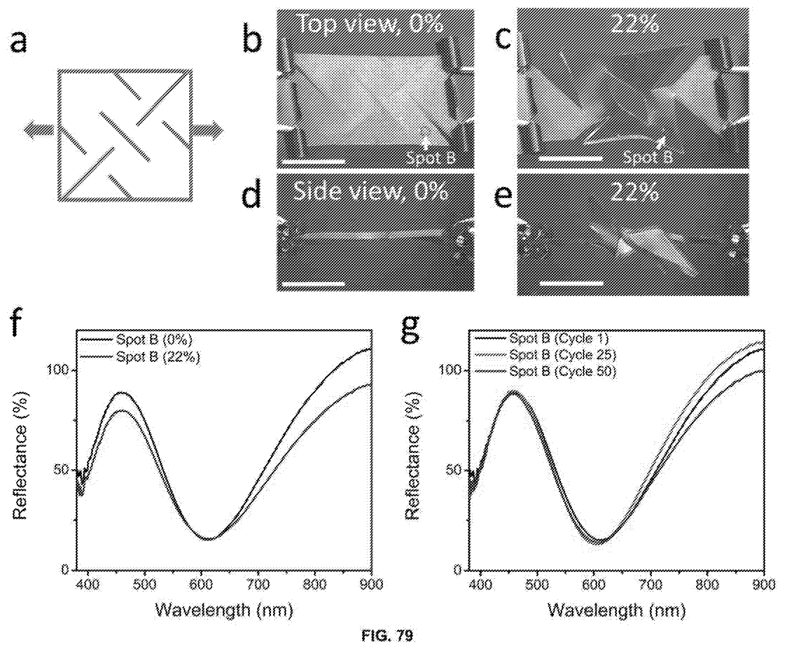

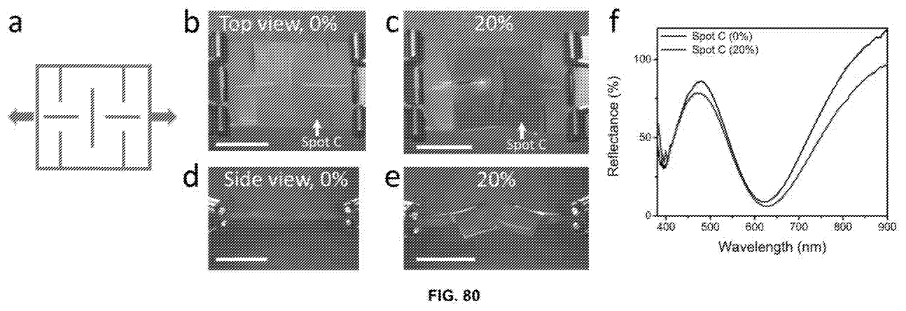

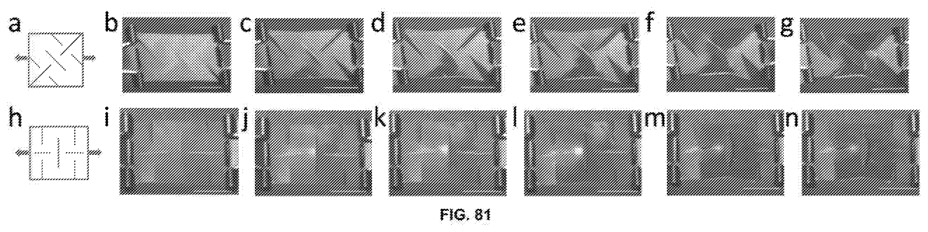

We choose an array of mutually orthogonal cuts in our kirigami design because 3D transformation of such a cut pattern is controlled by the uniaxial tensile direction (Rafsanjani and Bertoldi, Phys. Rev. Lett. 2017, 118, 084301). In our first kirigami structure (kirigami I), the load direction is at 45° to the cuts, whereas in our second kirigami structure (kirigami II), the load direction is at 0°/90° to the cuts (FIG. 74H and FIG. 74L). The uniaxial stretching of the perforated PVP-Ir-PDMS film generates localized out-of-plane buckling, which, in turn, results in the localized change of viewing angle and color (FIG. 74 and FIG. 79-FIG. 81). As the reflection peak position (θ=0°) is nearly unchanged upon buckling (FIG. 79F and FIG. 80F), the significant color change observed can be attributed mainly to the change of viewing angle. Since a very small strain is sufficient to produce significant out-of-plane buckling, the kirigami I and II start to show visible, localized color change at 5% strain or less (FIG. 74B, FIG. 74C, and FIG. 81). In contrast, the PVP-Ir-PDMS film without cuts exhibits only trivial color change at much larger strain (e.g. 22% and 60%), due to very small blue-shift of the reflection peak and lack of out-of-plane deformation (FIG. 74E-74G, FIG. 75, and FIG. 78).

The strain-induced spatially heterogeneous color change in kirigami can be recorded by a video camera and analyzed by the Image Color Summarizer software. The image color analysis allows quantitative assessment of mechanochromic properties of different kirigami structures by tracking the total sample area of initial blue color at each mechanical strain. Most interestingly, we have observed that the kirigami I shows nonlinear mechanochromic response with highest sensitivity in the region of 13%-17% strain, whereas the kirigami II exhibits nearly linear mechanochromic response until it reaches the plateau around 17% strain (FIG. 74B and FIG. 74C). These results indicate that it is possible to tailor the mechanochromic properties of the PVP-Ir-PDMS kirigami films by changing the load direction relative to the orthogonal cut pattern. To evaluate the stability of the perforated PVP-Ir-PDMS film, we have performed the stretch-release cycle test for the kirigami I film. Our cycle test shows that there is no detectable change in reflection spectra in the test region of the kirigami I film after 50 cycles of stretch (22% strain)-release experiments (FIG. 79G).

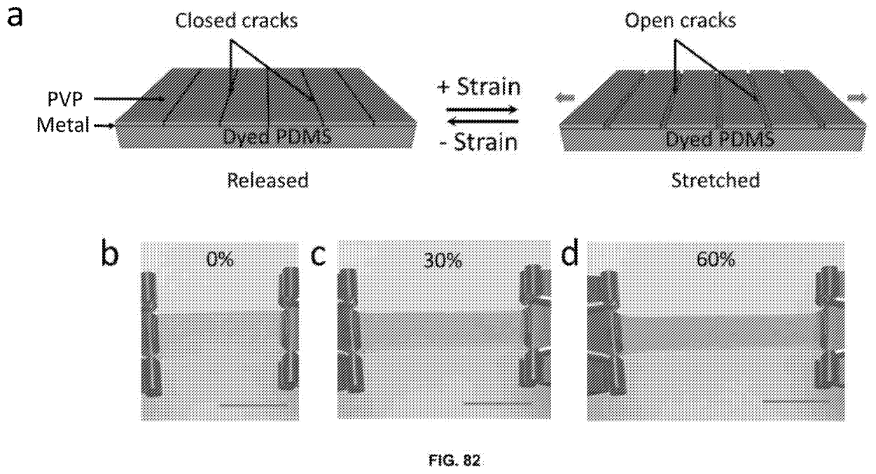

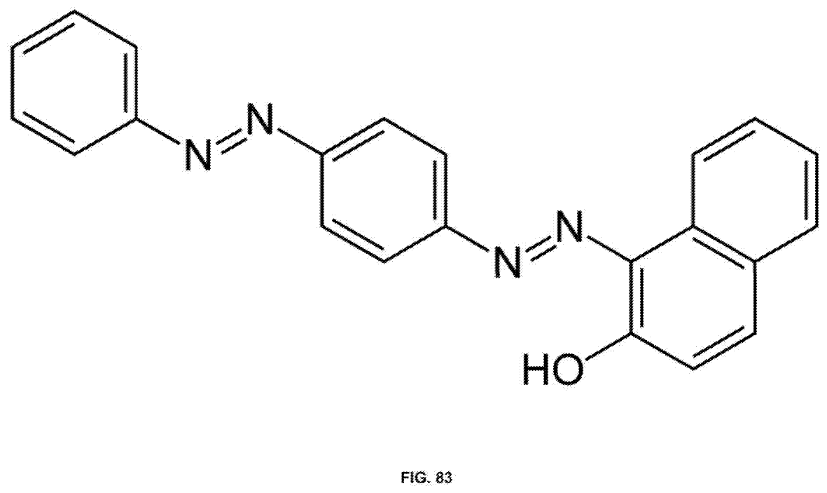

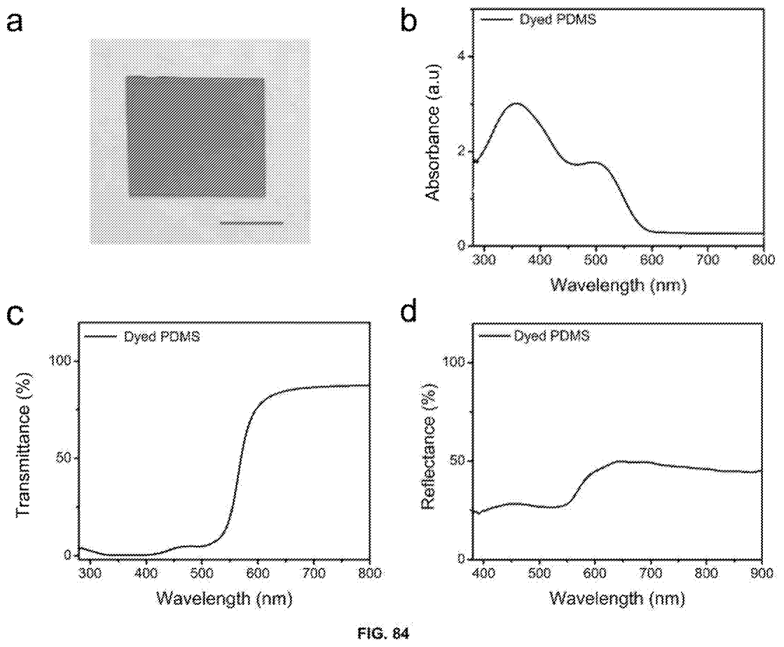

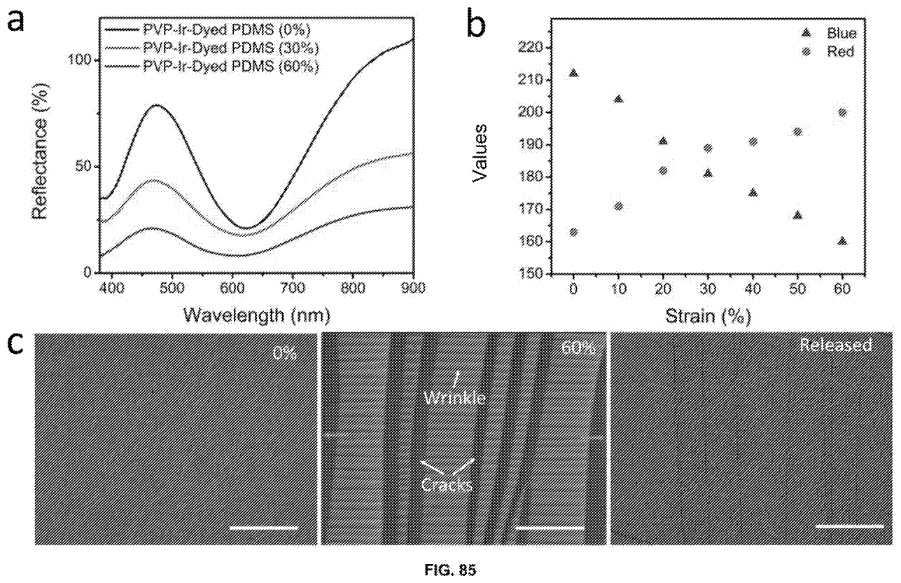

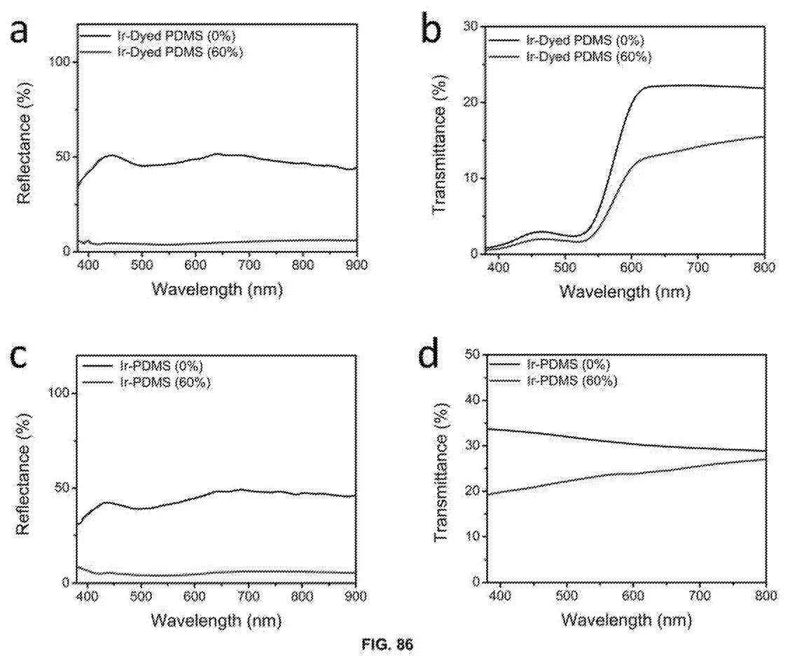

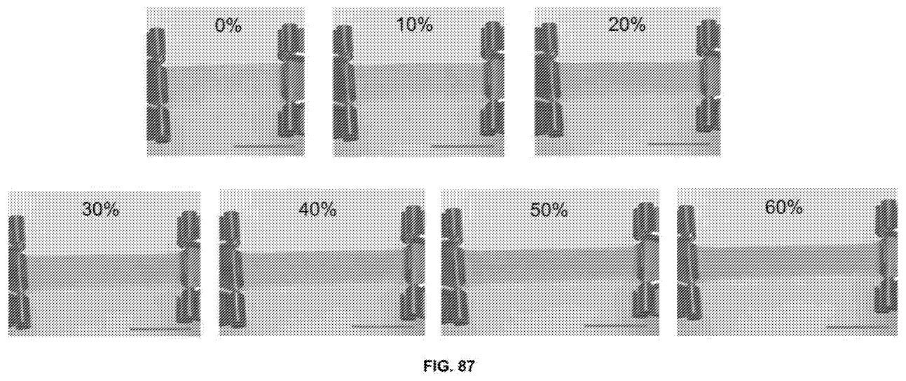

In our second mechanochromic approach, we use the PVP-Ir bilayer film as a mechanically tunable reflectivity shield to program its interference reflection color intensity and the visibility of the underlying dyed PDMS layer (FIG. 82). A red-orange Sudan III dye is added to the PDMS layer to create a substantial color contrast to the blue reflection color of the PVP layer (FIG. 83, FIG. 84, FIG. 86, and FIG. 87). Upon uniaxial mechanical stretching, the blue reflection color intensity decreases dramatically due to the PVP/metal cracking (FIG. 85A), whereas the red-orange dyed PDMS layer becomes increasingly visible thanks to the PVP/metal cracking and diminished blue reflection color intensity (FIG. 82B-82D). Upon mechanical release, the blue reflection color is fully recovered owing to closed PVP/metal cracks, which, in turn, renders the red-orange dyed PDMS layer nearly invisible. Unlike the intrinsic spatially heterogeneous mechanochromic response in the kirigami systems, the mechanochromic response in the PVP-Ir-Dyed PDMS film is, in principle, spatially uniform.

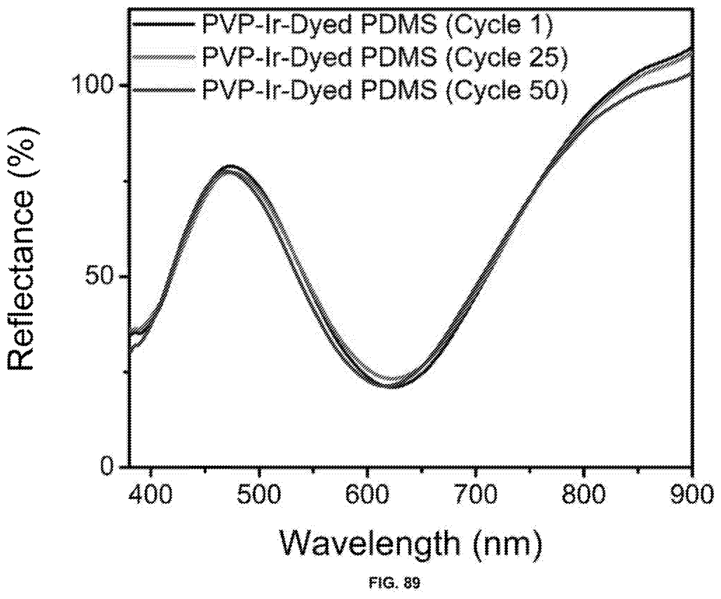

The mechanochromic data recorded by a video camera can be quantitatively analyzed by the Image Color Summarizer software, which produces blue (B) and red (R) values that represent blue and red color intensity, respectively, at each mechanical strain (FIG. 85B and FIG. 87). As shown in FIG. 85B, the B value decreases while the R value increases with increase of the strain from 0% to 60%. The stretch-release cycle test confirms that there is little change in reflection spectra in the test region of the PVP-Ir-Dyed PDMS film after 50 cycles of stretch (60% strain)-release experiments (FIG. 89).

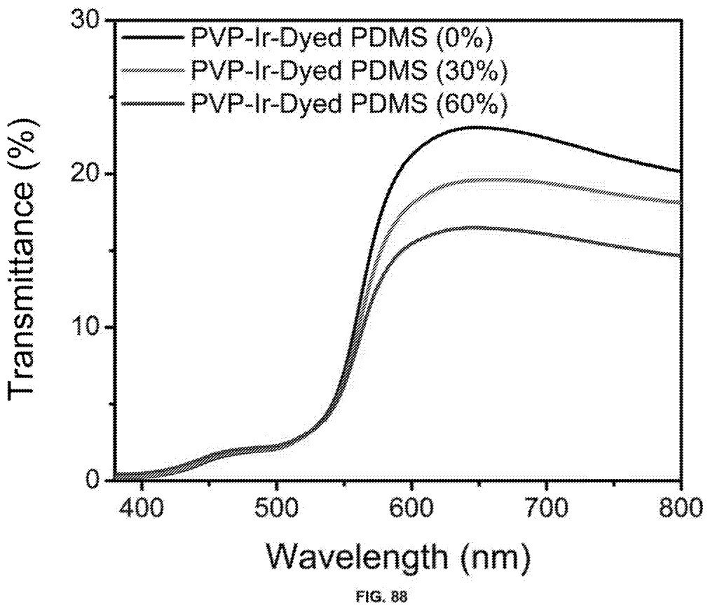

To investigate the strain-induced metal cracking by SEM, we use the Ir-PDMS film with comparable metal and PDMS layer thickness as a model system to avoid the severe charging from the insulating PVP layer in SEM imaging. We have also observed the strain-induced diminishing intensity of the broad reflection spectra of Ir-PDMS and Ir-Dyed PDMS films, respectively, owing to the metal cracking (FIG. 86A and FIG. 86C). The reflection spectroscopy When the pristine Ir-PDMS film is subjected to the uniaxial stretching, the metal cracks form along the direction that is roughly perpendicular to the tensile direction (FIG. 85C). In addition, numerous fine wrinkles develop on the surface of PDMS along the load direction. Upon the strain release, the metal cracks are closed and the surface wrinkling of PDMS disappear. Furthermore, we have noticed that the surface wrinkling of PDMS significantly reduces the transmittance of Ir-PDMS, Ir-Dyed PDMS, PVP-Ir-PDMS, and PVP-Ir-Dyed PDMS films (FIG. 75A-75C, FIG. 75E, FIG. 86B, FIG. 86D, and FIG. 88). This observation is in good agreement with previous studies on ultraviolet/ozone-treated PDMS films and nanocomposite PDMS films, respectively (Li et al., Adv. Optical Mater. 2017, 5, 1700425; Kim et al., Adv. Mater. 2018, 30, 1803847). Therefore, both reflectance and transmittance of our interference coloration films can be reversibly tuned mechanically.

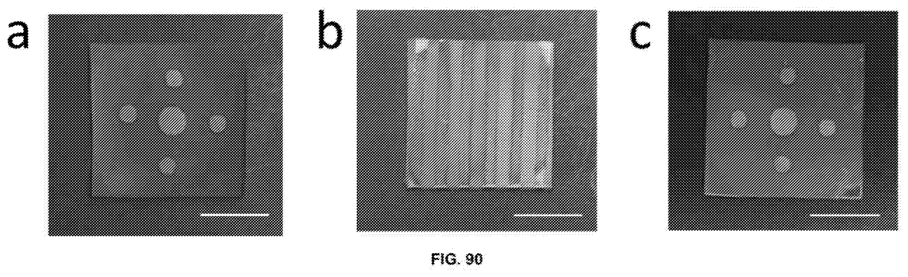

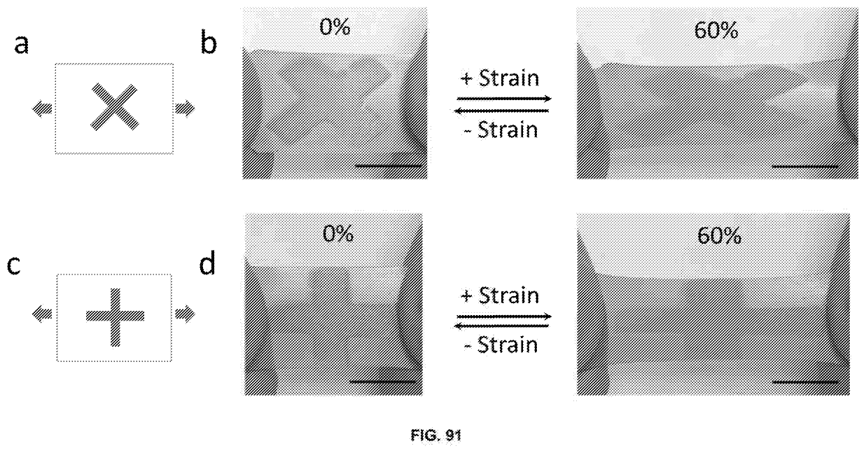

Various interference color patterns such as dots and stripes can be produced by patterning of the ultrathin metal film with different plastic stencil masks on top of the PDMS substrate during the metal deposition (FIG. 90). This allows us to explore the mechanochromic properties of color patterns. As shown in FIG. 91, the blue-colored cross pattern in the PVP-Ir-Dyed PDMS film exhibits dynamic and reversible color change upon mechanical stretching and release. We have found that the mechanochromic response of the cross pattern is basically isotropic and independent of the stretching direction relative to the cross pattern. This further highlights the contrast between the kirigami approach and tunable reflectivity shield approach. Such diverse mechanochromic approaches are valuable for different applications.

### Example 5

### Spectroscopic Evidence for the PVP/Metal Cracking in the PVP-Ir-PDMS Film Upon Stretching

We calculated the expected shift in reflection peak at different strain in the absence of PVP/metal cracking in the PVP-Ir-PDMS film by using the condition for constructive thin-film interference defined by Equation 4 where λ is the wavelength giving the maximum reflectivity, m is the order of diffraction (a positive integer), d₂ and n₂ are the thickness and refractive index of the polymer layer, respectively, and θ is the angle of incidence (Kinoshita et al., Rep. Prog. Phys. 2008, 71, 076401; Banisadr et al., ACS Appl. Mater. Interfaces 2019, 11, 7415-7422). The following assumptions were made in our calculation: The PVP layer is continuous without cracking, the volume of the PVP layer is conserved upon uniaxial stretching, and the dead ends are negligible and the PVP-Ir-PDMS film is rectangular both in the unstretched and stretched state. This allows for approximation of the area covered by the PVP film in the stretched and unstretched states as shown in FIG. 76.

The initial thickness of the PVP layer in the PVP-Ir-PDMS film at 0% strain can be calculated using Equation 4, where n₂ is 1.53 for PVP and A is 467 nm. The thickness of the PVP layer in the absence of PVP/metal cracking at different strains can then be calculated according to Equation 6:

V=Ad₂ (6)

Where V, A, and d₂ are the volume, area, and thickness, respectively, of the PVP layer.

The calculated reflection peak wavelength at different strains is then obtained using the calculated thickness of the PVP layer and Equation 4. Since the calculation assumes that there is no PVP/metal cracking upon mechanical stretching, the significant disagreement between the experimental and calculated reflection peak wavelengths of the PVP-Ir-PDMS film upon mechanical stretching (FIG. 76) provides strong evidence for the strain-induced PVP/metal cracking.

Since the PVP and ultrathin metal layers are crucial for observed interference reflection color intensity, the PVP/metal cracking upon stretching also causes significant intensity reduction of the reflection peak (FIG. 75D).

While several embodiments of the present invention have been described and illustrated herein, it is to be understood that the foregoing embodiments are presented by way of example only and that, within the scope of the appended claims and equivalents thereto, the invention may be practiced otherwise than as specifically described and claimed.

What is claimed is:

1. A responsive interference coloration system comprising:
(a) a substrate, the substrate having a first surface;
(b) a thin film of a metal or metal alloy, the thin film being a continuous film on at least a portion of the first surface of the substrate; and
(c) a polymer layer, the polymer layer being coated on the thin film and the polymer of the polymer layer being a stimulus-responsive polymer;
wherein the thin film has a thickness configured to filter electromagnetic radiation.

2. The system of claim 1, wherein the electromagnetic radiation is visible light, ultraviolet light, or infrared light, or a combination thereof.

3. The system of claim 1 or 2, wherein the thin film is deposited on the first surface of the substrate by physical or chemical deposition methods.

4. The system of claim 1 or 2, wherein the thin film is deposited on the first surface of the substrate by thermal evaporation, sputter coating, or electroless plating.

5. The system of any of claims 1-4, wherein the thin film is a thin film of aluminum, indium, silver, nichrome, copper, titanium, chromium, nickel, palladium, zinc, iron, carbon, gallium, indium, silicon, germanium, tin, selenium, or tellurium, or a combination thereof.

6. The system of any of claims 1-5, wherein the thin film has a thickness of 0.5 to 15 nm.

7. The system of any of claims 1-6, wherein the polymer layer is coated on the thin film by spin-coating, dip-coating, spraying, plasma coating, thermal coating, inkjet printing, or chemical vapor deposition.

8. The system of any of claims 1-7, wherein the stimulus-responsive polymer is responsive to one or more of a physical, chemical, or biological stimulus.

9. The system of claim 8, wherein the stimulus is a physical stimulus and the physical stimulus is one or more of heating, cooling, electromagnetic radiation, an electrical signal, a magnetic signal, or mechanical force.

10. The system of claim 8, wherein the stimulus is a chemical stimulus and the chemical stimulus is one or more of a chemical substance or a redox stimulus.

11. The system of claim 10, wherein the chemical substance is an element or a chemical compound.

12. The system of claim 10 or 11, wherein the chemical substance is in the form of a gas, liquid, solid, or a dissolved chemical substance.

13. The system of any of claims 10-12, wherein the chemical substance is water vapor or solvent vapor.

14. The system of any of claims 10-12, wherein the chemical substance is water, a non-aqueous solvent, or a mixture thereof.

15. The system of any of claims 10-12, wherein the chemical substance is a dissolved chemical substance selected from cations, anions, molecules, biomolecules, or a mixture thereof.

16. The system of claim 15, wherein the dissolved chemical substance is aqueous H⁺.

17. The system of any of claims 1-16, wherein the stimuli-responsive polymer is selected from the group consisting of polyvinylpyrrolidone, polyvinylpolypyrrolidone, fluoropolymers, polycarbonate, polystyrene, polyurethane, polyvinyl chloride, polyacrylonitrile, polytetrafluoroethylene, polychlorotrifluoroethylene, phenol-formaldehyde resin, para-aramid, poly(methyl methacrylate), parylene, polyethylene terephthalate, polychloroprene, polyamide, epoxy resins, polyarylsulfones, polyetheretherketone, polyetherimide, polyetherketoneketone, perfluoroalkoxy resin, poly(p-phenylene), polyethyleneoxide, polyphenylene ether, polyphenylene oxide, polyphenylene sulfide, polyphenylene sulfide sulfone, polyvinyl alcohol, polyvinylidene chloride, polyvinylidene fluoride, polyvinyl fluoride, poly(lactic acid), styrene-butadiene rubber, poly(vinyl acetate), polyacetal, polyhydroxyalkanoates, polycyclodextrins, polybutylene succinate, polycaprolactone, polyanhydrides, cellulose acetates, nitrocellulose, vitrimers, ferrocene-based polymers, hydrogels, organogels, block copolymers, poly(ionic liquid)s, radical polymers, supramolecular polymers, polydopamine, polyamines, covalent organic frameworks, metal-organic frameworks, fluorescent polymers, polythiophenes, polyanilines, polyacetylenes, polypyrroles, poly(phenylene vinylene)s, polyparaphenylenes, poly(phenyleneethynylene)s, polyfluorenes, glucomannan, cellulose, nanocellulose, lignin, starch, polysaccharides, chitin, chitosan, gelatin, collagen, keratin, silk, enzymes, DNAs, RNAs, polypeptides, proteins, antibodies, liquid crystalline polymers, liquid crystalline elastomers, azopolymers (polymers that contain azo group), ionomers, carbon nanotubes, graphene, graphene oxide, fullerenes, nanodiamond, diamondoids, carbon black, asphalt, graphyne, C₃N₄, transition metal dichalcogenides, transition metal carbides, transition metal oxides, MXenes, and perovskite-structured materials, and their derivatives and composites, or a combination thereof.

18. The system of claim 17, wherein the stimuli-responsive polymer is selected from the group consisting of polyvinylpyrrolidone, polyvinylpolypyrrolidone, polydimethylsiloxane, polycarbonate, polystyrene, tetrafluoroethylene-perfluoro-3,6-dioxa-4-methyl-7-octenesulfonic acid copolymer, starch, and glucomannan, and their derivatives and composites, or a combination thereof.

19. The system of any of claims 1-18, wherein the polymer layer has a thickness of 5 nm to 800 nm under ambient conditions.

20. The system of any of claims 1-19, wherein the substrate is a glass, metal, ceramic, stone, brick, concrete, cement, wood, composite, or polymer substrate, or a combination thereof.

21. The system of claim 20, wherein the substrate is the polymer substrate and polymer is a stimulus-responsive polymer.

22. An article comprising the system of any of claims 1-21.

23. The article of claim 22, wherein the article is a sensor.

24. A method of manufacturing the article of claim 22 or 23 comprising
(a) depositing a metal or metal alloy on at least a portion of a first surface of a substrate, the metal or metal alloy being deposited as a thin film with a thickness configured to filter electromagnetic radiation; and
(b) coating a stimulus-responsive polymer on the thin film to form a polymer layer.

25. A method of detecting a change in an environmental condition comprising
(a) contacting the article of claim 22 or 23 with a physical, chemical, or biological stimulus; and
(b) detecting a change in color and/or shape of the article.
